(19) United States
(12) Patent Application Publication
(10) Pub. No.: US 2004/0254816 A1
(43) Pub. Date: Dec. 16, 2004

(54) Network-connected personal medical information and billing system

(76) Inventor: Gene E. Myers, Sarasota, FL (US)

Correspondence Address: KEVIN A. BUFORD, HOLLAND & KNIGHT LLP, 1600 TYSONS BOULEVARD, SUITE 700, MCLEAN, VA, 22102, US

(21) Appl. No.: 10/836,429

(22) Filed: Apr. 30, 2004

Related U.S. Application Data
(63) Continuation of application No. PCT/US02/34781, filed on Oct. 30, 2002.
Application No. PCT/US02/34781 is a continuation of application No. 10/037,462, filed on Oct. 30, 2001.
(60) Provisional application No. 60/422,394, filed on Oct. 30, 2002.

(51) Int. Cl. G06F 17/60

(52) U.S. Cl. 705/2

(57) ABSTRACT

A method system and computer readable medium for a medical service provider to document and approve service and billing information substantially contemporaneous with a provision of services is disclosed. The method includes receiving context information about services for a patient and retrieving a first category of service identifier groups based at least in part on the context information. The method further includes receiving, in response to an approval by the medical service provider of a first group of the service identifier groups, a first identifier belonging to the first group as further input substantially contemporaneous with the provision of services by the medical service provider. The method further includes storing the context information and the first identifier for output in connection with billing information.

### CROSS-REFERENCE TO RELATED APPLICATIONS

This patent application claims priority to PCT international application number PCT/US02/34781 entitled “Method and Apparatus for Contemporaneous Billing and Documenting with Rendered Services,” filed on Oct. 30, 2002 and published on May 8, 2003 as international publication number WO 03/038559. The aforementioned patent application is hereby incorporated by reference in its entirety.

The invention disclosed broadly relates to the field of medical information maintenance. More particularly, the present invention relates to a method, system and computer readable medium for maintaining on a network information related to medical services rendered, billing, medical treatment, medical claims and continuing medical education

### BACKGROUND OF THE INVENTION

Medical service providers use a variety of systems to record, report and bill for the services they provide. These systems vary in structure and complexity based on the information requirements of the service provider, its customers, and any third parties reviewing the services (e.g., insurance companies responsible for payment). While many service providers have flexibility in choosing their form of billing and reporting systems, some are more constrained in what they must record, report and bill for their services.

An example of the latter includes physicians, technicians and other health care service providers, who are typically paid for their services by third party payors (such as private insurance carriers or the federal government, e.g., through the Medicare and/or Medicaid programs), and must comply with all the complex reporting requirements imposed by the third party(ies) in order to receive payment or partial payment. Errors in reports or bills, or nonconformance with third party reporting or billing requirements can, and often does, result in a denial of or delay in payment for services. Although such a delay or denial of payment can apply to services provided by any service provider who seeks payment or partial payment from a third party, delay or denial of payment for services is particularly problematic in the health care field.

To add to the complexity, in addition to the insurance carriers, the federal government and other organizations have from time to time imposed their own billing and reporting conditions on the health care providers. However, there has begun to emerge some “consensus” in the reporting requirements required by the insurance industry and the federal government—at least to the extent each health care provider is required to use common service codes to identify the particular cognitive and non-cognitive care they render to their patients. In the parlance of the industry, “cognitive” care refers generally to services that principally involve mental processes and exercise of professional judgment of the health care provider performing an evaluation of a patient. Services considered “non-cognitive” on the other hand tend to be those which involve more physical interaction with a patient such as performing invasive or non-invasive procedures, clinical tests or treatments.

In addition to documenting the type of care, diagnostic information is sometimes required. For example, when billing for and reporting non-cognitive care, a health care provider may have to indicate a health care condition or disease and the particular diagnostic indications that the payor deems to adequately medically support the particular type of non-cognitive care recommended for the patient.

Requirements for proper coding of a patient's health care condition and the diagnostic indications which support a proposed non-cognitive level of care, as well as the detailed requirements for identifying the particular cognitive level of care administered by a physician during an office visit or hospital in-patient visit, have been promulgated primarily by the Health Care Financing Administration (HCFA) of the U.S. government, in conjunction with the American Medical Association (AMA). The codes currently promulgated by HCFA to identify types of care rendered are the health care prcedure coding system (HCPCS) codes. The HCPCS codes include AMA promulgated codes identifying cognitive and non-cognitive levels of care, referred to respectfully as Current Procedural Terminology (CPT) codes and non-cognitive CPT codes. The cognitive and non-cognitive CPT codes are set out in several volumes of books and manuals and are updated from time to time. The codes selected by HCFA to identify the health care condition of the patient are commonly referred to as the International Classification of Diseases (ICD) codes. Like the CPT codes, the ICD codes are set out in one or more separate volumes and are also subject to revision. The ICD multi-volume manual is currently in its ninth revision; thus, the ICD codes are generally presently referred to as ICD-9 codes.

In order for a physician to be paid promptly upon the submission of an insurance claim, the physician must ensure that the proper codes are all properly set forth on the claim form. Failure to provide the proper codes for the procedures administered or recommended will likely result in either a denial of payment or a substantial delay in payment of the claim. Needless to say, delays and/or denials of payment can have a substantial negative impact on the financial condition of both the physician and his or her practice.

A typical medical office operates as follows with respect to billing and reporting for services rendered to a patient. At the time the physician sees the patient, the physician notes, either in writing or through dictation, his observations of the patient and the patient's symptom descriptions. Based on the symptoms and observations, the physician then makes a disease diagnosis and recommends a plan of treatment. Well after the patient has left the office, the physician's notes are reviewed by the billing department or office staff for entry into the insurance claim form. During such review, the office staff attempts to interpret the physician's notes and assign the proper codes to the services. In particular, the office staff attempts to assign the proper ICD-9 code, cognitive and/or non-cognitive CPT code, and any diagnostic indication codes necessary to support a claim for rendered services based on the physician's notes. The insurance claim form is then prepared and submitted to the patient's insurance carrier. The insurance carrier typically responds within thirty days with payment or a claim denial based on particular grounds. In response to a claim denial, the physician and/or the physician's staff must try to retrace their steps and determine where the coding error occurred, what the coding errors was, and what the proper coding should be. Typically, errors in the codes result from inaccuracies in interpreting or translating the physician's notes. Each claim denial adds at least another thirty days into the insurance provider's claim processing cycle and, therefore, delays payment by at least that same amount of time.

In a hospital setting, the translation and interpretation problems described above are compounded. The physician's notes and/or dictation are first interpreted by the hospital staff and then are faxed or otherwise communicated to the physician's staff for further interpretation prior to selection of the ICD-9, CPT and/or diagnostic indication codes, and completion of the insurance claim form. Therefore, not surprisingly, insurance claim forms submitted to bill for in-patient hospital visits have error rates at least as high as the error rate for claim forms generated after in-office services are performed. The submission and re-submission of insurance claim forms create undesirable delays in obtaining payment for rendered medical services and reduce the profitability of the medical practice due to the added costs necessary to process denied claims.

There is a clear need for accurate and complete documentation, too. More than ever before, healthcare accountability is becoming the focus of community, fiscal and governmental scrutiny. Not only what the doctor does for his/her patients, but why it is being demanded by a growing number of interested parties. Insurance companies, legal counsel, HMOs, and now even federal agencies are taking a closer look at outcomes-based documentation.

Since 1992, physician providers have had to face the increasingly specific documentation guidelines of the Resource-Based Relative Value systems in submitting payment claims for the performance of Evaluation and Management services. Now headlines are underscoring the serious implications of billing for services without supporting documentation. During this same time period, an accelerated group of managed-care organizations and an epidemic of their ensuing health plans have created a heightened state of awareness among the medical community of just how important comparative data can be. An alarming trend of publishing hospital and physician data in local newspapers and magazines is getting the attention of many administrators and practice managers. Vast databases are now available on-line, free for public inspection.

Practice efficiency, quality outcomes measurement, physician report cards and economic credentialing are becoming critical factors in determining survivability for thousands of physicians in today's competitive market. Inclusion and exclusion from provider panels can, in many cases, be tied directly to cost of care, length of stay, mortality rates and other performance parameters. Supporting documentation in the medical record serves to explain deviations from the norm and to justify care path variance.

Although critical pathways, cost controls and case management initiatives have gone a long way to improve our financial and quality outcomes for normalized cases, we are very much aware of the tough cases that defy convention and skew our performance ratings. Insurance companies have long recognized the undesirable consequences of providing coverage to certain high-risk conditions. They can effectively deal with the problem by simply denying coverage up front. But admitting physicians don't have that luxury. They must manage the multiple diagnostic challenges that accompany their patients as an obligatory inheritance.

Fortunately, those who survey our performance take into consideration differences in case complexity. Allowance is made for the unusual patient who places an inordinate demand on hospital resources, for the outliers with uncontrollable financial and mortality risks. When comparing physicians or hospitals, the kind of patients, the cross-section of diagnostic possibilities, the spectrum of performed procedures—the “case-mix” —is taken into consideration as an adjustment to equalize sensitive parameters.

The concept of case-mix may be illustrated in connection with a hospital admission profiling system. The typical profiling approach uses a Diagnostic Related Group (DRG) system, constructed on the premise that homogeneous populations of hospitalized patients can be identified by their principal diagnosis or surgical procedure. These diagnostic groups are assigned numeric values called relative weights, a measure of resources utilized during the hospital stay. High relative weights indicate high intensity services for high severity conditions and high complexity procedures. The intent is to allocate resources appropriately through a severity-complexity adjusted mechanism. Providers are rewarded for efficient care delivery and compensated by a fixed reimbursement based on the relative weights, with the understanding that such weights are averages and that no DRG population is purely homogeneous. Some cases within a DRG will cost less, have shorter stays, and consume fewer resources than average; while other cases will cost far more, stay longer, and consume more resources than average. But, taken as a whole, the aggregate (the mix of the cases) will average out. The average of all relative weights for all patients admitted in any given time period is a case-mix index.

The DRG system and its use by prospective payment programs is critical to the analysis of provider performance outcomes. Hospitals and attending physicians alike are affected by the placement of patients within the spectrum of specific groups. Providers with high-case mix indices (CMIs) are expected to have sicker patients, perform more complicated procedures, and experience a higher complication and mortality rates. Patients with high severity-complexity may be inappropriately placed in a lower than deserved DRG if final diagnostic statements are incomplete, vague, nonspecific or inaccurate, thus preventing proper code assignment. Likewise, patients may be inappropriately placed in a higher than deserved DRG if code assignments are made without supporting clinical documentation.

Thus, a physician who receives and treats only young, healthy patients would receive an unfair advantage if pitted against a hapless colleague who is saddled with a practice full of aged, ailing sufferers without first adjusting their disparate admission rates, length of stay, post-operative complications, pharmacy charges, and mortality rates for difference in severity.

However, when the medical records fail to identify or mention the additional comorbidity that the patient brought with them, (requiring additional attention, work-up, and care) one will fail to explain why the patient's costs were higher, why they received more x-rays, lab studies, medications, treatments, or time in the hospital. Consequently, not only is the patient outlier, but the hospital becomes an outlier. The practice profile shows us standing out above the crowd.

When physicians documentation is silent about the significance of a patient's immunosuppression, vulnerability to aspiration, manifestations of sepsis, clinical evidence of dehydration, incarcerated bowel or lysing adhesions, and a myriad of other observations that the physician considers is “routine” or “expected”—it will be just as silent in justifying the higher infection rates, transfusion rates, and death rates associated with such patients. The report card will likely provide the hospital with special recognition.

Thus, there is a range of possible outcomes. In the middle, one has appropriate severity-complexity. This is evaluated by regulatory guidelines on one hand and an increased risk on the other. On the down side there is loss and that is affected by documented support. The consequences of straying from the ideal of producing appropriate severity-complexity rating for each patient's hospital stay is thus affected. Overstating the extent or nature of care delivery is reckless behavior known as upcoding. Numerous regulations clearly define such abusive and fraudulent activities. On the other hand, the careless indifference to documenting a complete and accurate account of each patient's episode of care can result in an under appreciation of all pertinent events and conditions, a skewing and distortion of important statistical data, and hindering effective outcome analysis, as well as necessitating the absorption of expended resources. A solid understanding of standard coding policy and careful attention to correct charting practices can prevent the errors and risks of both pitfalls.

Once again, appropriate, complete, compliant documentation supports the true diagnostic and procedural assignments for the claim and the resulting payment. Proper documentation protects the moral integrity, and defends one's reputation. Not only does it prevail in securing credit for the kinds of patients we must attend, but as a consequence, it also supports appropriate payment for the work that one must perform.

However, current industry practice comes up short in assisting physicians achieve this goal. In a typical retrospective approach to documentation, an office or hospital staff coding specialist is relied on to establish the DRG, often long after the care is provided. While the care giver may dictate or provide written notations proximate the time of care, it is retrospectively that the staff coding specialist reviews the medical record, establishes the major disease category or MDC, and seeks information regarding major complications and comorbidity and complications. He or she then establishes a DRG based on the information gleaned. The DRG is used in turn to support the billing for that patient's hospital stay.

While this approach does allow a coding specialist establish proper DRG levels, it remains disadvantageous because the care-giver is not armed with all that knowledge base such that he/she could ensure that all major complications, comorbidities, procedures and complexities, are properly added to the medical record and documented. This is only complicated if multiple care-givers are involved, where e.g. brief or minor episodes may go undocumented that in aggregate might otherwise have warranted a higher DRG. Moreover, if there is any question raised at the time of coding, most physicians are hesitant to add any information to the medical record after discharge.

Therefore, a need exists for a method and apparatus for generating a an insurance claim form or other billing report and/or a medical procedure report that results in accurate report generation the first time and facilitates report generation by a single operator at substantially the same time as at least a portion of the services are rendered. There is further a need for a method and apparatus that also provide a mechanism for accurately and expediently verifying compliance with third party reporting requirements prior to submission of the billing report for payment to the third party and facilitate rapid entry of all information necessary to generate a billing report that is acceptable to the third party. There is also a need for such a method and apparatus which prevents inconsistencies between entries made in a medical procedure report documenting services rendered and a billing report seeking payment for those same services.

Further, in June 2000, the Healthcare Financing Administration (presently called DMS), published a draft evaluation and management documentation guidelines (referred to as Medicare/professional/technical information/documentation guidelines for E/M). This document defined what is expected for specific levels of service regarding E/M codes. The publication provided definitions and documentation guidelines for the three key elements of E/M services and for the visits which consist predominantly of counseling or coordination of care. The three key components—history, examination, and medical decision-making—appear in the descriptors for office and other outpatient services, hospital observation services, hospital inpatient services, consultations, emergency department services, nursing facility services, domiciliary care services, and home services.

The descriptors for the levels of E/M services recognize seven components that are used in defining the levels of E/M services. These components are: history, examination, medical decision-making, counseling, coordination of care, the nature of the presenting problem and time. The first three of the components (i.e., history, examination and medical decision-making) are the key components of selecting the level of E/M services. The exception to this rule is the case of visits which consist predominantly of counseling or coordination of care—for these services, time is the key or controlling factor to qualify for a particular level of E/M service.

With respect to documentation of history, the levels of E/M services are based on four types of history, which are problem-focused, expanded-problem-focused, detailed and comprehensive. Each type of history includes some or all of the following elements: chief complaint (CC), history of present illness (HPI), erview of systems (ROS) and past, family and/or social history (PFSH). The extent of the history of the present illness, review of systems and past family and/or social history that is obtained and documented is dependent upon clinical judgment and the nature of the presenting problem(s).

Certain diagnostic guidelines (DG) have been promulgated. One such DG states that the CC, ROS and PFSH may be listed as separate elements of history, or they may be included in the description of the history of the present illness. Another DG states that a ROS and/or a PFSH obtained during an earlier encounter does not need to be re-recorded if there is evidence that the physician reviewed and updated the previous information. This may occur when a physician updates his or her own record or in an institutional setting or group practice where many physicians use a common record. The review and update may be documented by: a) describing any new ROS and/or PFSH information, or noting if there has been no change in the information or b) noting the date and location of the earlier ROS and/or PFSH.

Another DG states that the ROS and/or PFSH may be recorded by ancillary staff or on a form completed by the patient. To document that the physician reviewed the information, there must be a notation supplementing or confirming the information recorded by others. Yet another DG states that the physician should document efforts made to obtain the history from the patient, accompanying family members, friends or attendants or emergency personnel (e.g., paramedics) or available medical records (e.g., previous hospital records, nursing facility records, ambulance records).

In addition to the DG above, definitions and specific documentation guidelines for each of the elements of the history are listed below. With regards to a CC, a concise statement describing the symptom, problem, condition, diagnosis, physician recommended return, or other factors that is the reason for the encounter must be stated. With regards to a DG, the medical records must clearly reflect the chief complaint. With regards to a HPI, the history must contain the chronological description of the development of the patient's present illness from its first sign and/or symptom or from the previous encounter to the present. It should provide pertinent details about the reason for the encounter. The types of details include: a) for symptoms, the location, quality, severity, duration, timing, context, modifying factors including the medications, associated signs and symptoms, etc., b) the follow-up of a previously diagnosed problem, changes in conditions since the last visit, compliance with the treatment plan, etc., and c) for patients on multiple medications or whose primary reason for the visit is for medication management: review of compliance, effectiveness of medications, side effects and complications from medications, verification of medication name, dosage and frequency. The DG includes a brief HPI consisting of documentation of the chief complaint(s) or reason(s) for the encounter as well as 1-3 pertinent details about at least 1 presenting problem. The DG further includes an extended HPI documents the chief complaint(s) or reason(s) for the encounter as well as 4 or more details about at least 1 presenting problem.

With regards to a ROS, it must include an inventory of body systems obtained through a series of questions seeking to identify signs and/or symptoms that the patient may be experiencing or has experienced. For purposes of ROS, the following are recognized: a) constitutional symptoms (e.g., fever, weight loss) and b) organ systems such as eyes, ears, nose and throat, cardiovascular, respiratory gastrointestinal, genital urinary, musculoskeletal, integumentary (skin and/or breast), neurological, psychiatric, endocrine, hematological/lymphatic, allergic/immunologic. The DG includes a brief ROS inquiring about the system(s) directly related to the presenting problem(s)/complaint(s). Examples are as follows: a) CI systems with chief complaint of diarrhea and b) pulmonary and cardiac symptoms with chief complaint of chest pain. These overlap with the history of present illness. Generally, a brief ROS consists of 2 organ systems. A DG further includes an extended ROS comrpising a brief ROS as well as a review of additional organ system(s). Generally an extended ROS consists of organ systems including the system directly related to the presenting problem(s)/complaint(s). A DG further includes a complete ROS comprising a review of 9 or more organ systems including the system directly related to the presenting problem(s)/complaint(s).

With regards to documenting positive and negative findings, all positive findings must be described. Negative findings do not need to be individually documented except as appropriate for patient care. A notation including a system was negative is sufficient. The name of each system reviewed must be documented. For example, the following notations are acceptable:

a. “Pulmonary: cough×4 weeks, otherwise negative.”

b. “Cardiac: negative.”

c. “Review of systems: cardiac, pulmonary, GI, GU, endocrine all negative.”

While the following notations are unacceptable:

a. “ROS: negative.”

b. “Pulmonary: positive.”

c. “All systems negative.”

With regards to PFSH, a review of 3 areas is required. This includes past history (e.g., the patient's past experience with illnesses, operations, injuries, medications, compliance, and treatments), family history (a review of medical events of the patient's family, including illnesses which may be hereditary or place the patient at risk) and social history (age, appropriate review of past and current activities). For the categories of subsequent hospital care, the follow-up inpatient consultation and subsequent nursing facility care, CPT requires only an “interval” history. It is not necessary to record information about the PFSH. A pertinent PFSH is a review of the history area(s) directly related to the problem(s) identified in the “HPI.”

A DG includes at least one specific item from any of the three history areas must be documented for a pertinent PFSH. A complete PFSH is a review of 2 or all 3 of the PFSH history areas, depending upon the category of the E/M service. A review of all 3 history areas is required for services that by their nature include a comprehensive assessment or reassessment of the patient. A review of 2 of the 3 history areas is sufficient for other services.

A DG further includes at least one specific item from any of the 3 history areas that must be documented for a complete PFSH for the following categories of E/M services: office or other outpatient services (established patient), emergency department, subsequent nursing facility care, domiciliary care (established patient), home care (established patient). A DG further includes at least one specific item from each of the 3 history areas that must be documented for a complete PFSH for the following categories of E/M services: office or other outpatient services (new patient), hospital observation services, hospital inpatient services (initial care), consultations, nursing facility assessments, domiciliary care (new patient) and home care (new patient).

With regards to Draft Evaluation and Management Documentation Guidelines, as identified in the aforementioned communication based on the June 2000 publication (and initially outlined in the 1997 documentation guidelines) federal regulations have identified key elements (bullets) which must be evaluated and documented in order to support reimbursements for specific levels of services when it comes to E/M CPT coding.

The present industry standard requires that when a patient enters a physician's office they are in general provided with a paper format where they are asked a series of questions to try to identify some of the aforementioned elements. In some instances, office staff aid in helping the patient complete the information. Once this paper documentation is completed, the physician reviews this and includes some of the information into the medical record under the appropriate categories as mentioned above. This is a relatively time consuming effort on behalf of all concerned including the patient, office staff and physician's staff. Each time the patient goes to a new physician, the same information is requested of them.

Multiple publications have called attention to this “problem” for the physician and patient. At least two-thirds of the time that the patient spends in a physician's office or other facility is spent accumulating this past information. This leaves a limited amount of time the physician has available to actually focus on the problem for which the patient is being seen at the individual time. Although the documentation information is frequently necessary, it becomes the irritating focus on behalf of the physicians since they feel that they should be able to focus on the patient's problem of the day as opposed to recreating past information.

The problem is particularly exaggerated in the older age population where a patient, besides seeing their family practice or internist physician, may see multiple specialists over a relatively short period of time. In each instance the patient has to recreate all the old review of systems and past social and family history information for the specialist. So the problem is one that is highly recognized by both the patient, physician's staff, and physician themselves.

Multiple Electronic Medical Record (EMR) products have become available over the past few years in order to solve the problem of managing medical records. Several problems have surfaced which create barriers to physicians utilizing the EMR system. One problem arises from the fact that most specialists are uncomfortable using a digitized template format for creation of the history of present illness. Many specialists feel it is very important to include specific adjectives and adverbs to describe the patient's clinical condition in the history of the present illness. Another problem and perhaps even a larger problem, is what to do with legacy paper medical records. Scanning entire patient's charts into a computer format becomes an expensive, time-consuming and burdensome task. In addition to this, a significant portion of the data would be of questionable value.

Therefore, a need exists to overcome the problems with the prior art and particularly for an easy and efficient way to generate, maintain and allow access to personal medical records of patients.

With regards to continuing medical education (CME) Health Care Providers (HCP) have traditionally maintained their medical skills by attending medical meetings certified by organizations organized to deliver continuing medical education. Although these events are useful and informative, they occur on a relatively infrequent bases. With the rising healthcare costs, attendance by HCP has progressively decreased. Many CME providers deliver the eduction over the Internet. However, the HCP must be very motivated to seek out such services, must be computer savvy, and then must accept the CME offered by that service or available by that service at that time—whether the CME is of interest or necessity to the HCP at that time.

Traditionally, the field of medicine has been taught using the motto “see one, do one, teach one.” Nearly every Physician who has ever learned how to do a physical examination, learned it using this technique. As a matter of fact, most of the learning occurred at the bedside in patients with specific problems. It was long ago recognized that the retention of medical information is best if it's done at the point and time that service is delivered to the patient by the health care provider. In other words, the HCP is much more likely to retain information about congestive heart failure if they see a patient with congestive heart failure and learn new information/guidelines about congestive heart failure at the point and time of delivery of the service.

Maximizing the use of these “memory hooks” to help retain the information at a time when the HCP was most interested in the delivery of such CME information would result in important facts and information guidelines being optimally utilized. Recognizing the time constraints witnessed by most health care providers is crucial. One of the most valuable pieces of information to be gleaned from such a system would be the information specifically pertaining to the individual patients care at the time the patient is being seen. In other words, most CME subject matters contain scientific information, explanations of physiological and anatomical and maladies, but one of the most important ingredients that the practicing health care provider needs to go away with is: what difference it makes to the patient and more specifically what differences it makes to the patient in front of the HCP at that time. Because time is so very important, there's little opportunity during a patient contact, immediately thereafter or between patients to obtain this information. Thus, the education information pertaining to patient care and patient education would be considered the most preeminent information top the HCP.

Therefore, a need exists to overcome the problems with the prior art and particularly for an easy and efficient way to generate and provide continuing medical education information to health care providers during the provision of medical services.

### SUMMARY OF THE INVENTION

Briefly, according to an embodiment of the present invention, a method for a medical service provider to document and approve service and billing information substantially contemporaneous with a provision of services is disclosed. The method includes receiving context information about services for a patient and retrieving a first category of service identifier groups based at least in part on the context information. The method further includes receiving, in response to an approval by the medical service provider of a first group of the service identifier groups, a first identifier belonging to the first group as further input substantially contemporaneous with the provision of services by the medical service provider. The method further includes storing the context information and the first identifier for output in connection with billing information.

Also disclosed is a method for maintaining a personal medical record available on a network. The method includes performing an evaluation and management service upon a patient and generating personal medical information of the patient substantially contemporaneous with the evaluation and management service. The method further includes causing the identification of a personal medical record on the network corresponding to the patient and sending the personal medical information over the network for storage in the personal medical record.

In another embodiment of the present invention, the method includes maintaining in a database a list of unique identifiers associated with personal medical records corresponding to patients. The method further includes receiving personal medical information of a patient over the network substantially contemporaneous with an evaluation and management service performed upon the patient. The method further includes identifying in the database, using the list of unique identifiers, a personal medical record corresponding to the patient and storing the personal medical information in the personal medical record that was identified.

Also disclosed is an information processing system for maintaining a personal medical record database available on a network. The information processing system includes an interface for inputting personal medical information of a patient substantially contemporaneous with an evaluation and management service performed upon the patient. The information processing system further includes a processor for causing the identification of a personal medical record on the network corresponding to the patient and a transmitter for sending the personal medical information over the network for storage in the personal medical record.

In another embodiment of the present invention, the information processing system includes a database of personal medical records corresponding to patients, each medical record having a unique identifier. The information processing system further includes a network interface for receiving personal medical information from a patient over a network substantially contemporaneous with an evaluation and management service performed upon a patient. The information processing system further includes a processor for identifying a personal medical record corresponding to the patient and storing the personal medical information in the personal medical record that was identified.

In yet another embodiment of the present invention, a method for providing continuing medical education substantially contemporaneous with a provision of medical services is disclosed. The method includes performing an evaluation and management service upon a patient and generating personal medical information of the patient substantially contemporaneous with the evaluation and management service. The method further includes sending the personal medical information over the network for storage in a personal medical record on the network corresponding to the patient and receiving continuing medical education information related to the personal medical information.

The method can also be implemented as machine executable instructions executed by a programmable information processing system or as hard coded logic in a specialized computing apparatus such as an application-specific integrated circuit (ASIC). Thus, also disclosed is a computer readable medium including computer instructions for maintaining a personal medical record available on a network.

The foregoing and other features and advantages of the present invention will be apparent from the following more particular description of the preferred embodiments of the invention, as illustrated in the accompanying drawings.

### BRIEF DESCRIPTION OF THE DRAWINGS

The subject matter, which is regarded as the invention, is particularly pointed out and distinctly claimed in the claims at the conclusion of the specification. The foregoing and other features and also the advantages of the invention will be apparent from the following detailed description taken in conjunction with the accompanying drawings. Additionally, the left-most digit of a reference number identifies the drawing in which the reference number first appears.

FIG. 1A is a block diagram of an exemplary billing and reporting system in accordance with the present invention.

FIG. 1B is a block diagram of an exemplary local processing device.

FIG. 1C is a block diagram of a portion of the system of FIG. 1 illustrating use of a wireless communication device as either a local processing device or an interface to a local processing device in accordance with an embodiment of the present invention.

FIG. 1D is a block diagram of the wireless communication device of FIG. 1C in accordance with an embodiment of the present invention.

FIGS. 2A-2D are logic flow diagrams illustrating the steps executed by a local device to facilitate services and billing in accordance with an embodiment of the present invention, where:

FIG. 2A illustrates an overview of a medical services and billing process;

FIG. 2B illustrates an evaluation and management (E&M) service and billing process;

FIG. 2C illustrates a service (e.g., procedure) ordering process; and

FIG. 2D illustrates a procedure and interpretation process.

FIGS. 3A-3AA are screen shots illustrating how information may be presented and selected by a service provider in accordance with the embodiments of FIGS. 2B-2C.

FIG. 4 is a logic flow diagram illustrating more detailed steps executed by a local processing device which, together with the steps executed by a remote processing device as illustrated in FIG. 8 below, facilitate generation of a billing report in accordance with an embodiment of the present invention.

FIGS. 5A-5C are collectively a logic flow diagram illustrating the steps executed by a local processing device which, together with the steps executed by a remote processing device as illustrated in FIGS. 9A-9D below, facilitate generation of a medical claims billing report in accordance with a preferred embodiment of the present invention, the local processing device being located locally with respect to a location at which medical services are being rendered to a patient.

FIG. 6 is a logic flow diagram illustrating the steps executed to display identifiers relating to a cognitive level of care to a health care provider in accordance with a preferred embodiment of the present invention.

FIG. 7 is a logic flow diagram illustrating the steps executed by a local processing device which, together with the steps executed by a remote processing device as illustrated in FIG. 10 below, facilitate generation of a medical procedure report in accordance with a preferred embodiment of the present invention, the local processing device being located locally with respect to a location at which a non-cognitive level of medical care is being administered to a patient.

FIG. 8 is a logic flow diagram illustrating the steps executed by a remote processing device in conjunction with the operation of the local processing device whose operation is illustrated in FIG. 4 in order to facilitate generation of a billing and medical procedure report in accordance with an embodiment of the present invention.

FIGS. 9A-9D are collectively a logic flow diagram illustrating the steps executed by a remote processing device in conjunction with the operation of the local processing device whose operation is illustrated in FIGS. 5A-5C in order to facilitate generation and a medical claims billing and medical procedure report in accordance with a preferred embodiment of the present invention, the remote processing device being located remotely with respect to a location at which medical services are being rendered to a patient.

FIG. 10 is a logic flow diagram illustrating the steps executed by a remote processing device in conjunction with the operation of the local processing device whose operation is illustrated in FIG. 7 in order to facilitate generation of a medical procedure report in accordance with a preferred embodiment of the present invention, the remote processing device being located remotely with respect to a location at which a non-cognitive level of medical care is being administered to a patient.

FIG. 11 is an example of a graphical user interface depicting at least a portion of an object of services rendered or to be rendered by a service provider. The graphic in this example represents to human arterial system.

FIG. 12 is a flowchart illustrating use of the graphical user interface of FIG. 11.

FIGS. 13A-13I are screen shots illustrating how information may be presented and selected by a service provider, drilling down through progressive screens to detailed history and category information, using an exemplary billing and reporting system in accordance with the present invention.

FIG. 14 is a block diagram depicting a high-level architecture of the personal medical web site component of one embodiment of the present invention.

FIG. 15 is a block diagram depicting the architecture of the application service provider component of one embodiment of the present invention.

FIG. 16 is a block diagram depicting the architecture of a computer useful for implementing one embodiment of the present invention.

### DETAILED DESCRIPTION

The present invention is in its preferred embodiments directed to a method and apparatus for generating billing and report information substantially contemporaneous with services rendered by a service provider. In a first embodiment, a system includes a local processing device (“LPD”) at the location at which the services are rendered which works together with a remote processing device (“RPD”). The local and remote devices execute respective programs and communicate over a communication channel such as a wide area computer network (e.g., the Internet). The service provider using the LPD can access the RPD and enter identifiers related to the services (e.g., service codes such as CPT codes ) for use in generating service and/or billing reports. In accordance with one aspect of the invention, entry of the identifiers in a form acceptable to the payor preferably occurs substantially contemporaneously with at least a portion of the services being rendered. Thus, the identifiers can be entered and verified while the service provider is either rendering services, preparing to imminently render the services, or sufficiently shortly after the services have been rendered that the nature of the service is still fresh in the mind of the service provider. The RPD can provide verification prompts to the service provider regarding the compliance of entered identifiers with reporting requirements of a third party and, if the entered identifiers comply, automatically generate the billing report and, if desired, a service procedure report based on the entered identifiers. In turn, the remote device preferably communicates the report electronically to the third party for payment. As will be described, the local processing device 101, 102 may comprise a wireless device to facilitate data entry from virtually any location. The programs executed by the remote and local devices may be stored in respective memory of the devices or on other machine-readable media that are separately accessible by the respective devices.

Although readily applicable to all service industries having third party payors with more complicated billing support requirements, a preferred embodiment of the present invention is particularly directed to the health care industry and may be employed by the health care industry to facilitate rapid creation and submission of a claim form by a single operator, such as the attending physician, at substantially the same time at least a portion of the services are rendered. For example, with the present invention, the attending physician can rapidly access a remote server, receive browsable menus, lists or other displays of service-related identifiers, such as cognitive CPT codes, non-cognitive CPT codes, ICD-9 codes and diagnostic indications codes, make correct identifier selections, and instruct the remote server to automatically generate and submit the claim form, such as the so-called “1500” form presently in widespread use, electronically to the patient's insurer or payor. Once entered, some or all of the same identifier entries used for the standard “1500” or other claim form are stored and used to populate corresponding fields of a templated medical procedure report which can be submitted along with the billing report to the health care provider, referring physician or others, and stored for later access by the health care provider, insurer or others, all via a paperless, seamless system requiring almost no human intervention beyond data entry. Thus, the present invention enables the health care provider, the person with the most knowledge about the services rendered to the patient to select the most appropriate service and condition codes (e.g., CPT, ICD-9 and diagnostic indication codes) for billing purposes, and verify other required information is captured, all contemporaneous with the delivery of services. This is in sharp contrast to prior art medical billing approaches in which the physician's notes or transcribed dictation are interpreted by the billing staff, often resulting in submission of insurance claim forms with errant codes. Consequently, the present invention substantially increases accuracy and the likelihood that insurance claim forms will be accepted upon initial submission, thereby reducing the substantial payment delays introduced by the return of unacceptable insurance claim forms.

To facilitate rapid selection of correct cognitive CPT codes, a plurality of cognitive CPT codes and their associated cognitive care descriptions from among which the physician may select are preferably displayed or presented to the physician or other health care service provider in the manner in which a physician typically thinks while rendering a cognitive level of care to a patient. In a preferred embodiment, the cognitive CPT codes and descriptions are presented such that physiological codes and descriptions are presented first, followed by anatomical codes and descriptions. Such display of the cognitive CPT codes and descriptions is in sharp contrast to process of reviewing numerical listing of codes and their associated descriptions provided in multi-volume manuals of the prior art, a process typically left by the physician to others more familiar with the manuals.

The invention also facilitates rapid and accurate generation of two or more different documents, such, as a medical billing report and a corresponding medical treatment or procedure report, which require entry of at least some of the same data in each document. Efficiency is improved and inconsistencies between such documents are avoided according to the invention by entering only once data which is common to more than one document and populating or pre-populating appropriate fields of each document with the data in the form entered on only that single occasion. In the context of the invention, “document” may include any suitable form (traditional, electronic, optical, or any other means for storing information) Further, in accordance with the invention, data is entered at substantially the same time and substantially the same place as at least a portion of the services to which the data relates are actually rendered. As explained above, this means that data is entered while the service provider is preparing to imminently render the services (to be typically followed by a verification or approval), while at least some aspect of the services are being rendered, or sufficiently shortly (preferably minutes) after the services have been rendered that the services are still fresh in the mind of the service provider. Moreover, while permitting data to be entered by more than one person either at the same or different times and/or locations, the invention permits entry and/or editing of all data needed to populate one or more comments by only a single operator. For instance, all necessary entries, including any edits of prior entries, can be made a physician rendering medical services to a patient in an exam room or shortly before or thereafter. On the other hand, if for example the physician orders the patient to undergo subsequent tests or procedures, a technologist, clinician or even the same physician later performing such tests or procedures either in the same exam room or a different location such as a clinical test facility, can make additional entries and, if authorized, edit prior entries made by the physician or others.

These and other aspects of the invention will become more apparent to those of ordinary skill in the art upon review of the following detailed description of a preferred embodiment taken in conjunction with the appended drawings in which like reference numerals designate like items.

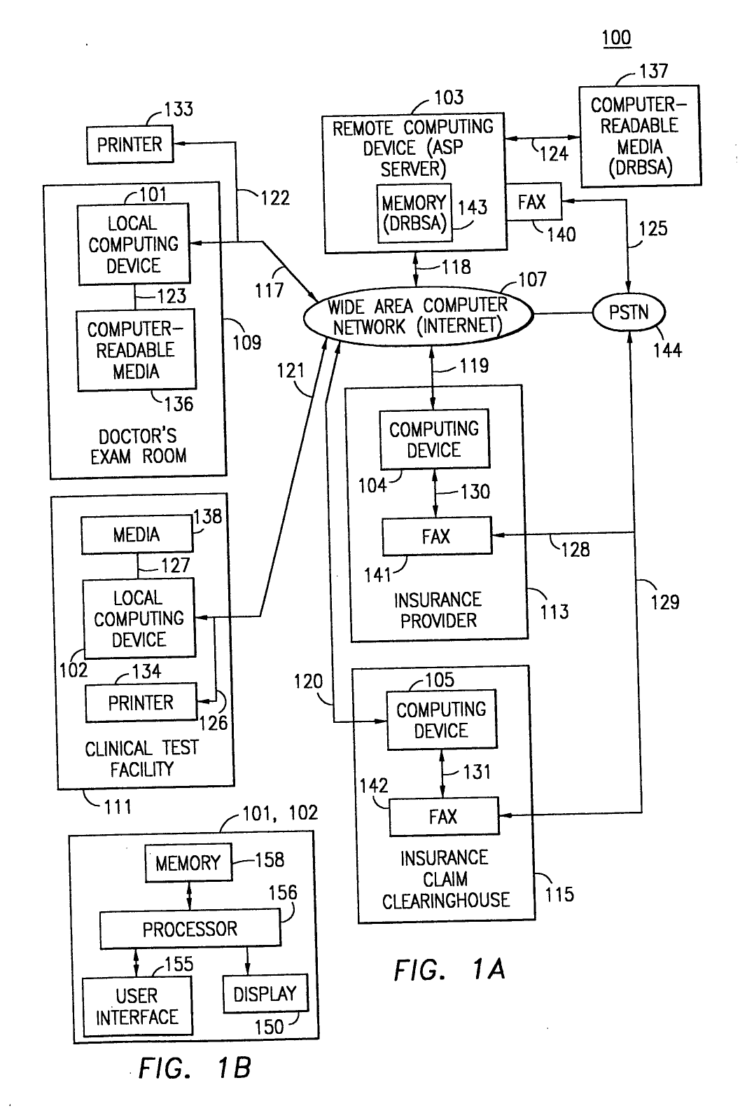

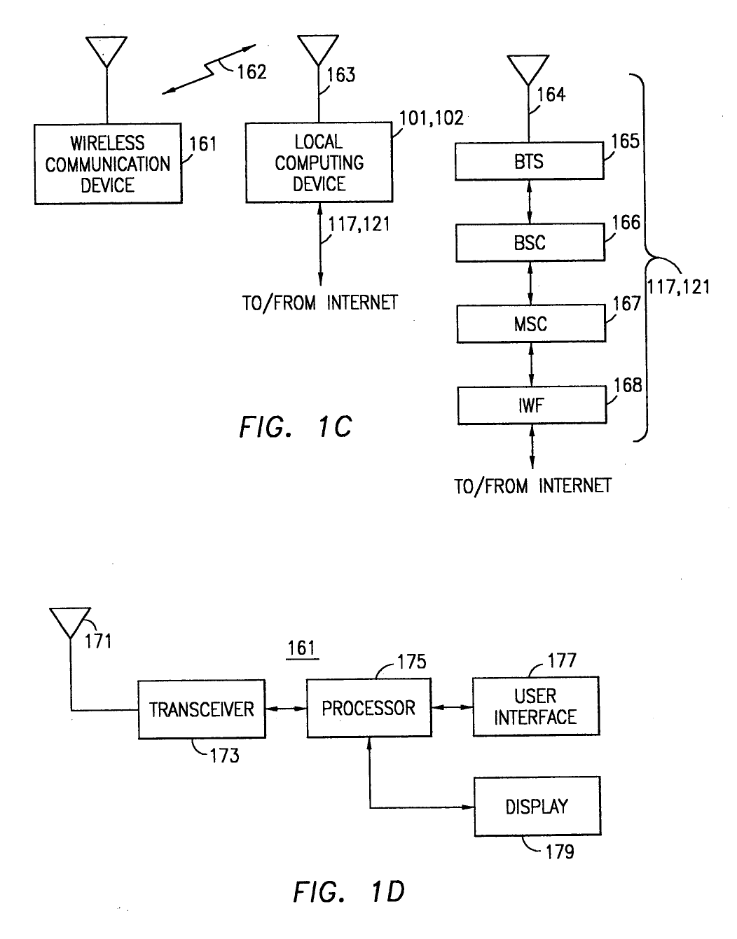

Turning now to FIG. 1, a preferred embodiment of a billing and reporting system 100 in accordance with the present invention is illustrated in block diagram form. The system 100 includes a plurality of processing devices 101-105 which are operably coupled to one another via a wide area computer network 107, such as the global computer network commonly referred to as the Internet or World Wide Web. The processing devices 101-105 can be located at mutually-separated physical locations and are capable of processing data received from one or more of the other devices 101-105. A processing device 101, 102 that is located in or in close operational proximity to a location where services to be billed are rendered by a service provider to a customer is referred to herein as a “local processing device”. A processing device 103 that is located remotely with respect to a location where services to be billed are rendered is referred to herein as a “remote processing device.” A “processing device” can be any device capable of automated processing of information, such as a computer, a PDA (personal digital assistant), digital pads, thin clients, and virtually any device or program capable of processing according to the invention. For convenience, a local processing device is referred herein as a “LPD”, while a remote processing device is referred to as a “RPD.” Programming and operation of local and remote processing devices in accordance with a preferred embodiment of the present invention is described in further detail below.

By way of illustrative example of a particular field of use, the invention will be described with reference to an embodiment useful in the healthcare field for documenting and billing services rendered by a physician or technician. According to such embodiment, an LPD 101, 102 may be located in one or more of: a physician's examination room 109, at a clinical facility 111, such as a hospital, in a test area (e.g., in the radiology department), near patients' rooms (e.g., at a nursing station), or at any other location in physical proximity to a location where services are rendered, so as to facilitate access to the LPD 101, 102 substantially contemporaneously with the rendition of services. As used herein “substantially contemporaneously” means either during the time that the physician or other health care provider is rendering services to a patient, or just before, or sufficiently soon thereafter (preferrably within minutes) that the type and nature of services rendered is still fresh in the mind of the service provider. As shown in FIG. 1B, each local processing device 101 includes a user output 150 of any type suitable for, typically, displaying alphanumeric and/or graphical information, or more generally presenting information (e.g., by audio or other electromagnetic means) to the service provider, and a user interface 155 such as a keyboard, key pad, touchscreen, scrolling thumbwheel, mouse or other pointing device, or audio input, suitable for selecting particular information presented to the service provider via output (e.g., audio or display) 150. Each local processing device typically includes a processor 156 coupled to the user interface 155 and to the display 150 as well as to memory 158 (e.g., volatile or non-volatile, electric, magnetic, optical or other device or object), suitable for storage of data and the software instructions executed by processor 156. Local processing devices 101, 102 may suitably consist of or comprise personal computers, laptop computers, palmtop computers, personal digital assistants, or data-capable wireless devices, such as two-way paging devices or two-way radio devices that support data or short message communications. A preferred data-capable wireless device is depicted in block diagram form in FIG. 1D and will be described in further detail later below.

A remote-processing device 103 is preferably used in accordance with the present invention to execute a data recording and billing application software (DRBA) accessed by the local processing device 101, 102. The DRBA executed by the remote processing device 103 generates billing or other reports and provides such reports to various other processing devices 104, 105 (which may be either local or remote with respect to the location at which the services were rendered) as described in detail below. RPD 103 preferably comprises an Internet server operated by an application service provider (ASP). Alternatively, remote-processing device 103 may comprise a host computer or server in any wide area network.

As mentioned above, the system 100 may further include other processing devices 104, 105 that may be located either remotely or locally with respect to the location at which the services are rendered. Such processing devices 104, 105 are preferably operated by an insurance provider 113 or other third party that is at least partially responsible for payment of the services rendered to the customer, and/or an insurance claim clearinghouse 115 which may perform insurance claim form screening in accordance with known techniques prior to actual submission of an insurance claim form to an insurance provider 113. Processing devices 104 and 105 preferably comprise host computers or servers that may be located on the respective premises of the third party or clearinghouse. In the event that insurance claim form or billing report screening is performed, at least initially, at a web site hosted by the ISP, processing devices 104 and 105 may be located on the premises of an Internet Service Provider (ISP).

Processing devices 101-105 are all preferably operably coupled or coupleable to the computer network 107 via respective communication links 117-121. Such links 117-121 may comprise any known wireline or point-to-point communication links, including without limitation, leased telephone lines, such as T1 or T3 lines, microwave links, free space optical links, integrated services digital network (ISDN) lines, digital subscriber lines (DSLs), low speed (e.g., 56 kilobit per second) data links, cellular telephone links or community access television (CATV) cables. For convenience of illustration only, FIG. 1 shows processing devices 101-105 connected directly to computer network 107. It will be appreciated however that one or more of such connections may not be direct and may instead be made indirectly by way of one or more local area networks, wide area networks or other networks of which any of computer devices 101-105 may form a part. In the event that any processing device 101-105 shown in FIG. 1 as being directly coupled to the computer network 107 is not so directly coupled, it will be appreciated that the communication link 117-121 coupling such processing device 101-105 to the computer network 107 may include other elements, such as switches or switching centers, routers, gateways, bridges, controllers, or any other known components conventionally used to interconnect processing systems or portions thereof. For example, one of ordinary skill will appreciate that communication links 117-121 implemented using telephone lines require data communicated over such links 117-121 to pass through the public-switched telephone network (PSTN) 144.

As an alternative to wireline or point-to-point links, the communication links 117-121 used to couple the processing devices 101-105 to the computer network 107 may include a wireless communication subsystem to facilitate use of a wireless local processing device. Use of a wireless local processing device is desirable in order to reduce the amount of capital at the service provider's place of business and provide mobility with respect permitting the service provider to use system 100 while moving freely in, around and even well beyond the site at which services are rendered. For example, instead of purchasing a PC for each examination room at a physician's office, the physician may use a single, portable network-accessible wireless device to allow the service provider to access the computer network 107 regardless of the physician's location. With such a wireless device, a physician for example, can provide the information necessary to generate a billing report in accordance with the present invention whether attending to patients in the physician's office or in the hospital. An exemplary wireless subsystem forming part of communication link 117 useful for coupling a wireless local processing device 161 to the computer network 107 is illustrated in block diagram form in FIG. 1C and described in detail below.

As a backup or in the event computer network 107 access is not available to the third party (e.g., insurance provider 113) or the insurance claim clearinghouse company 115, facsimile modems/devices 140-142 are optionally employed in the system 100 to facilitate facsimile transmission of information, such as billing reports (e.g., insurance claim forms) and/or medical procedure reports, from the remote processing device 103 to a third party payor or others. Facsimile transmission between the remote processing device 103 and the third party processing device 104, 105 in accordance with known techniques over appropriate communication links 125, 128, 129, such as standard telephone lines supported by the PSTN 144. In such a case, the remote processing device 103 preferably includes an internal facsimile modem (not shown) or is coupled through a telephone cable or other means to an external facsimile modem 140, and includes appropriate software to enable the remote processing device 103 to communicate information to and receive information from other processing devices 104, 105 or facsimile machines via the fax modem 140.

If the processing device 104, 105 of the third party is capable of receiving facsimiles, the processing device 104, 105 may include an internal facsimile modem (not shown) or be coupled through a telephone cable, infrared link or other link 130, 131 to an external facsimile modem 141, 142 and includes appropriate software to enable the processing device 104, 105 to communicate information to and receive information from other processing devices or facsimile machines via the fax modem 141, 142. If the processing device 104, 105 of the third party is not capable of receiving facsimiles and such processing device 104, 105 is not operably coupled to the computer network 107, the third party preferably uses a stand-alone facsimile machine (not shown) which is operably coupled to the PSTN 144 over a respective communication link 128, 129 in accordance with known techniques.

Each processing device 101-105 operates in accordance with software programs stored either in a memory 143 of the processing device or on some other computer-readable media 136-138 operably coupleable to the processing device 101-105 via an appropriate communication link 123, 124, 127. As is known in the art, the computer readable media 136-138 may require the use of a drive device to enable the particular processing device 101-105 to read from and/or write to the media 136-138. Memory 143 is illustrated in block diagram form for remote processing device 103 only, but similar memory is preferably included in each processing device 101-105. The memory 143 preferably comprises read-only memory (ROM), random-access memory (RAM), programmable ROM (PROM), electrically erasable read-only memory (EEPROM), dynamic random access memory (DRAM), Flash ROM, and/or any other form of now-known or future-developed memory. The memory 143 preferably includes multiple memory locations for temporary or permanent storage of, inter alia, the computer programs executed by the respective processing device 103 and data received from other processing devices 101, 102. Memory 143 is one form of computer-readable media that is contained within the processing device 103 itself.

Computer-readable media 136-138 can be internal or external to the processing devices 101-105 and may comprise any now-known or future-developed media for storing data, including without limitation, diskettes, compact disk read only memories (CD-ROMs), digital versatile disks (DVDs), hard drives, ZIP drives, and/or others. The computer-readable media 136-138 preferably include multiple memory locations for temporary or permanent storage of, inter alia, the computer programs executed by the respective processing devices 101-105. The computer-readable media 136-138 are depicted in FIG. 1 with respect to processing devices 101-103 only primarily because the computer programs which may be stored on such media 136-138 and executed by such processing devices 101-103 are of particular importance in accordance with the present invention. However, one of ordinary skill in the art will readily appreciate that processing devices 104, 105 may also be operably coupled to respective computer-readable media.

The billing and reporting system 100 may optionally include one or more printers 133, 134 appropriately located throughout the system 100 and preferably coupled to the computer network 107 and/or respective processing devices 101, 102 via corresponding communication links 122, 126. The printers 133, 134 may be used to print reports or other information in accordance with the present invention as described in more detail below.

FIG. 1C is a block diagram of a portion of the billing and reporting system 100 of FIG. 1 illustrating use of a wireless communication device 161 as either a local processing device (e.g., local processing devices 101 and/or 102) or an interface to a local processing device 101, 102 in accordance with alternative embodiments of the present invention. In one such embodiment, the local processing device 101, 102 comprises a wireless communication device 161 which is operably coupled to the computer network 107 via a wireless communication resource 163 and a wireless communication subsystem which together constitute a portion of the communication link 117, 121 between the local processing device 101, 102 and the computer network 107.

The communication subsystem forming part of the communication link 117, 121 between the wireless local processing device 161 and the computer network 107 may comprise a two-way radio system, a cellular telephone system, a cordless telephone system (e.g., a wireless local loop), a home wireless network, a personal communication system (PCS), a personal area network (e.g., a Bluetooth network), a wireless data system, or any combination or sub-combination thereof. A preferred wireless subsystem illustrated in block diagram form in FIG. 1C comprises the primary infrastructure elements 164-168 of a cellular, cellular-type, or other wireless system. An example of a cellular-type wireless system is the “iDEN” system, which is commercially available from Motorola, Inc. of Schaumburg, Ill. Depending upon the implementation or choice of the wireless subsystem, the wireless communication device 161 may comprise a data-capable mobile or portable radio or radiotelephone, a data-capable cellular phone, a two-way pager or a wireless data device, such as a palmtop computer, a personal digital assistant (PDA) a laptop computer that includes a wireless modem implemented on a Personal Computer Memory Card International Association (PCMCIA) card a custom, dedicated device or the like. Examples of two such wireless modems are the “MINSTREL V” wireless palmtop modem and the “MERLIN” wireless Type II PCMCIA card modem, which are commercially available from Novatel Wireless, Inc. of San Diego, Calif.

When a cellular system is selected to provide the wireless subsystem that couples the wireless local processing device 161 to the computer network 107, the wireless subsystem infrastructure includes, inter alia, an antenna 164 (which is typically located atop an antenna tower), one or more base transceiver sites (BTSs) 165 (one shown), a base site controller (BSC) 165, a mobile switching center (MSC) 167 and an interworking function (IWF) 168 to support data transmissions. The infrastructure components of the wireless subsystem are well known to one of ordinary skill in the art; thus, no further discussion of them will be presented except to facilitate an understanding of the present invention.

The infrastructure components of the wireless subsystem are interconnected via various communication links. Such links may comprise any known communication links, including without limitation, leased telephone lines, such as T1 or T3 lines, microwave links, integrated services digital network (ISDN) lines, digital subscriber lines (DSLs), low speed (e.g., 56 kilobit per second) data links, RS-232 links, or a common hardware bus when the BTS 165 is directly coupled to the BSC 166 (e.g., when the BTS 165 and the BSC 166 are collocated). In the event that any wireless subsystem infrastructure component shown in FIG. 1C as being directly coupled to another component is not so directly coupled, the communication links between such infrastructure components may include other elements, such as switches or switching centers, routers, gateways, bridges, controllers, or any other components used to interconnect communication systems or portions thereof.

As is known, the BTS 165 provides communication service to a respective geographic service coverage area, conveying information to and receiving information from wireless communication devices 161 located in the service coverage area over wireless communication resources 163. Depending on the access scheme utilized in the wireless subsystem, each wireless resource 163 may comprise a frequency carrier, one or more time slots of a frequency carrier, or an orthogonal code implemented by a respective frequency hopping pattern or by a pseudo-random noise sequence spread over a wide (e.g., 3 MHz) bandwidth.

In another embodiment, the local processing device 101, 102 might include or be coupled to its own antenna 162 and wireless transceiver (not shown) to facilitate communication with a wireless communication device 161 over a wireless communication resource 163. In such case, the wireless communication device 161 serves as a remote user interface to the local processing device 101, 102. Such an embodiment would allow the service provider or service facility (e.g., hospital) to utilize a single, centrally-located local processing device 101, 102, without requiring the service provider to walk to the physical location of the processing device 101, 102 to enter appropriate information for generating the billing report for services.

Still further, the service provider's office location or service facility may include its own wireless subsystem with which the wireless communication device 161 would communicate over the wireless resource 163 to provide information to a centrally-located local processing device 101, 102. That is, in this embodiment, the antenna and transceiver are located outside the local processing device 101, 102, and are coupled via a communication link (e.g., telephone line) to the local processing device 101, 102. Similar to the embodiment in which the antenna 162 and the transceiver are incorporated in the local processing device 101, 102, this embodiment would allow the service provider or service facility to utilize a single, centrally-located local processing device 101, 102, without requiring the service provider to walk to the physical location of the processing device 101, 102 to enter appropriate information for generating the billing report. However, local processing device 101, 102 may also consist of or include a wireless communication device 161.

FIG. 1D is a block diagram of a preferred wireless communication device 161 in accordance with the present invention. The wireless device 161 includes, inter alia, an antenna 171, a transceiver 173, a processor 175, a user interface 177, and a display 179. All of these elements 171-179 are well known to one of ordinary skill in the art. For example, the transceiver 173 comprises a transmitter and a receiver, wherein the transmitter includes filters, mixers, a modulator, large-signal amplifiers, and other known elements to produce a radio frequency or microwave signal representation of data for communication over the wireless communication resource 163 to the wireless communication subsystem, and wherein the receiver includes filters, mixers, small-signal amplifiers, a demodulator, and other known elements necessary to produce an analog and/or digital baseband representation of a data message received by the antenna 171 via the wireless communication resource 163. The processor 175 preferably comprises a microprocessor and/or a digital signal processor that operates in accordance with software programs stored in a memory of the processor 175 or in a memory (not shown) in communication with the processor 175. Such memory preferably includes RAM for temporary storage of received data messages and various other forms of memory, such as ROM, PROM, and EEPROM, for more permanent storage of firmware and software programs utilized by the processor 175. A software algorithm as described further below is stored in memory and executed by the processor 175 of communication device 171.

The user interface 177 preferably comprises one or more of various known input devices, such as a keypad, a computer mouse, a touchpad or other pointing device, touchscreen, scrolling thumbwheel, trackball, and/or a keyboard. The display 108 preferably comprises a liquid crystal display or other similar display capable of producing, responsive to processor signaling, graphical displays and/or alpha-numeric displays. Constructed as detailed above, the wireless communication device 161 might comprise a custom, dedicated device, a two-way pager, a data-capable (e.g., Internet-accessible) two-way radio or radiotelephone, or a wireless data device, such as a personal digital assistant (PDA), a laptop computer or a palmtop computer that includes or is coupled to a wireless modem (e.g., such as may be implemented on a PCMCIA card).

The operation of the billing and reporting system 100 in accordance with a preferred embodiment of the present invention will now be described in further detail. The following description will focus primarily on operation of an embodiment in the context of providing medical services to a patient; however, the present invention is not limited to application in the health care field and is equally applicable to generating contemporaneous billing or other reports for any services where the reports are to be submitted to third parties for full or partial payment for rendered services. Thus, describing the invention as deployed in the context of health care services is by way of example and is not limiting of the scope of the claimed invention.

When a patient visits his or her physician or other health care provider, the patient is guided to the examination room 109 by the physician or one of the physician's staff. The physician performs an examination of the patient in the exam room 109. As part of the examination, the physician renders a cognitive level of care to the patient and the physician, or a staff member (e.g., a nurse) may render a particular level of non-cognitive care depending on the patient's condition. The cognitive care typically includes listening to the patient describe his or her symptoms, if any, visually looking at the patient to detect any signs of illness, reviewing the patient's chart (e.g., to analyze the patient's medical and family history), perform a physical examination of the patient, make a preliminary diagnosis based on the examination, signs, symptoms, and history, and recommend, as necessary, a non-cognitive level of care for the patient. The non-cognitive level of care may include clinical tests (e.g., X-ray, blood tests, stress test, and so forth) and/or other medical procedures or treatment (e.g., surgery, radiation, prescriptions, and so forth). Certain non-cognitive levels of care may be administered in the physician's exam room 109 immediately following the patient's physical examination (e.g., lesion biopsy or removal, or ultrasound).

In accordance with the invention, during the examination or shortly thereafter, the physician accesses either a local processing device 101 that is located in the exam room 109 or at a central location of the physician's office (e.g., an Internet-accessible PC), or a wireless communication device 161 which the physician carries with him or her (e.g., an Internet-accessible wireless communication device 161). The physician instructs the local processing device 101 to execute software stored in a memory of the device 101 or on some other computer-readable media 136 coupled to the device 101 (e.g., by using a mouse to double-click or single-click on an icon indicative of the software program or selecting an equivalent software program indicator using some other user interface, such as a touchscreen, a keyboard or keypad function key or arrow button, a voice-activated program or so forth). The local device software allows the local device 101 to access the remote processing device 103 and request access to the data recording and billing software application stored in a memory 143 of the remote processing device 103 or on some other computer-readable media 137 operably coupled to the remote processing device 103. In a preferred embodiment, the local and remote processing devices 101 and 103, respectively are interconnected to one another via a wide area computer network 107, such as the Internet, and the remote processing device 103 is an Internet server which may be operated by an application service provider (ASP).

Responsive to the local processing device's access request, the remote processing device 103 communicates, via the computer network 107 and any necessary communication links 117, 118, a log-on screen to the local processing device 101 wireless and/or communication device 161 for display to the physician. Data identifying both the physician and the patient are then entered. To do so, the physician may use the keyboard, pointing device and/or other user interface. For example, a microphone linked to a processing device 101 equipped with appropriate voice-recognition software may be used to enter the physician's pre-established identification (ID) number or other alpha-numeric text string ID (e.g., name, medical license number, taxpayer identification number, federal employer identification (FEI) number, or social security number). For example, in the U.S., each licensed physician is uniquely identified by a Universal Provider Identification Number (“UPIN”). In addition to entering his or her own UPIN number, the attending physician would also enter the UPIN number of any referring physician since that information is also routinely required by insurance companies or other third party payors. To facilitate looking up the UPIN number of the referring physician, the software preferably includes a link to the UPIN website or other database including such information. The patient's ID number or other alpha-numeric text string ID (e.g., name or social security number), and, if appropriate, the patient's Insurance group number are also entered. After entering or retrieving the above information, the physician depresses the “ENTER” key on the keyboard or selects an “ENTER” or “OK” virtual button displayed on the display 150 of local device 101 or display 179 of wireless device 179 by using a touchscreen, mouse or other user interface 155 or 177 to indicate completion of the log-in process and impliedly request a menu or list of identifiers related to the services. The physician and/or the patient may have an encoded electronic and/or magnetic swipe card by which some or all of the data just mentioned can be entered. Responsive to the physician's inputs, the local processing device 101 communicates the entered information to the remote processing device 103 via the computer network 107 and any necessary communication links 117, 118.

Alternatively, the local processing device 101 may already be accessing the remote processing device 103 when the physician begins using the local device 101. That is, the physician may have signed or logged himself or herself onto the remote processing device 103 upon initially arriving to the office or even beforehand (e.g., in the car on the way to the office when the local processing device 101 comprises a wireless device 161). In such a case, only patient information need be provided to complete the log-on procedure. Thus, in this case, entry of the patient ID constitutes an implied request to receive the medical service codes identifying services to be performed for that patient.

In the context of a modern medical practice, services rendered and to be billed are identified by various standard codes familiar to those skilled in the art. For example, the service-related identifiers comprise cognitive CPT codes for cognitive procedures or services, non-cognitive CPT codes for non-cognitive procedures or services, ICD codes for disease identification related to non-cognitive procedures or services, and diagnostic indication codes for identification of particular symptoms, signs, or other irregularities that support a recommended non-cognitive level of care. As those skilled in the art will recognize, CPT codes may have appended thereto certain additional codes known as “modifiers” which identify a type of service rendered under a particular CPT code with even more specificity than the CPT code above. In the context of non-medical services, services may readily be identified by service codes or other identifiers related to the services that have been previously agreed to between the service provider and the party or parties that will be at least partially responsible for payment.

The service-related identifiers (e.g., CPT or other medical codes) are preferably stored in the memory 143 of the remote processing device 103 or on some other computer-readable media 137 coupled to the remote processing device 103 before the patient's visit. Typically, such identifiers and their groupings (e.g., heirarchical listings allowing for rapid narrowing and selection of an appropriate identifier) would be stored some time after the physician decides to begin seeing patients having a particular insurance provider and before the physician actually begins servicing such patients.

In a preferred embodiment, the stored identifiers comprise cognitive CPT codes, non-cognitive CPT codes, ICD-9 codes and diagnostic indication codes, along with associated descriptive terminology (e.g., ICD code 710.3 and associated description Dermatomyositis). Such codes are promulgated by various organizations, including HCFA, and are used and/or required by most third party payors such as insurance providers. However, billing codes specific to a particular insurance provider may also be stored. The proper identifiers to be presented to the physician are preferably selected from all the stored codes and associated descriptors, narrowed as appropriate based on context information such as the location of services and the ID for the physician. For example, the physician's ID may be compared to a medical specialty database, and the location compared to a database of possible services performed at the location, to limit the codes presented to the medical specialty (e.g., cardiology) and available care (e.g., cognitive only at an office) of the physician. Similarly, the patient's ID may be compared to a payor (e.g. insurance provider) database to identify the patient's insurer and select the service codes related to the medical specialty of the physician that are acceptable to the patient's insurer or other payor(s). Further, the identifier presented to the physician may be limited to the associated descriptive terminology, e.g., if the descriptor is sufficient for the physician's selection process and the display is constrained (as in a PDA). In this case the descriptor may be associated with a code via the LPD or RPD, and, as appropriate, matched up with yet other coding used by the clearinghouse or payor when forwarding the claim.

In order to minimize the amount of time that the service provider has to spend entering information, as much relevant information as feasible is already stored in one of the system data stores in a manner convenient for retrieval at the time services are rendered. Thus, e.g., in one preferred embodiment certain service context information, captured at a variety of times preceding the time of the visit or procedure, is previously stored in the system. If the patient is a new patient, then at the time of scheduling or when the patient first shows up for the appointment, information is entered identifying the patient (e.g., name, address, social security number and birth date, relevant history), the patient's medical cost payor (e.g., employer, insurance and coverage information), the doctor's information (e.g., identifying both the doctor and office/facility involved), and the nature of the visit. Information about the nature of the visit can be important, since when a patient is scheduled certain aspects of the services that can be given are predetermined. Thus, e.g., if a patient is scheduled as a new consultation, that means the referring physician has referred the patient to the office and told the office of the new patient evaluation; the office staff will then have scheduled that patient for a particular type of visit—and thus a particular group of E&Ms (consultation)—and already decided, for the most part, the level of care to be given.

Given the predetermined nature of these factors, all this information can be entered and available for use by the system at the time the service provider sees the patient. Not all this information need be available to the remote device, but as much information that is relevant to facilitate the data capture and reporting contemporaneous with the services should be accessible.

In one embodiment, the system includes the capability of pre-selecting the information that will be presented to the service provider based on this initial service context information. If the Care Type is predetermined (e.g., the scheduling dictates the care type available), the display provided to the doctor is tailored to include the information the doctor typically expects to interact within the expected type of visit (e.g., levels of care within the group). While the physician will make the final decision regarding the group and level of care appropriate, scheduling will typically have predetermined, e.g., whether the patient is visiting as a new patient, for an office consultation, or a return office visit; and often has decided whether it will be a high level visit, consultation, or evaluation, or a low level service. This is typically necessitated by the specific times allotted for each patient (i.e., you cannot schedule thirty patients for new evaluations where each one takes approximately an hour). This practice reality can be captured by appropriate system rules.

For typical medical services, it may be convenient to start with point of service information, since many levels of service are of necessity excluded based on where the services are rendered. In other words, a type of location can be expected to be associated with a limited group of care type codes. Examples of locations may include: an emergency room; hospital (other than emergency room); office; nursing home; patient's home; federal facility; etc.) Once a location is determined, the scheduled nature of the service is processed. For example, if the service is at an office, the available or displayed groups for office evaluation services may include: new patient; new office consultation; and return office visits. Within each of these groups there may be different (e.g., five) levels of care. Each of these levels relates to the service to be rendered, with the higher levels representing higher value service. At each level HCFA has typically specified what components of the history, physical, and management elements must be included to satisfy reimbursement requirements for that level.

When proceeding with the visit, the physician will typically want to validate or approve the type of service being performed. Once the type of care is established, the physician will perform (or as appropriate verify or review) the history, physical examination, and other components of the management recommendations. In a typical practice, the physician will likely dictate information required by HCFA or the payor; the required elements may be optionally presented as bullets or other display format based on the E&M group, as an aid to the physician 308. She or he will then select the diagnosis code (e.g., ICD code 312) which is most appropriate for the information obtained.

If the physician has logged onto the remote processing device 103 and accessed the stored recording and billing software application, the remote processing device 103 may, in accordance with operation of the software application, store and communicate the first group (or the only group if there is only one group) of identifiers or service codes and their associated service descriptions to the local processing device 101 via the computer network 107 and any necessary communication links 117, 118. In the typical medical service context, the first group of identifiers comprise a type of care identifier (e.g., identifying a level of care or CPT code). Since there are many practice areas in medicine, each with its own set of service-related identifiers, the remote processing device 103 may, again, automatically select the appropriate group of identifiers based on the physician's ID and location of services. That is, the remote processing device 103 accesses a database stored in its memory 143 or on another computer-readable media 137 to determine the medical practice area of the received service provider ID. After determining the practice area (e.g., cardiology), the remote processing device 103 retrieves the appropriate set of service type identifiers related to the identified practice area and communicates the codes to the local processing device 101 for display to the physician. This information may alternatively be stored on the local device (e.g., for use when not connected to the remote device).

Alternatively, the software executed by the remote-processing device 103 might, upon receiving the physician's ID, communicate local processing device 101 data specifying a screen to be displayed on display 150 allowing the physician to select the practice area to which the service-related identifiers are to apply. For example, if the physician practices in both cardiology and neurology, the remote processing device 103 might determine that the physician has such specialties based on looking up the physician's ID in a practice area database and communicate a menu or list of practice area identifiers to the local processing device 101 for display to the physician. The physician would then select the appropriate practice area and, responsive to such selection, the remote-processing device 103 would return the cognitive CPT codes and service descriptions for the selected practice area.

A preferred embodiment may be better understood by more detailed explanation of the processes involved in connection with the devices involved. Upon receiving the service codes and descriptions, the local processing device 101 displays the codes and descriptions to the physician. The codes and associated service descriptions are displayed in such a manner as to enable the physician to rapidly select the proper identifier for the care rendered to the patient. In one embodiment, the cognitive CPT codes are organized such that the physician first views the codes or identifiers that relate to the physiological condition of the patient, and then views the codes or identifiers that relate to the anatomical condition of the patient. For example, the local processing device 101 might first display a menu of cognitive CPT codes that relate to the physiological condition of the patient (e.g., signs detected by the physician prior to performing any physical examination of the patient and/or symptoms reported by the patient). After the physician selects one or more of the physiological codes using the local processing device's user interface (e.g., after the physician uses the mouse to select appropriate codes and depresses the “ENTER” button on the keyboard or selects the “ENTER” or “NEXT” virtual button displayed on the screen using the mouse), the local processing device 103 might display a menu of anatomical codes for selection by the physician. If either group or set of identifiers requires more than one screen for viewing, a command set may be communicated together with the codes from the remote processing device 103 to the local processing device 101 to allow the physician to advance to the next page or screen of codes using the local device's user interface.

Alternatively, depending on the quantity of possible identifiers, the identifiers are preferably pre-sorted into logical hierarchies, such that the physician first selects an appropriate group or category encompassing the type of service rendered, and in response a list of related identifiers within the group are presented for further selection by the physician. By displaying groups and identifiers in this manner, the remote processing device 103 software application attempts to display the identifiers in an order that logically coincides with the physician's internal mental processes as the physician is rendering the services to the patient. Where both service identifiers (e.g., level of care or CPT codes) and supporting identifiers such as condition codes (e.g., ICD diagnosis codes) are being captured, the information is preferably presented in the order in which the physician would efficiently approach the service delivery process. In a typical office visit, the physician would proceed first to approve (either by selection of an identifier or other indication of concurrence with a predetermined selection) the appropriate service identifier (e.g., level of care code); next receive condition group names appropriate for that level of care and context information; then select an appropriate identifier from a list of that group's identifiers displayed; and enter other appropriate information (e.g., indications, history and other information such as described later). For example, physicians may typically analyze the signs and symptoms (e.g., render a cognitive physiological assessment) before performing an anatomical (physical) examination the patient. Accordingly, the identifiers are preferably displayed to the physician in the typical order of examination. Displaying the identifiers in such an ordered process allows the physician to very rapidly (on the order of several seconds to a minute for more complex service) make the appropriate selections, in contrast to merely recording descriptions of the service rendered for later conversion via code books into an approved form for submission in a claim (requiring the physician and staff together to expend substantially more time (on the order of minutes, at different times) searching for the appropriate codes, preparing the reports, and (much later) correcting information as required by the payor).

Still further, the remote processing device 103 software may facilitate textual searches of the service descriptions (e.g., through a simple query language (SQL) search) to enable the physician or other service provider to rapidly locate the appropriate identifier for the service rendered to the patient. In this case, the remote processing device 103 may cause to be displayed a screen, e.g., entitled “COGNITIVE CPT CODES” or that includes some other appropriate title, and that includes one or more search term entry fields and a means (e.g., a mouse-selectable virtual button entitled “SEARCH”) for instructing the remote processing device 103 to perform the search. Responsive to the search request, the remote processing device 103 would search a service description relational database or other list/grouping stored in memory 143 or on some other computer-readable media 137 and communicate the resultant descriptions and CPT codes, if any, found in the search to the local processing device 101 for display to the physician. The physician would then use the user interface of the local processing device 101 to select the appropriate CPT code.

By way of more detailed example, after the physician has completed selecting the appropriate cognitive CPT codes from the menu or menus of cognitive CPT codes and has preferably indicated such completion (e.g., by using the mouse to select the “OK”, “END”, “NON-COGNITIVE CPTs”, or some other appropriately entitled virtual button on the display), the local processing device 101 communicates the selected codes to the remote processing device 103 via the computer network 107 and any necessary. communication links 117, 118. Alternatively, if the physician is unsure as to which cognitive CPT codes must be selected to comply with the reporting requirements of the patient's insurer (e.g., reporting requirements promulgated by HCFA), the physician may request display of the insurer's reporting requirements by using the computer mouse or other user interface device to select an appropriately-labeled virtual button (e.g., “REPORTING REQUIREMENTS” or “BULLETS”) to submit the request. Responsive to receiving such a request from the local processing device 101, the remote processing device 103 retrieves the requested reporting requirements from memory 143 or other computer-readable media 137 and communicates the reporting requirements to the local processing device 101 for display to the physician.

Responsive to receiving the selected cognitive CPT code(s), the remote processing device 103 automatically communicates a menu or other display of non-cognitive CPT codes to the local processing device 101 for display to the physician. If non-cognitive care is not necessary for the particular patient, the physician may use the computer mouse or other user interface device to select a “CANCEL” virtual button. Alternatively, the remote processing device 103 might, prior to communicating the non-cognitive CPT code(s), send a message to the local processing device 101 for display to the physician in which the physician is asked if he or she wants to receive non-cognitive CPT codes or whether a non-cognitive level of care is required for the patient. If non-cognitive care is not necessary, the physician uses the user interface of the local processing device to answer the query negatively; whereas, if non-cognitive care is necessary, the physician uses the user interface to answer the query affirmatively.

Assuming for the purposes of the following discussion that a non-cognitive level of care is required for the patient, the local processing device 101 and/or wireless communication device 161 displays a menu or, as will be later described, a graphical presentation of non-cognitive CPT codes and their associated care descriptions (e.g., tests or procedures) to the physician. The physician then scrolls through the list of non-cognitive CPT codes or uses a touchscreen, mouse or other pointing device to find and select the particular code or codes corresponding to the recommended treatment plan. Alternatively or additionally, the remote processing device 103 software may support electronic searching as discussed above with respect to the selection of cognitive CPT codes. In such a case, the physician may input search term(s) for an SQL or other query of the non-cognitive level of care service descriptions and the remote processing device 103 would execute the search and communicate the search results to the local processing device 101 and/or wireless communication device 161 for display to the physician. The physician would then select the appropriate non-cognitive CPT codes from the search results or request a new search.

After the physician selects the appropriate non-cognitive CPT codes, the local processing device 101 communicates the selected codes or identifiers to the remote-processing device 103 via the computer network 107 and any necessary communication links 117, 118. The remote processing device 103 stores the received codes in memory 143 or on another computer-readable media 137 operably coupled thereto in accordance with the DRBA, and preferably automatically communicates a menu or list of health care condition codes and descriptions to the local processing device 101 for display to the physician. The health care condition codes and descriptions preferably comprise ICD-9 codes and descriptions promulgated by HCFA in conjunction with the AMA. The physician, using the user interface of local device 101 or wireless communication device 161 scrolls or pages through the displayed ICD-9 codes and descriptions, or executes an SQL or equivalent query, to locate and select the appropriate ICD-9 code(s) or identifier(s). The device 101 and/or 161 communicates the physician's selection(s) to the remote processing device 103 via the computer network 107 for storage in the remote device's memory 143 or some other computer-readable media 137 coupled to the remote device 103. Alternatively, the remote processing device 103 may delay communicating the menu or list of health care condition codes to the local processing device 101 until the physician expressly requests them via the local processing device 101 (e.g., after the physician selects a virtual button or icon entitled “ICD-9 CODES” or equivalent with the computer mouse or other user interface).

After receiving the physician's selection(s) of ICD-9 codes or alternatively before receiving ICD-9 code selections but after receiving non-cognitive CPT code selections, the remote processing device 103 preferably automatically communicates a menu or list of diagnostic indication codes or identifiers and associated diagnostic indication descriptions to the local processing device 101 and/or wireless communication device 161 for display to the physician. The diagnostic indication codes and descriptions preferably comprise codes and descriptions promulgated by HCFA (or the state specific intermediary Local Medical Review Program (LMRP)), and only those ICD-9 codes which are specific and exclusive to the non-cognitive CPT. The physician, using the user interface of local device 101 and/or wireless communication device 161 scrolls or pages through the displayed diagnostic indication codes and descriptions, or executes an SQL or equivalent query, to locate and select the appropriate diagnostic indication code(s) or identifier(s). The device 101 and/or 161 communicates the physician's selection(s) to the remote processing device 103 via the computer network 107 for storage in the remote device's memory 143 or some other computer-readable media 137 coupled to the remote device 103. Alternatively, the remote processing device 103 may delay communicating the menu or list of diagnostic indication codes and descriptions to device 101 and/or 161 until the physician expressly requests them via device 101 and/or 161 (e.g., after the physician selects a virtual button or icon entitled “DIAGNOSTIC INDICATIONS” or equivalent with the computer mouse or other user interface).

After selecting appropriate cognitive CPT codes and, if applicable, non-cognitive CPT codes, ICD-9 codes, and diagnostic indication codes, the physician has completed all the entries necessary for the remote processing device 103 to generate in accordance with its software, a billing report for the rendered medical services. In the medical field, the billing report preferably comprises the conventional HCA “1500” insurance claim form promulgated by HCFA. Alternatively, the billing report may comply with any billing report requirements of the patient's particular third party payor(s).

In the event that the physician cannot locate an approved combination of service and condition identifiers and/or indication(s) which correspond to the service provided or treatment recommended for the patient, each entry process (e.g., at an appropriate point in the series of screens for recording information about a visit or ordering a procedure) preferably includes a means (e.g., icon leading to an entry screen) for requesting display of an advance beneficiary notice (ABN) or similar exception template promulgated for use in such circumstances e.g. by the federal government. The ABN template allows the physician to describe in writing the reasons for a particular diagnosis or recommended treatment plan when such a plan or diagnosis does not fit within the insurer-approved codes and descriptions (and accordingly may not be covered by the insurer). The code or identifier might be all zeroes followed by a description, such as “NONE OF THE ABOVE”, “ABN”, “OTHER”, or any other description identifying or suggesting access to an ABN template. In addition to use for ABN notification, other exception information or requests that may be required or recommended by third party payors are, preferably, similarly displayed prompting the service provider to enter additional information for use in processing the billing report.

If an ABN template is necessary, the physician selects the ABN identifier using the user interface of device 101 and/or 161. The local processing device 101 converts the selection into a request for the ABN template and communicates the request to the remote processing device 103 via the computer network 107 and any necessary communication links 117, 118. Upon receiving such request, the remote device 103 retrieves the ABN template from memory 143 or some other computer-readable media 137 and communicates the template to the local device 101 via the computer network 107. The device 101 and/or 161 displays the template to the physician and receives entries into the template from the physician via the user interface. When the physician has completed the template entries, the physician indicates such completion (e.g., by selecting a virtual “OK” or “DONE” button with the computer mouse) and the local device 101 stores the entries in RAM and communicates the completed template to the remote device 103 for storage in memory 143 or on some other computer-readable media 137. In a preferred embodiment, the template entries include an electronic signature of the patient obtained in accordance with known techniques, such as through the use of the “APPROVEIT” software which is commercially-available from Silanis Technology Inc. of Montreal, Canada. One such entry asks whether the patient desires a submission of a claim form (e.g. an HCA 1500 form) to the insurer to purposely receive a denial from the primary carrier so that the secondary insurance can accept or deny the claim. When this occurs, an appropriate modifier is added to the cognitive, non-cognitive CPT code submitted to the primary insurance carrier.

In the event that the physician is unsure of which service-related parameter(s) (e.g., cognitive CPT code(s), non-cognitive CPT code(s), ICD-9 code(s) and/or diagnostic indication code(s)) must be selected to comply with the reporting requirements of the patient's insurer or other third party payor(s), the physician may use the user interface of devices 101 and/or 161 to request display of the insurer's reporting requirements (e.g., by using the user interface to select a virtual button or icon entitled “VIEW REPORTING REQUIREMENTS” or equivalent which may be presented on the local device's screen or display). The requirements are preferably stored in the memory 143 of the remote processing device 103 or in some other computer-readable media 137 operably coupled to and accessible by the remote processing device 103. Responsive to receiving the selection from the physician, the local processing device 101 communicates a request for the reporting requirements to the remote processing device 103 via the computer network 107 and any necessary communication links 117, 118. The remote processing device 103 responds to the request by communicating the reporting requirements to the local processing device 101 and/or wireless communication device 161 via the computer network 107 for display to the physician.

After the appropriate codes and/or templates have been selected and/or completed, the physician may instruct the remote device 103 via the software to generate a billing report (e.g., insurance claim form) for the rendered services (e.g., by selecting a “GENERATE CLAIM FORM” or equivalent virtual button using a computer mouse or other user interface device). The physician's selection is converted into a request and communicated to the remote device 103 via the computer network 107 and any necessary communication links 117, 118. The remote processing device 103 receives the request and, prior to executing it, preferably automatically executes a compliance software module that determines whether or not the codes and other information entered and/or selected by the physician meet the billing and reporting requirements of the patient's insurance provider. The compliance module compares the entered and/or selected codes with the codes that are acceptable to the patient's insurer and optionally computes a percentage of compliance or other compliance metric. The compliance module is stored in the remote device's memory 143 or on an alternative computer-readable media 137 operably coupled to the remote device 103. Use of the compliance module reduces the chance that a claim will be rejected or delayed.

In the event that the selected and/or entered codes satisfactorily comply with the reporting requirements of the insurer, the remote device 103 generates the insurance claim form based on the identifying information, service codes entered by the physician and communicates the form electronically either directly to the patient's insurance provider 113 (or other third party payor(s)) or alternatively to a clearinghouse such as an insurance claim clearinghouse 115 for initial review Preferably, the insurer 113 or the insurance claim clearinghouse 115 is coupled to the computer network 107 via respective communication links 119, 120, the remote device 103 preferably communicates the insurance claim form to the appropriate one of the insurance provider 113 and the insurance claim clearinghouse 115 via the computer network 107. However, if the insurer 113 or the insurance claim clearinghouse 115 does not have access to the computer network 107, the remote device 103 preferably communicates the insurance claim form in electronic form to a facsimile modem 140 coupled to or within the device 103. The facsimile modem 140 is used to communicate the claim form via the PSTN 144 and appropriate communication links 125, 128, 129 to a recipient facsimile machine or modem 141, 142 at the target insurance provider 113 or insurance claim clearinghouse 115. When the insurer or other payor requires a “paper claim” such is created according to HCFA regulations, and mailed, unfolded per HCFA protocol. In instance where six or more CPT codes are submitted on a specific patient by a specific physician or other health care provider on the same day, the system may be programmed to automatically default to the paper claim protocol, unless specifically overridden.

The software on the local processing device 101 and on the remote-processing device 103 also facilitates printing the completed insurance claim form on a printer 133 coupled to the computer network 107. If a printout is desired, the physician may select a “PRINT” button, pull-down menu item or equivalent using the local device's user interface. Responsive to receiving the print request, the local device 101 preferably communicates the insurance claim form data to the printer 133 in accordance with known techniques.

In an alternative embodiment, the remote processing device 103 automatically executes the compliance routine and generate the billing report and/or non-compliance alert responsive to receiving an indication from the device 101 and/or 102 signifying the end of billing information entry. For example, the physician might select an “END TASK” button upon completion of selecting all the service-related codes or identifiers pertaining to the rendered and/or recommended medical services for a particular patient on a particular visit. The local device 101 receives the “END TASK” command and communicates a data message to the remote device 103 via the computer network 107 bearing a similar command. Responsive to receiving the end-of-task command, the remote device 103 executes the auto-compliance routine and, if a satisfactory level of compliance is met, generates and sends the insurance claim form to the insurance provider 113, insurance claim clearinghouse 115, and/or printer 133 pursuant to previously stored or default instructions maintained at the remote device 103.

Additionally, when a non-cognitive level of care is necessary, the remote processing device 103 optionally communicates with a scheduling computer (not shown) located at the hospital, clinic, or other medical service location 111 to schedule the procedure or test recommended for the patient. In such a case, the remote processing device 103 might further receive from the local processing device 101 (e.g., responsive to the physician's selection from a menu) an ID code for the clinical test facility 111 at which the test or procedure is to be performed. After receiving the facility ID code, the remote device 103 might consult a database relating facility ID codes to Internet Protocol (IP) addresses of scheduling computers for the facilities. The remote device 103 would then communicate a scheduling request to the scheduling computer via the computer network 107 and would receive a date and time for the test or procedure. The remote device 103 forwards the scheduling information to the local processing device 101 for display to the physician or, if the scheduling request also includes the IP address of the local processing device 101, the scheduling computer communicates the scheduling information to the local device 101 directly via the computer network 107. Upon receiving the scheduling information, the physician can inform the patient of such information.

To facilitate insurance payment for non-cognitive care administered to a patient, a payor such as a private insurance provider or the federal government, typically requires submission of a medical procedure report detailing the procedure or test performed on the patient. In accordance with a preferred embodiment of the present invention, the medical procedure report is also generated by the remote processing device 103 and submitted electronically to the payor such as insurance provider 111 or insurance claim clearinghouse 115. Prior to the start of the procedure or test, the health care provider administering the non-cognitive care (which may be the physician that ordered the care originally) uses a local processing device 102 located at the location where the non-cognitive services are to be rendered to access the remote processing device 103 via the computer network 107. Such access preferably includes a log-on procedure as described above in which the health care provider inputs all necessary identifying information such as the provider's ID, the patient's ID, and optionally the patient's group ID. Once access has been obtained, the health care provider uses the local processing device 102 and/or an associated wireless processing device 161 to retrieve the non-cognitive CPT codes, ICD-9 codes, and diagnostic indication codes together with their respective descriptions which were previously selected by the patient's physician and stored in a computer-readable media, such as the remote device's memory 143 or another computer-readable media 137 operably coupled to the remote processing device 103. The local processing device 102 and/or wireless communication device 161 displays the retrieved codes and descriptions to the health care provider to enable the health care provider to understand the basis for the test or procedure and to verify which test or procedure was ordered. The test or procedure is then administered to the patient and the results of the test or a summary of the procedure are communicated or downloaded from device 102 and/or 161 to the remote processing device 103 via the computer network 107 and appropriate communication links 118, 121 for storage at the remote device 103.

The timing of the communication of the test results or procedure summary to the remote processing device 103 can vary according to the type of care provided and the discretion of the health care provider. Thus, the information (e.g., summary or results) resulting from administration of the non-cognitive level of care may be communicated to the remote processing device 103 at any time after administration of the care begins. For example, if the health care provider is administering an echocardiogram (“echo”) test to the patient, the echo data may be fed directly to the local processing device 102, which in turn may provide the data to the remote processing device 103 during administration of the test in real time. Alternatively, if the patient is receiving open-heart surgery, the summary of the surgery may be entered into the wireless communication device 161 and/or directly into local processing device 102 and downloaded to remote device 103 after completion of the surgery.

After the non-cognitive care has been administered and the information related to administration of the care has been communicated to the remote processing device 103, the remote processing device 103 generates a medical procedure report on an insurer-approved form stored on a computer-readable media 137, 143 accessible by the remote processing device 103. The report may be generated automatically upon receiving all necessary information or responsive to a request for generation of the report made by the health care provider via the local processing device 102. In addition to receiving the information resulting from administration of the non-cognitive level of care, the remote device 103 also receives the health care provider's selections of appropriate non-cognitive CPT codes to support the health care provider's billing for administering the non-cognitive level of care. Such non-cognitive CPT codes may be entered by the health care provider in the manner described above (e.g., responsive to viewing a menu of codes or identifiers) or such codes may be automatically selected based on information input into the local processing device 102 during administration of the non-cognitive care.

For example, the health care provider may access a graphical user interface incorporating an anatomical graphic image retrieved from the remote-processing device 103 for display to the health care provider either prior to, during or after administration of the procedure. The health care provider may then select, using a touchscreen or other user input device on the local processing device 101, 102 including any wireless communication device 161 associated therewith, certain locations on the image to indicate certain aspects of the procedure which are important for identifying the procedure sufficiently for insurance billing purposes. Responsive to the selections made via the touchscreen or other input device associated with the graphical user interface 155, the local processing device 102 converts the identified locations into appropriately-formatted data and communicates the data to the remote processing device 103, which in turn evaluates the data and automatically selects the appropriate non-cognitive CPT code(s) to accurately bill for the procedure. A more detailed explanation of the use of such graphical user interface entry of billing information is provided below with respect to FIGS. 11 and 12 for an exemplary balloon angioplasty procedure

The medical procedure report is communicated by the remote processing device 103 together with the insurance claim form to the insurance provider 113 or insurance claim clearinghouse 115 either automatically upon completion of both the report and the form or responsive to a request by the health care provider entered into the local device 102. The medical procedure report may also be communicated to a printer 134 in the event that the health care provider or patient desires a copy of the report. Communication of the report to the insurance provider 113 and/or insurance claim clearinghouse 115 preferably occurs electronically via the computer network 107 or by facsimile as described above.

The remote processing device 103 preferably executes an auto-compliance routine as described above prior to communicating the report and insurance claim form to substantially reduce the likelihood that the submitted report and form do not comply with the insurance provider's and/or the federal government's reporting requirements. The auto-compliance routine significantly increases the likelihood that the submitted form and report will be accepted upon submission and reduces the likelihood of additional delays in receiving payment due to errors in submitted claim forms and medical procedure reports. In a preferred embodiment, rather than using a single auto-compliance routine, verification steps will be added at each appropriate step within the entry process. Thus, as a physician is entering information (e.g., a condition identifier), he can be immediately prompted to verify his selection and, e.g., either change it or fill out an appropriate exception or ABN screen.

Under federal guidelines, physicians are required to report the amount of time they have spent rendering medical services. The physician preferably accesses the device 101 either directly or via any wireless communication device 161 associated therewith, at the time when the physician enters the examination room 109 and the local processing device software starts a timer to compute the amount of time the physician spent with the patient. For example, the physician may enter the patient's ID number and group number into the local processing device 101 and instruct the timer to stop or the time may be programmed to stop automatically upon occurrence of a predetermined event or satisfaction of one or more predetermined conditions. For example, the timer may upon the local processing device's 101 access to the remote-processing device 103 or upon entry of a stop command via local processing device 101. Such access of the remote processing device 103 may then result in the automatic transmission of the examination time to a memory location of the remote processing device's memory 143 which is associated with the patient and/or reporting time spent.

In the event that the local processing device 101 comprises or is associated with a wireless communication device 161, the access request and log-on completion indication (request for service-related identifier menu) are communicated via radio signals transmitted over a wireless communication resource 163. Such radio signals are generated by the processor 175 and transmitted by the transceiver 173 in accordance with known wireless communication techniques. The radio signals are received by the wireless infrastructure subsystem of communication link 117 and are further communicated to the remote processing device 103 via the computer network 107 and communication link 118. The menu(s) of identifiers are communicated to the wireless device 161 from the remote-processing device 103 via the wireless infrastructure subsystem as radio signals. Such radio signals are received by the transceiver 173, translated by the processor 175 into a format suitable for presentment on the display 179, and presented on the display 179 to the physician or other service provider. The physician's selection of a particular identifier or code is received by the wireless communication device 161 through the user interface 177 (e.g., keypad or touchscreen). The selected parameter(s) are processed by the processor 175 into an indication of the selected parameter(s) (e.g., data message) having a format suitable for transmission by the transceiver 173. The transceiver 173 transmits the indication as a radio signal to the wireless infrastructure subsystem of communication link 117 for further communication to the remote processing device 103 via the computer network 107 and communication link 118. All the other communications (e.g., communication of instruction to generate billing report, communication of service time, and so forth) between the remote processing device 103 and the wireless communication device 161 occur in the form of radio signals bearing the respective information which are communicated over the wireless communication resource 163.

As described above, the present invention provides a billing and reporting method and system that enables service providers to rapidly bill for rendered services in a manner that complies with billing and reporting requirements of third parties which are at least partially responsible for payment for the services. In accordance with the present invention at substantially the same time and substantially the same place services are actually rendered, a single operator, preferably the service provider himself or herself, can rapidly select and enter via a local processing device 101 and/or wireless communication device 161 associated therewith, service-related identifiers to facilitate generation of a billing report or invoice for the services by a remotely located computer or server. Therefore, in contrast to prior art medical billing approaches which typically require billing staff to make educated guesses as to the appropriate billing codes based on a physician's notes or transcribed dictation, the present invention enables the physician himself or herself to select the appropriate billing codes for rendered services from lists of codes that have been approved by the patient's insurer and/or the federal government. Importantly, through its preferred presentation of at least some of the identifiers or service codes (e.g., cognitive CPT codes for medical services), the present invention enables the service provider to make billing code selections rapidly (e.g., in 20 to 30 seconds) to mitigate the amount of time that the service provider must concern himself or herself with billing formalities. Further, the present invention facilitates electronic generation and submission of both insurance claim forms (or other billing reports or invoices) and medical procedure reports in support of invoiced services. Still further, the present invention provides a wireless communication device 161 that may be used as either the local processing device 101, 102 or an interface to the local processing device 101, 102 via a wireless communication device 161 to allow the service provider to access the remote processing device 103 and enter billing code information regardless of where the services are rendered.

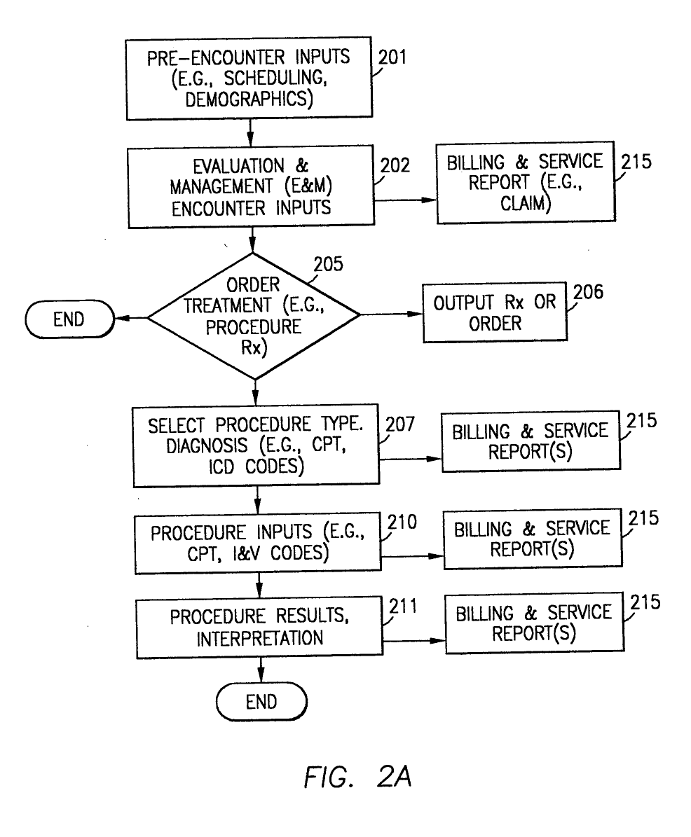

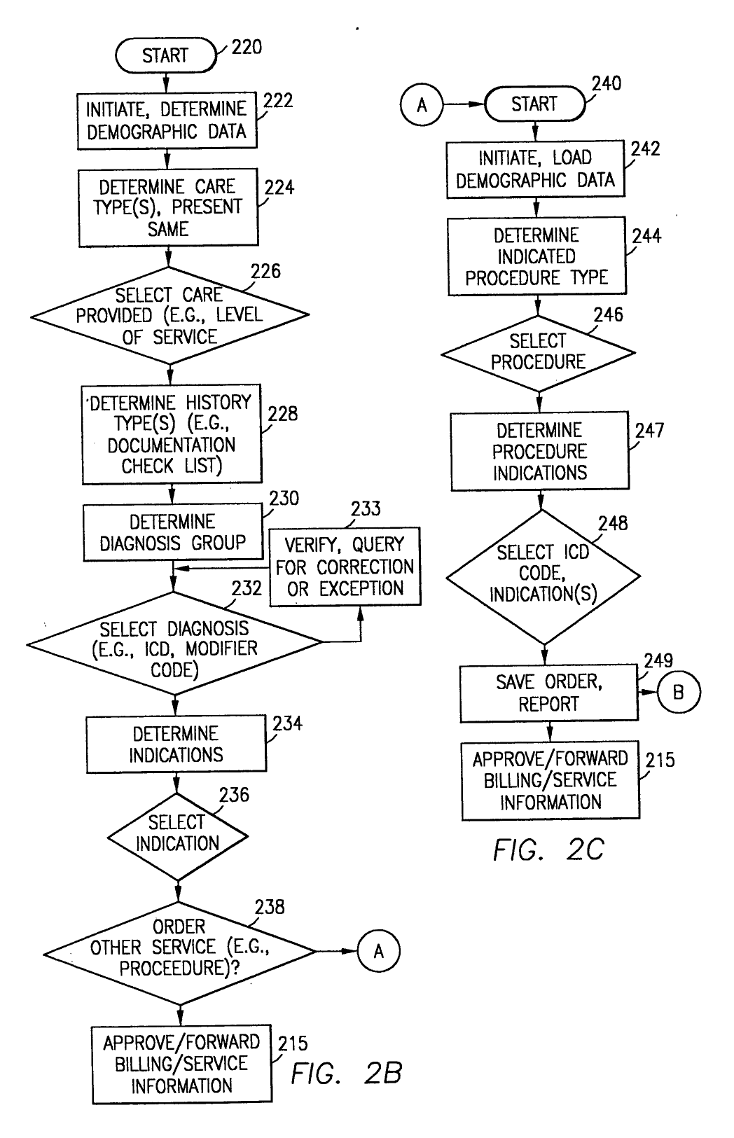

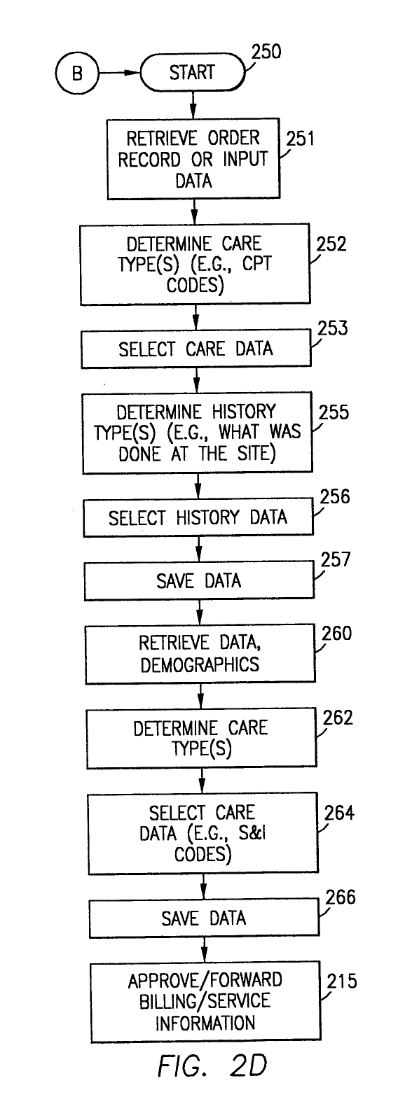

Turning now to FIG. 2, a preferred embodiment for the operation of the system of FIG. 1 is illustrated. In FIG. 2A, an overview of the service and billing process is illustrated in connection with a medical services visit. Again, it may be convenient for certain information to be entered before the professional encounter, e.g., before the patient visits with the doctor. This information may include certain patient information, particularly for new visits, as well as demographic information (such as the location and the physicians to be seen, etc.) While this information can be entered by the physician when starting an interview (e.g., at an encounter where there has been no pre-scheduled visit), it may also prove more convenient for the physicians' assistants or other staff to enter in as much of this information as feasible prior to the encounter. In many contexts this information needs to be captured before the actual visitation or encounter in any event, as the scheduling and demographics may constrain the type and level of services that can be offered.

In a common medical services scenario, the first encounter will be an office visit, referred to as an Evaluation and Management (E&M) encounter, step 202. At this time, the physician will enter, or confirm, the service identifiers such as type and level of care involved, as well as the condition of the patient (e.g., through the use of ICD-9 diagnosis codes). Since both the care and the supporting (e.g., condition or history) information (both of which are examples of identifiers ) are entered in sufficient detail to allow one to forward the billing report (e.g., a claim) and other reports (e.g., treatment summary), all necessary information for billing and care documentation will have been captured substantially contemporaneous with the actual provision of medical services, step 215. If as a result of the physician's evaluation and management the physician determines that a procedure, prescription, or other further service is appropriate, the physician may proceed, step 205, to order the additional service, e.g., a non-cognitive procedure. In this case, the physician also uses the local processing device to contemporaneously enter appropriate procedure types and diagnoses supporting the procedure type, step 207. In a typical medical context this would include the non-cognitive CPT code(s), as well as ICD-9 diagnostic codes. If the procedure is capable of being carried out at the same location and time, the physician or another medical professional may proceed to step 210, where the appropriate procedural inputs are captured (e.g., CPT codes and I&V code(s)). If the procedure needs to be scheduled for a later time or at a different location, the selected procedural and demographic information will already have been saved and inputted, ready for use or verification by the subsequent care provider before the procedure begins. Thus, the subsequent service provider may use certain pre-populated data in their LPD, much as the pre-encounter inputs of step 201 can be provided to a physician in an office visit environment such as that of the E&M session of step 202.

Finally, after a procedure has been performed, there may be other physicians or medical professionals providing interpretive and other services with respect to the procedures that have been performed, step 211, and the process according to the invention may be similarly used by these physicians in capturing and forwarding their billing and services reports, step 215.

In addition to ordering procedures, referrals or other types of encounters, the physician will also be able to preferably order other services or products deemed appropriate for the care of the patient. Examples of such types of services or products would include ordering a prescription, step 205, medical devices, and the like.

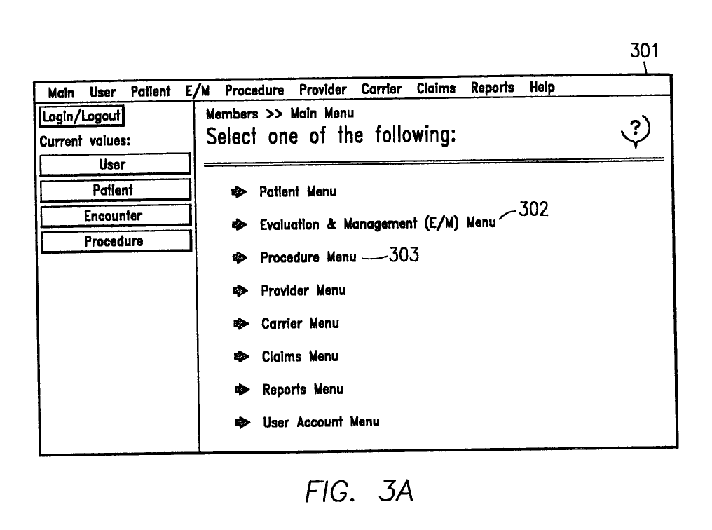

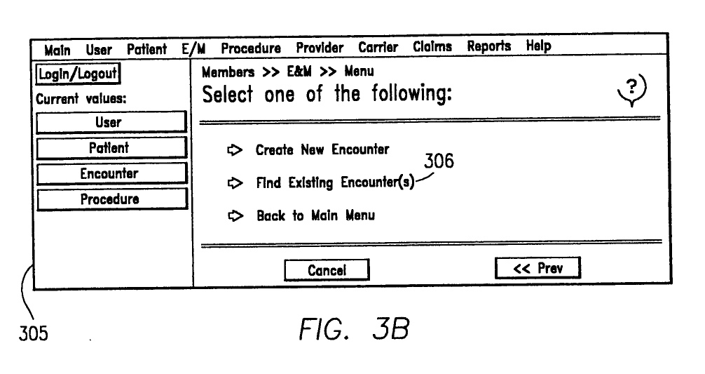

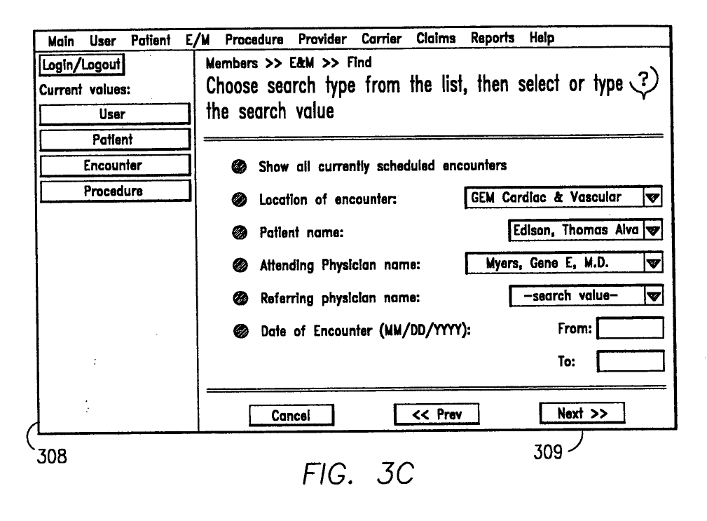

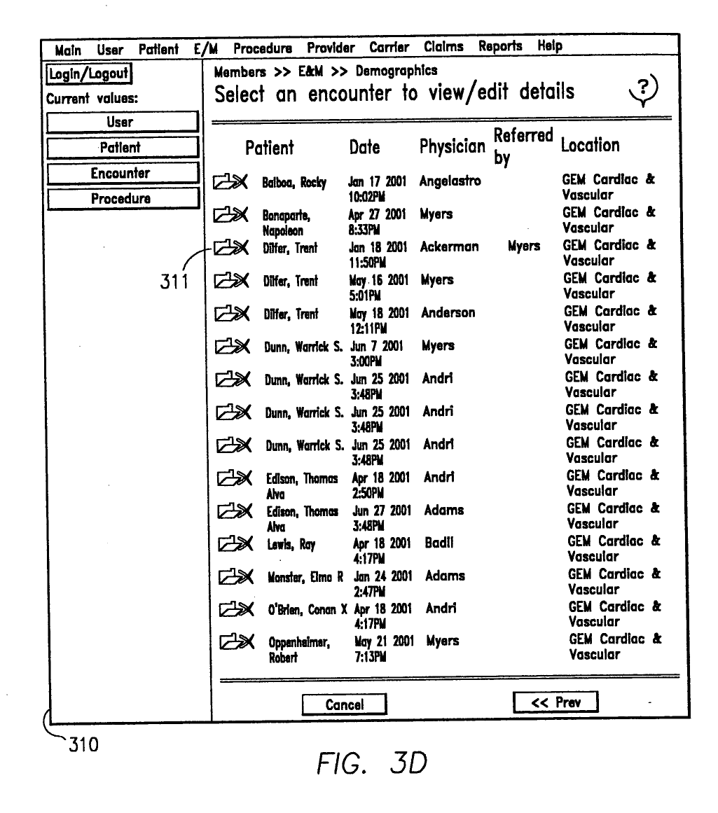

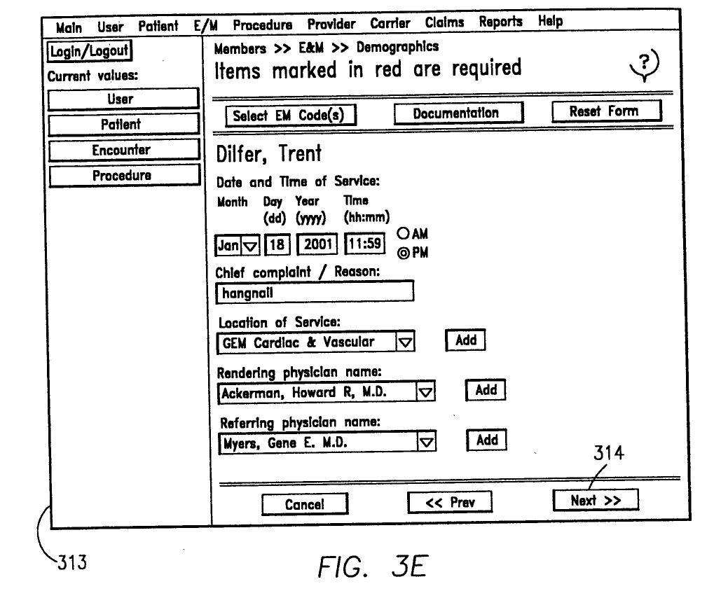

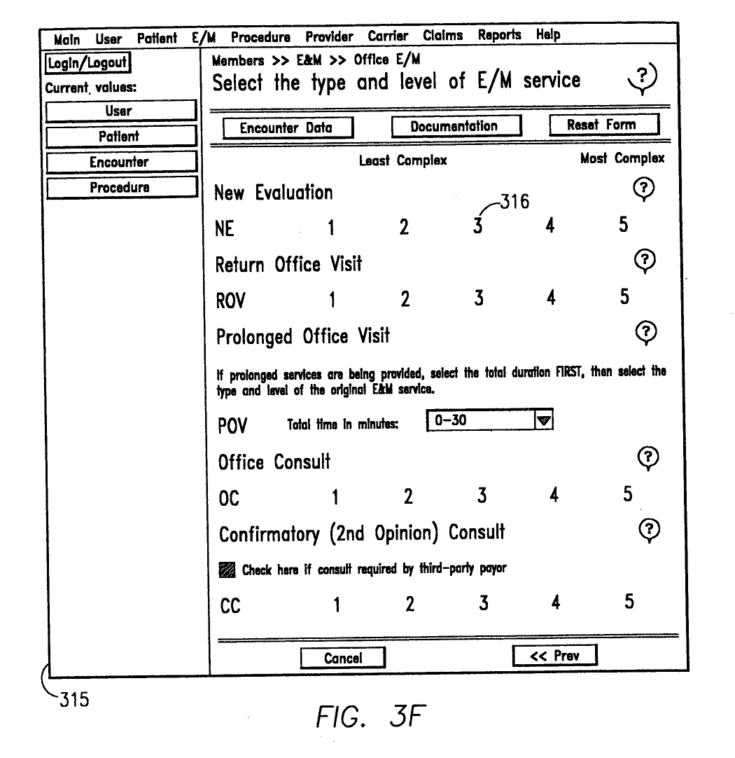

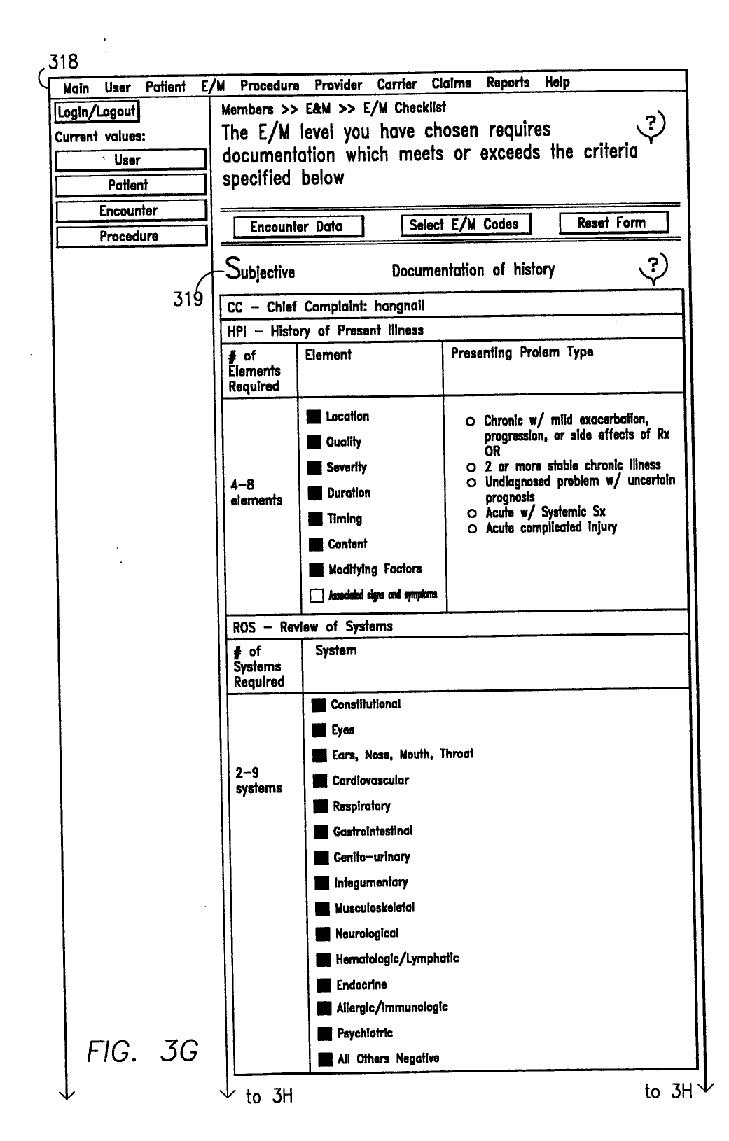

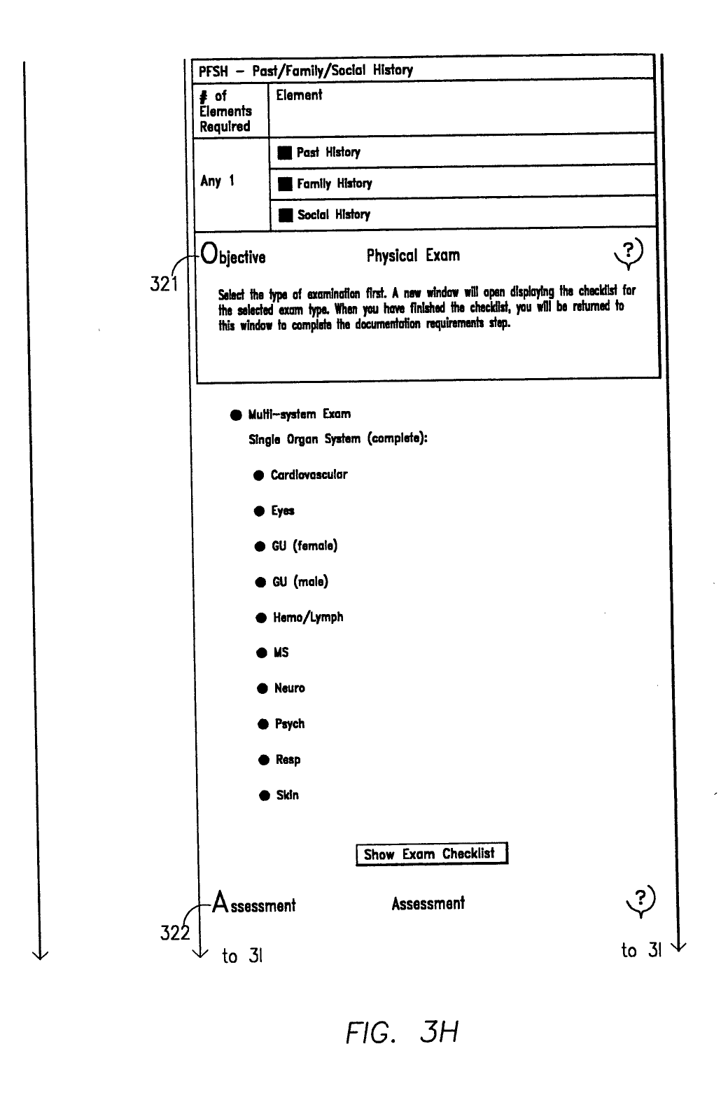

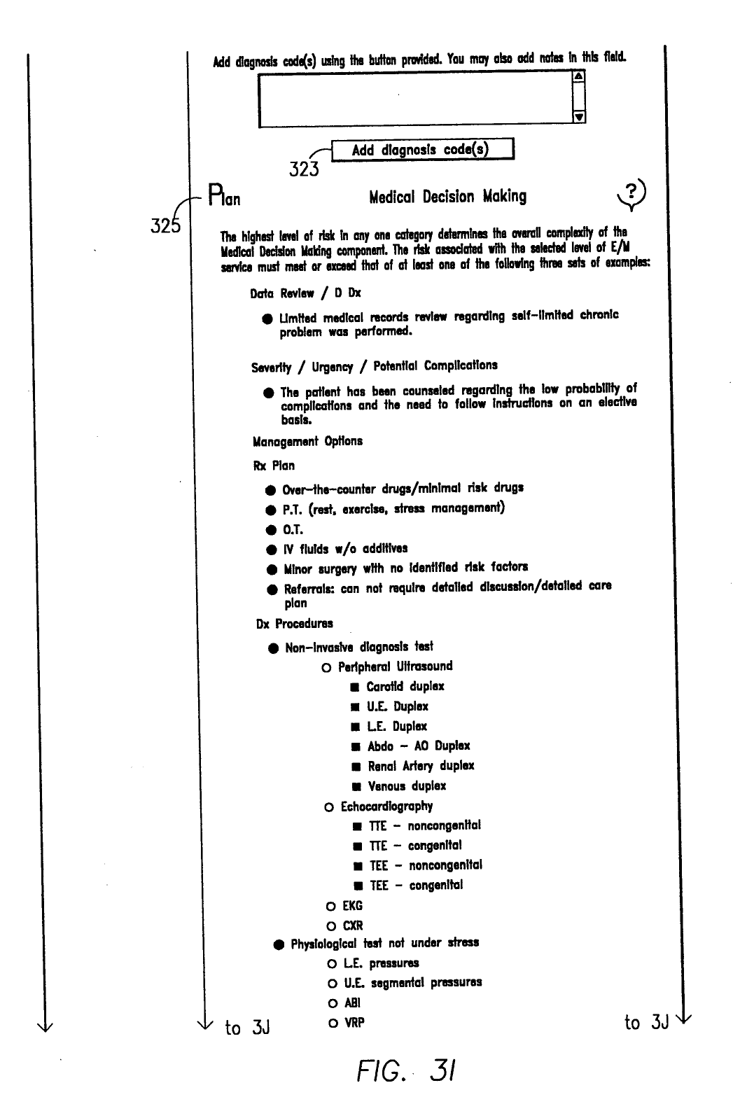

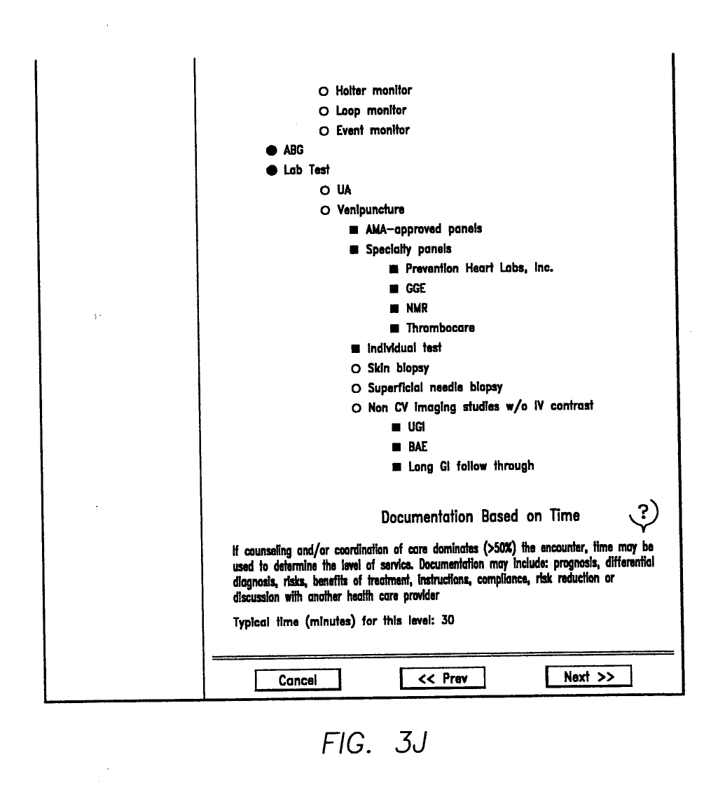

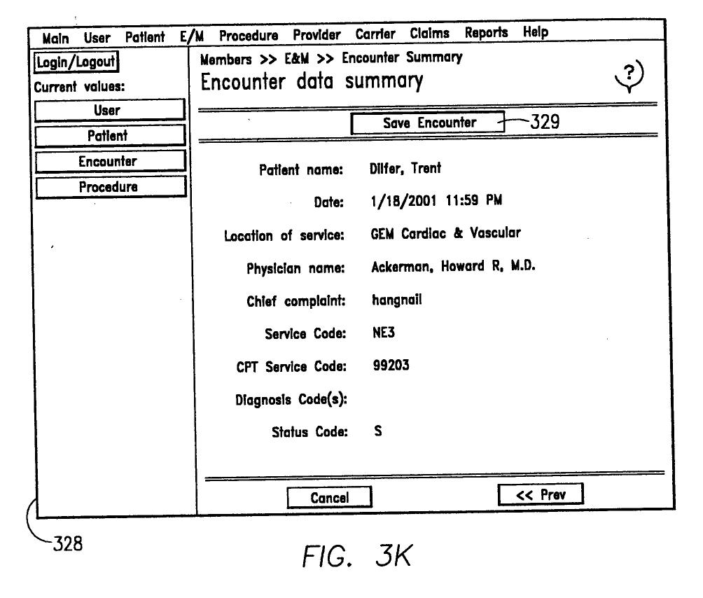

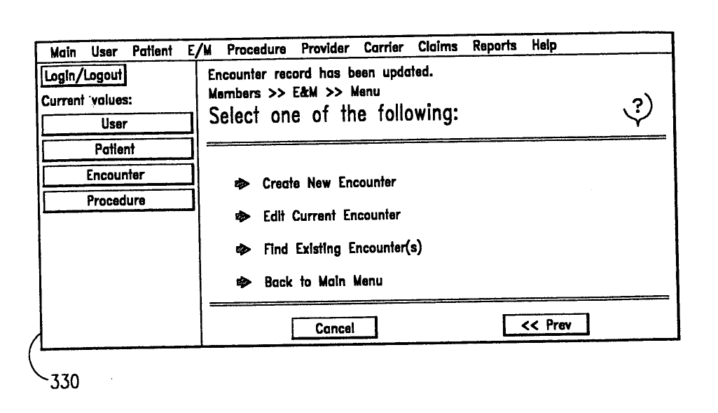

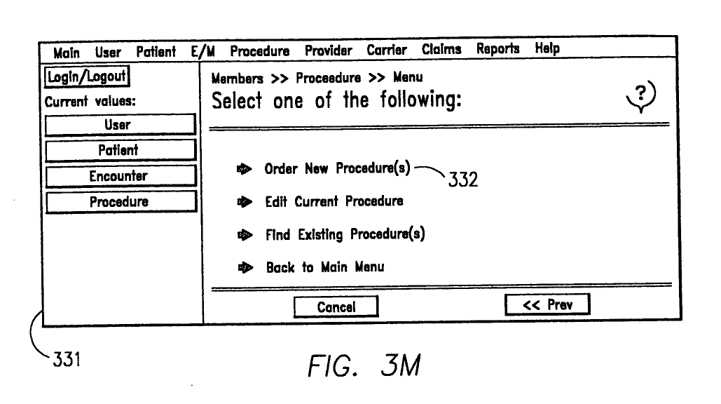

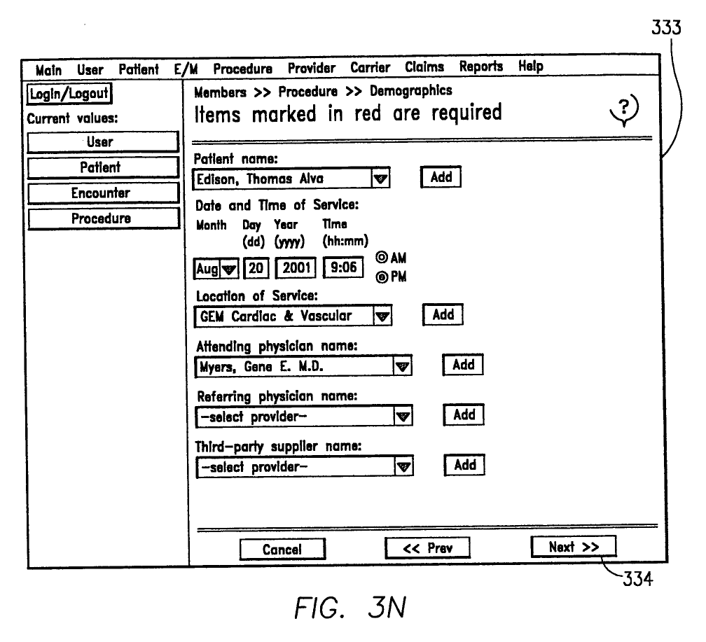

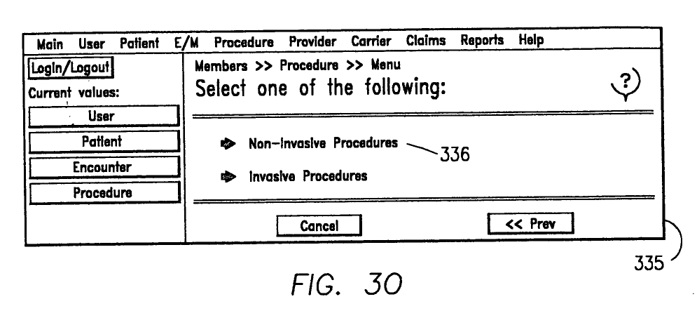

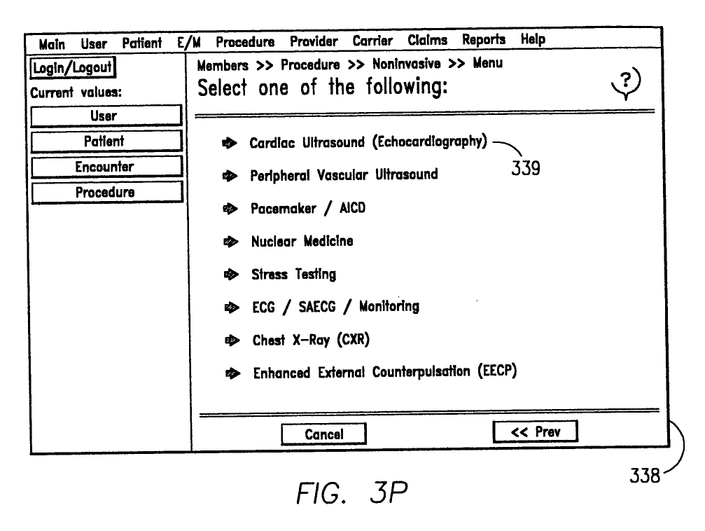

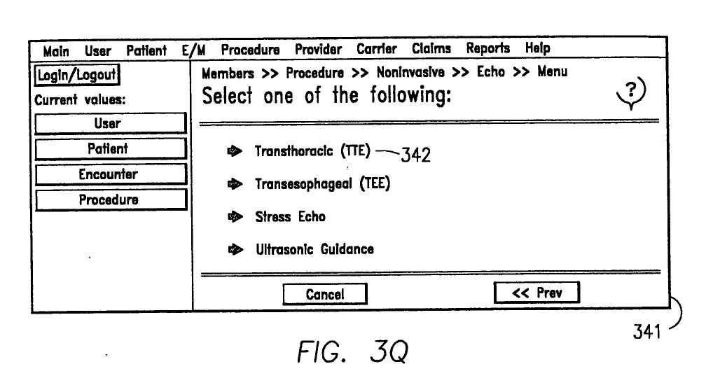

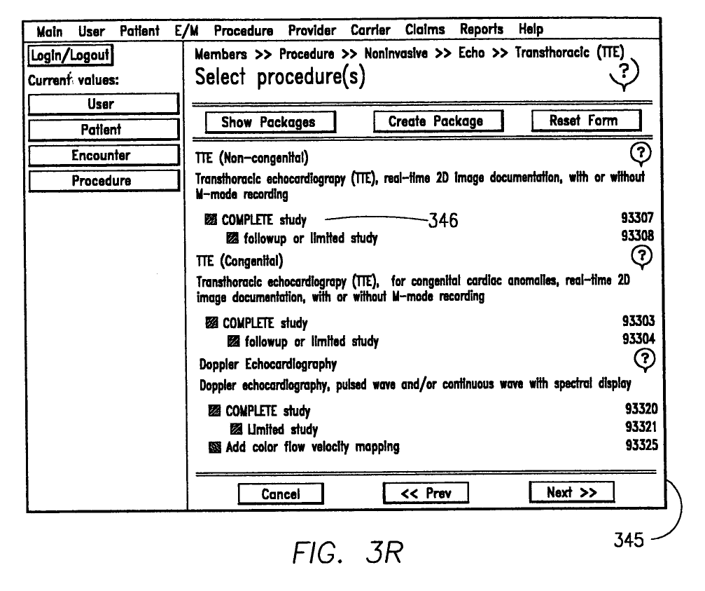

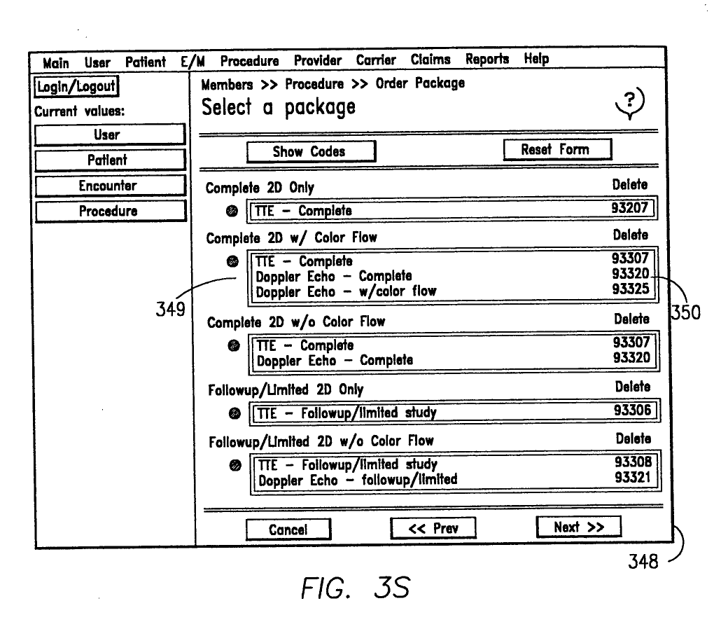

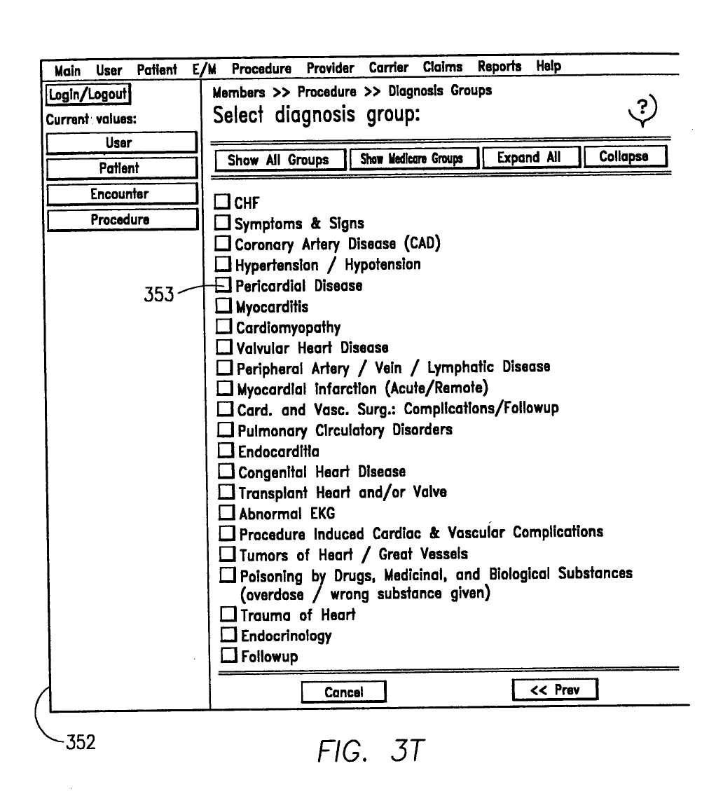

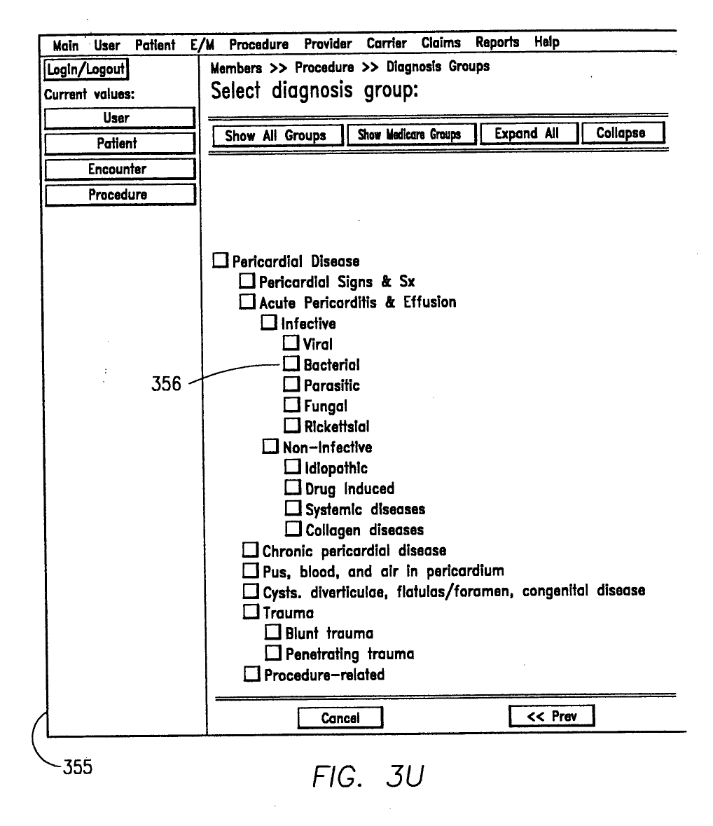

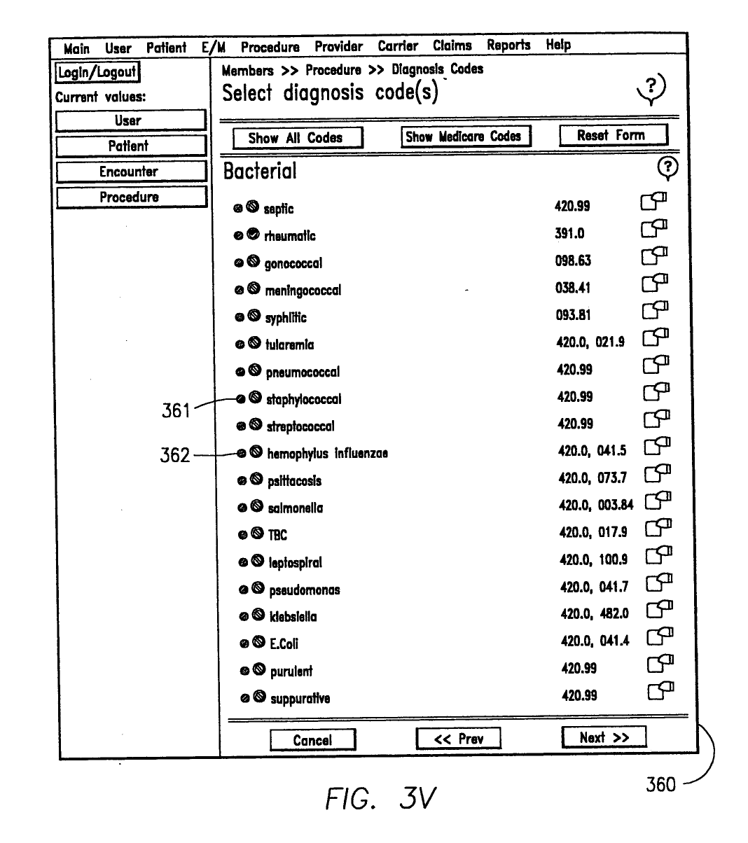

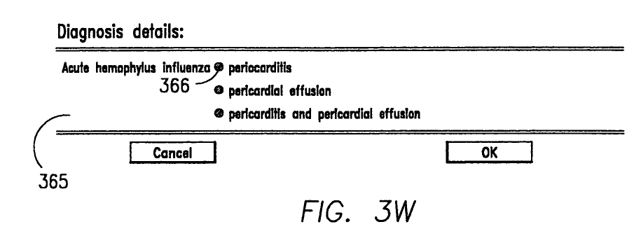

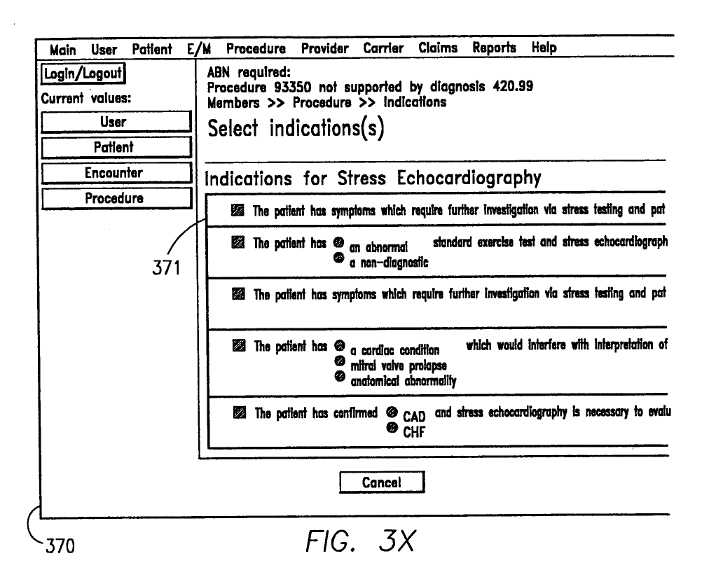

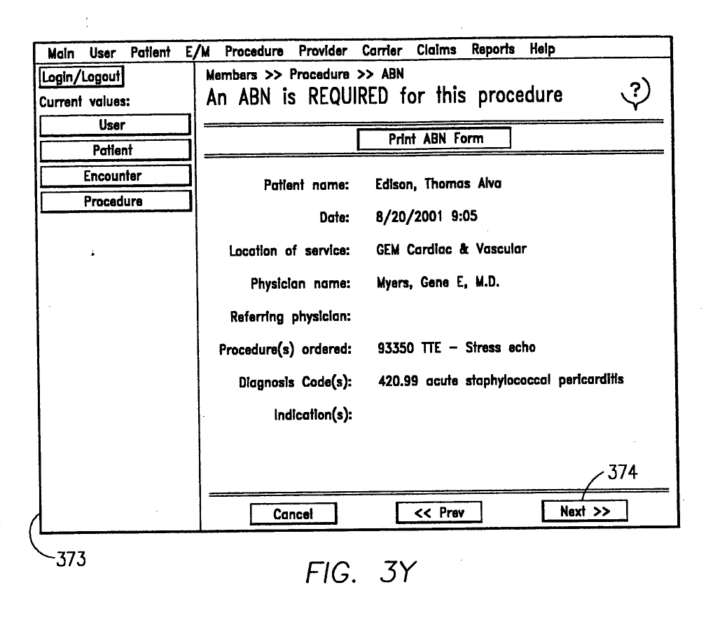

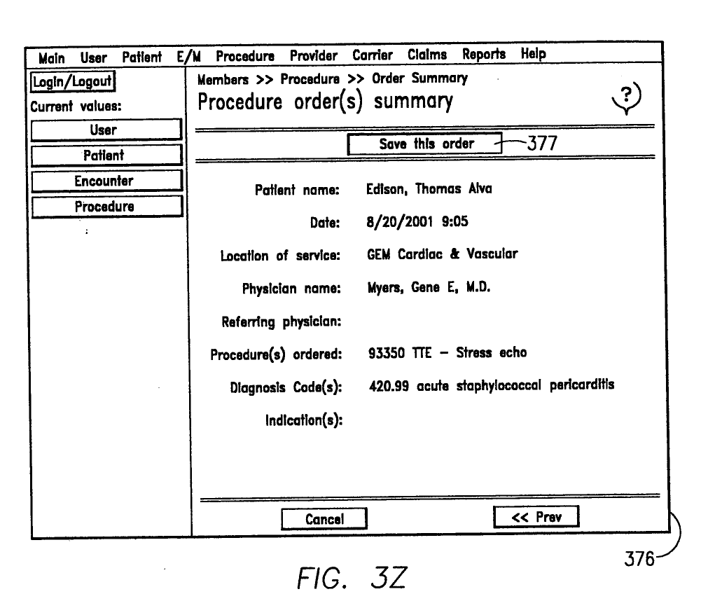

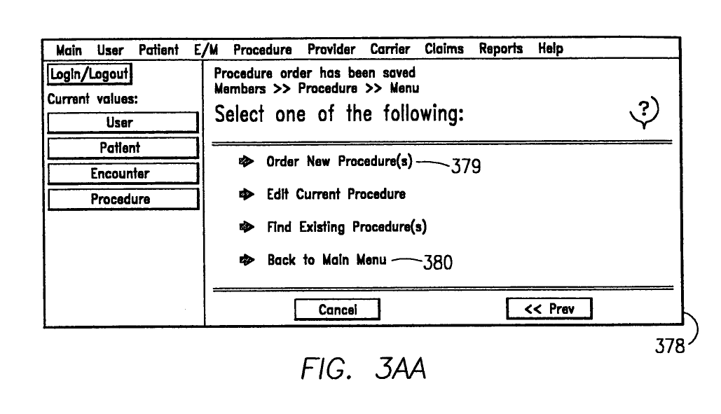

FIG. 2B illustrates a preferred embodiment for the evaluation and management encounter, step 202, of FIG. 2A. The start of the encounter typically begins with the physician's staff ensuring that appropriate information has been entered before the actual encounter commences. An example of this, again, includes calling up the appropriate patient information, as well as having the appropriate demographic data available to the LPD. Given the tight schedules of physicians, this information is preferably pre-loaded, step 222, and verified before the LPD is given to the physician. If the physician would like to verify this information, he can, for example, obtain an output of the information (e.g., via the display illustrated and discussed later in connection with FIG. 3E).

The nature of the services that can be provided are typically constrained in view of the demographic data. In a preferred embodiment of the invention, the LPD or RPD determines the appropriate type(s) of and level(s) of E&M service to be displayed. This can be accomplished through processing or filtering the types and levels of services that would not be appropriate or applicable in view of the selected demographics, e.g., through use of pre-selected hierarchical structures, filter rules, or any other appropriate data processing technique. By narrowing the possible types and levels of E&M services, the processing system can provide the physician with only those options that the physician needs to consider. The pre-selected rules used by the system can also help ensure that the physician does not have any of a pre-selected list of options omitted from his consideration.

Having been presented, step 224, with the types and levels of care that can be provided, the physician will then select, step 226, the first service identifier—in this case an appropriate care type and level. Alternatively, this information may already have been inputted for the physician. However, the physician is preferably provided with areview menu to confirm the type and level of care or, alternately, change the information to reflect the types and levels of care actually delivered. An example of a presentation screen in which the physician is provided with the option to select different types and levels of care is illustrated and discussed later in connection with FIG. 3F.

Having selected the levels of care, the physician then proceeds to determine the history types that are involved in this particular encounter, step 228. In this embodiment illustrated in connection with FIGS. 3G-3J, this can take the form of a documentation checklist that has been determined (e.g., by appropriate rule or preselection) appropriate for the levels of care that are being provided. In other words, for a less complex new evaluation that is rated as having a level care of 1, the physician may only be required to provide a certain minimum level of documentation supporting the indicated level of care. Even so, if one or more elements of the necessary documentation are missing this may result in a rejected claim or other forms of justification for the billing that has been submitted in connection with the encounter. However, when using the preferred embodiment, where the documentation history can be immediately recalled and presented to the physician at the time when the services are being rendered, the physician is provided with the necessary checklists as required, contemporaneous or part of the services being rendered. In this regard, the previously inputted information, for example, the demographic data, the patient data, and the levels of care that are being provided, will typically be used to filter or otherwise determine the type or scope of information necessarily presented to the physician.

In addition to information that is necessary to the efficient processing of the billing and medical records, other optional or desirable information may also be presented on the documentation checklist, or otherwise available for retrievable by the physician as he finds it desirable. If any particular element of information entered as the physician is going through the checklist needs further explanation, the physician can be taken to further screens or provided pop-up screens or other input mechanisms for capturing the additional information.

Either as part of this history capture step 228, or as a subsequent step 230, it is also preferable that the physician determine or otherwise assess an appropriate diagnosis for the patient's condition determined during the encounter. As described above, in most medical service encounters this means determining an appropriate ICD-9 diagnosis code. This would be a daunting task for most physicians in the middle of an encounter, where the physician may have to resort to, for example, a typical approach of retrieving and looking up the appropriate code within large, hardbound volumes. However, in the preferred approach of this system, the physician can be presented with a series of screens allowing him to rapidly narrow down his possible choices to the appropriate ICD-9 code during or immediately after the encounter. An example of one such approach is shown in connection with FIGS. 3T-3V. In a typical office visit this might include selecting one of the diagnosis groups—for example, the symptoms and signs group; in the next screen selecting an appropriate symptom sub-group; and in the final screen being presented with a selection of symptoms with their associated diagnosis codes. By this straightforward process, the physician has been walked through the series of steps that allow him to narrow down or filter the information presented in each successive step so that he can rapidly arrive at appropriate diagnosis. In each step, the physician is preferably presented with the common medical term for the symptom group, and diagnosis, using the system's pre-selected rules for determining what is presented on the subsequent screens based upon relevant prior information (e.g., demographics, level of care, and diagnosis groups). A verification step (233) is also preferably included at this point, whereby the physician may be alerted to any potential error (such as a mismatch between the service and support/condition identifiers), required ABN, or other exception issue. Similar verification or alert steps may also be added after any of the other steps, although such may be obviated in the case where only approved selections are presented for possible selection by the service provider. If desirable, additional information in the form of indications for the diagnosis selected may be presented and selected by the physician (step 234-236).

At this point, the encounter and necessary documentation may be all complete and the physician ready to proceed to the next encounter. However, it is common, particularly in medical services, for additional services to be ordered at the time of an evaluation and management visit. While this can be done by verbal or printed orders by the physician (e.g., a prescription regime, a non-cognitive procedure, or referral), in a preferred embodiment the medical service provider can proceed to order the subsequent procedure contemporaneous with the encounter, and may even efficiently do it while in discussion with the patient, step 238.

FIG. 2C illustrates one such approach toward ordering further medical service, in this case a non-cognitive procedure. Upon initiating the order process, steps 240-242, appropriate information is accessed to assist in the ordering process. As noted above, this can take a variety of forms, depending upon what is available or otherwise convenient for the particular medical service providers. Many will find it convenient to have a portable local device with all of the necessary information loaded on the device to capture the order. Such a device can be provided with the information by direct input or synchronization (e.g., through any convenient wireline or wireless synchronization with other processors). Also, the information does not have to be loaded locally if, for example, the service provider is using a client device that is in communication with an additional processing device, such as a server.

With the context information loaded, the server's provider then proceeds to determine the appropriate procedure that is to be performed, step 244. This could be done in one step, but is likely to be more common for medical services that several steps will be used to narrow down to the specific procedure that the physician desires to select. Thus, for example, in medical services a physician may proceed by electing between invasive and non-invasive procedures, selecting a broad category of invasive procedures, and finally selecting a specific procedure within the narrower category. One illustration of this is shown in connection with FIGS. 30-3R. Except for simple procedures, in the preferred embodiment several steps will be taken to assist the service provider to rapidly narrow the many possible procedures to the specific one that he deems appropriate. As with the earlier selection steps, the options presented in each subsequent step will preferably depend, or be otherwise filtered or narrowed, based upon the selection of the immediately preceding step.

Additionally, other information such as the demographic data may be used to further narrow the selection choices. Thus, as illustrated in FIGS. 30-3P, a selection for an invasive procedure when done by a cardiologist can be immediately narrowed to a pre-determined list of invasive cardiology procedures (FIG. 3P). In addition to such data as the demographic profiles of the physician, office, and patient, the process will preferably take into consideration additional information. This information could include, for example, preferences or restrictions from the insurance carrier or other payor for the medical services. To make it more convenient for a particular physician, the options presented may also be arranged in such a way as to provide for a list of favorites or more common procedures performed by the physician or to be performed by another convenient physician.

Once the appropriate procedure has been selected, step 246, the service provider proceeds to determine the appropriate supporting data for the service. In the case of many medical procedures, this may include a determination of the procedure indications, step 247. Again, based on the demographic information and selected procedure, the selection process, step 248, may include a multi-level or step approach to narrowing down the options, via common terms presented in a manner or structure familiar to the physician; once sufficiently narrowed, a specific diagnosis identifier may be selected for medical procedures, this identifier typically including a diagnosis code (e.g., ICD-9 codes) associated with the diagnosis selected.

As noted above, an additional step for selection of specific indications for the procedure may optionally be used in addition to contemporaneously capturing the diagnosis. This optional step may, in fact, be required when, for example, the selected procedure is not shown as supported by the particular diagnosis code selected. In this event, the preferred embodiment of the invention can alert the care giver that additional information is or may be required, and preferably provides the care giver with a menu of indications that might support the selected service identifiers. Having captured the information via the selection, step 248, the physician can then save the report and forward all appropriate information for processing the order.

When it comes time for the procedure to be carried out, the system according to the invention can also be used during the procedure. As with the procedure ordering process, FIG. 2C, appropriate information can be retrieved or inputted, which in turn will be used in the step of determining the appropriate care type (e.g., CPT code) for the procedure being undergone, steps 250-252. Once the type of care data has been selected, the support data for the service is entered as the procedure is performed, or alternatively, immediately following the procedure, steps 253-256. To facilitate the selection process, the choices may be presented to the care giver in visual form, but any appropriate single or multimedia format can be used. In addition to the menu-driven format illustrated in connection with FIGS. 3A-3AA, other formats such as the graphic format illustrated in connection with FIG. 11 may be used to capture the appropriate service type and support data. Once all the appropriate data has been captured, it is saved for later retrieval, step 257, and may also be immediately forwarded for claim purposes, step 215.

Following completion of a procedure, it is also common to have subsequent processing of the information captured during the procedure by the same or other medical service providers, depending, e.g., on who is providing the procedure services. The system of the invention may also be used in connection with these services as provided. Beginning in step 260, context information may similarly be retrieved or inputted, as desired. The service identifier (here a type) and supporting data is then be captured, steps 262-266, for example, by selection of an appropriate S&I code (supervisory and interpretation code). Once completed the data is saved and forwarded in an appropriate format for processing of the medical and billing information, step 215.

A preferred embodiment of the invention is further illustrated in connection with the user screen shots shown in FIGS. 3A-3AA. In particular, FIGS. 3A-3L show a multi-level selection process by which a physician can capture evaluation and management (E&M) encounter information, while FIGS. 3M-3AA illustrate a process for ordering a new procedure. Beginning with FIG. 3A, a main menu 301 is provided to a user for use in connection with capturing the service information. In the illustrated case, the selection of any of the menu choices will automatically take the service provider to the next screen based upon the service provider's section, although those skilled in the art will appreciate there are many varieties of user interfaces that may be employed in carrying out the invention. Two of the selections, the evaluation and management (E/M) menu 302, and procedure menu 303 are used in connection with the services and capturing of service and billing information. Other menus may also be provided, either relating to the service and billing, certain maintenance functions, or other unrelated functions useful to the operator and his or her business.

Upon selection of the E/M menu button, 302, E/M menu 305 is displayed with options to either create a new encounter, or find an existing encounter, 306. While either one of these options could be used by the service provider, it is more likely that support staff would be inputting information under the Create New Encounter option, and this inputted information would be saved with appropriate context information. In FIG. 3C a Find menu 308 is displayed. Any information identified in the encounter could be displayed, but in the illustrated case, demographic information such as the local of the encounter, the patient involved, the physician involved, and other information (the referring physician and date of encounter) are displayed. If these have been pre-selected, nothing needs to be entered by the physician; by selecting an appropriate button such as the illustrated Next button 309, all the displayed information will be used for the encounter. On the other hand, the physician or other care giver can change the information as appropriate, for example, where another physician is filling in for the originally-scheduled physician.

Proceeding to FIG. 3D, the alternative is illustrated where the service provider has chosen to request all currently scheduled encounters via a list menu 310, and selecting an individual encounter (patient Trent Dilfer 311). This selection returns Demographic menu 313 of FIG. 3E, and by selecting Next button 314, the Service Type menu 315 of FIG. 3F is presented. Using the demographic information, the preferred system has already narrowed the optional types of services as well as the level of E/M service that is available to view, e.g., of the physician and the location of services. Menu 315 provides a convenient format for the physician to rapidly select what he deems to be the appropriate type and level of service, as in the illustrated case of a New Evaluation at level 3, icon 316.

Having selected the level of care, the service provider is then taken through a supporting data (e.g., condition) selection process. FIGS. 3G-3J illustrate an E/M Checklist which conveniently provides to the care giver in one presentation the suggestions or requirements for supporting the selected level of care. These requirements have been predetermined upon any desirable factors, and preferably will be sufficiently detailed to satisfy all requirements by the payors or other responsible entities for reviewing the medical and billing records, as well as any optional items that the physician or other system designers may choose to provide. Thus, in addition to requirements in support of the selected E/M codes, special alerts, suggestions, or options may be programmed to trigger consideration by the service provider via the displayed information. In the illustrated menu 318, several categories are presented including a Subjective category 319 for documentation of history of the complaint and illness along with the designated number of elements needed for support of the history, and a Review of Systems along with a designation of the number of systems required for review; an Objective history 321 in the form of exam elements (which may optionally trigger additional exam checklist screens); an Assessment category 322 including appropriate input methods such as menu-driven diagnosis code button 323; and Plan Documentation 325.

If convenient, all this information can be captured by the physician during the course of the examination. Alternatively, it can be captured contemporaneous with the visit, for example, immediately following the visit and out of the presence of the patient. One skilled in the art will also appreciate how a variety of input methods can be utilized in addition to the illustrated ones, including mechanical, voice and multimedia methods. Thus, in addition to menu-driven or typewritten selections, in an appropriately configured system voice files could also be attached as part of the documentation history, and any other form of documentation could be attached (e.g., digital pictures, or even analog pictures scanned and attached as digital images). Depending on the requirements of the payors or government, this information could all be forwarded in connection with the billing report, or only selected components forwarded, the remaining information being retained in an appropriate local or centralized data store by the service provider.

Once finished, an encounter summary 328 may be provided to the physician. If satisfied, he can save the encounter 329 and proceed, FIG. 3L, to the selection of the next encounter 330.

Turning now to FIGS. 3M-3AA, a new procedure order process is illustrated. Starting with main menu 331 of FIG. 3M, the physician selects a new procedure 332. In response, the context information menu 333 is provided, which in this case is a Demographics menu with appropriate information already entered. If the new procedure is a continuation of an encounter or an existing procedure, the system of the invention can be designed to automatically populate appropriate information in the demographic screen 333. The care giver can still modify, as appropriate, any of the relevant information provided. If satisfied, the care giver approves, in the illustrated case via next button 334. The appropriate procedure button 336 is then selected on selection screen 335 in FIG. 3O. Based on the selected procedure and demographics information, FIG. 3P, presents a menu of types of further service identifiers, e.g., non-invasive procedures relevant to the cardiology practice of the selected physician in menu 338. Upon selecting echocardiography button 339, a further menu 341 is provided of the possible echocardiography procedures, in FIG. 3Q, that a care giver could select. Having selected TTE button 342, yet another menu 345 is returned with the possible TTE procedures listed for the physician's selection. In the illustrated case, the appropriate CPT code is also listed opposite each of the possible selections. Thus, if the physician, for example, selects TTE (non-congenital), complete study, button 346, the physician will have selected CPT code 93307 in addition to ordering the TTE procedure. Rather than having presented the physician with either the need to remember which procedure to select (but without the appropriate CPT code also being available), or forcing the physician to go through a much more extensive listing of procedures available, in four steps of convenient screen presentations the physician has arrived at a selection that satisfies his need to specify the appropriate procedure, while satisfying the payor's need for the associated CPT code and supporting information that satisfies the claims billing requirements.

FIG. 3S illustrates an additional feature of the preferred embodiment, in which the system presents the care giver bundled procedures based upon a selected individual procedure. In the illustrated case of menu 348, it has been recognized in the system design that the order of a particular non-congenital TTE procedure may in fact be implicating the order of multiple options. A physician may typically remember these options in terms of the results that they receive, for example, a 2D only, 2D with colorflow, or 2D without colorflow, echo package. But the physician may not recall that a complete 2D with colorflow package includes what has been designated as three separate tests, with three separate CPT codes, by the payor entity. In this optional arrangement, the service provider need only select what they would typically refer to as the complete 2D with colorflow option, and the system will automatically select the three sub-component tests 349 and capture the respective 3 CPT codes 350.

Having selected the appropriate service-type data (e.g., identifier name or code), a physician is then directed through a support data (e.g., condition, history or treatment data) selection process. Beginning with FIG. 3T, a diagnosis group menu 352 is provided with the high level categories of ICD-9 groups for use in the diagnosis. Upon selecting the button 353 for pericardial disease group, menu 355 in FIG. 3U is displayed with the appropriate subgroups. These may be displayed in any convenient format, and it is illustrated here in a hierarchical, expanding menu format in which clicks on any particular subgroup will display yet other subgroups, which may have yet other subgroups nested within them for subsequent selection. Upon selecting button 356 for the bacterial subgroup (displayed under Pericardial Disease:Pericardial Signs and Symbols: Infective), the physician is taken to menu 360 of FIG. 3V with a listing of possible diagnoses. If the physician were to select the diagnosis hemophylus influenzae, button 362, the system would capture ICD-9 diagnosis codes 420.0 041.5 associated, and displayed, with the selected diagnosis. If further diagnostic information or indications are desirable, an additional screen 365, shown in FIG. 3W, may be presented with yet additional condition information presented. On selecting an appropriate indication, in the illustrated case, pericarditis 366, the captured information is processed.

In the preferred embodiment, the diagnostic information is compared against the procedure ordered, and the physician alerted if this particular procedure is not supported by the diagnosis. This is illustrated in FIG. 3X, where a further indication menu 370 is provided to the care giver showing that an ABN is required. Appropriate indications may also be presented for the physician's selection, such as the further investigation selection 371.

Alternately, the physician could cancel the ABN window and return to the previous diagnostic screen to reconsider the diagnosis. In the illustrated case, if the physician were to return to FIG. 3V, screen 360, and instead select the staphylococcal diagnosis 361, that diagnosis would be saved in connection with the procedure being ordered. In this way, by prompting the physician about potential problems contemporaneous with the rendition of services, the physician can immediately correct or otherwise address the issues flagged, rather than having to face delayed billing and recreation of the appropriate report information days or weeks after the services are rendered.

In FIG. 3Y, this diagnosis is captured along with ICD-9 code 420.99 in connection with the ordered CPT 93350 TTE-stress echo procedure on summary menu 373. If satisfied, the physician selects next button 374, saves the order through button 377 on summary menu 376, FIG. 3Z, and is returned to the main procedure menu 378 in FIG. 3AA to either order a new procedure 379 or return further to the main menu 380.

The present invention is, in yet an alternative embodiment described next, additionally directed to a method and system for a single operator at a point of service to be prompted for patient profiling information relating to the service being administered. As noted above, a common form of profiling in healthcare services is the DRG system. When used, a physician would preferably upon entry of a service category (e.g., a major disease category) be prompted with information on a screen for selection via the screen or other input (or alternatively dictation, writing or other information storage means) for use in establishing a DRG level.

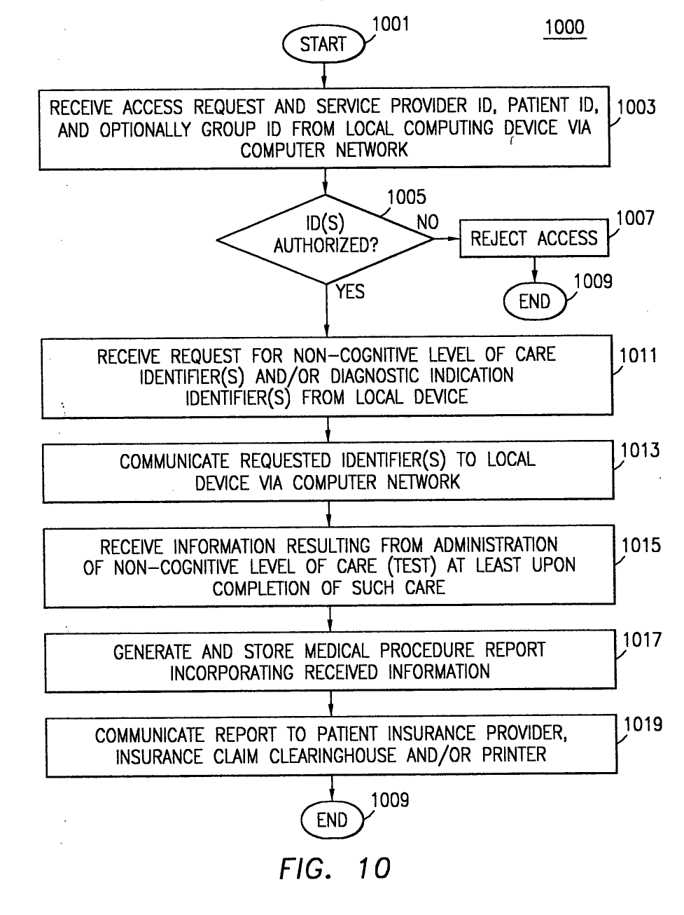

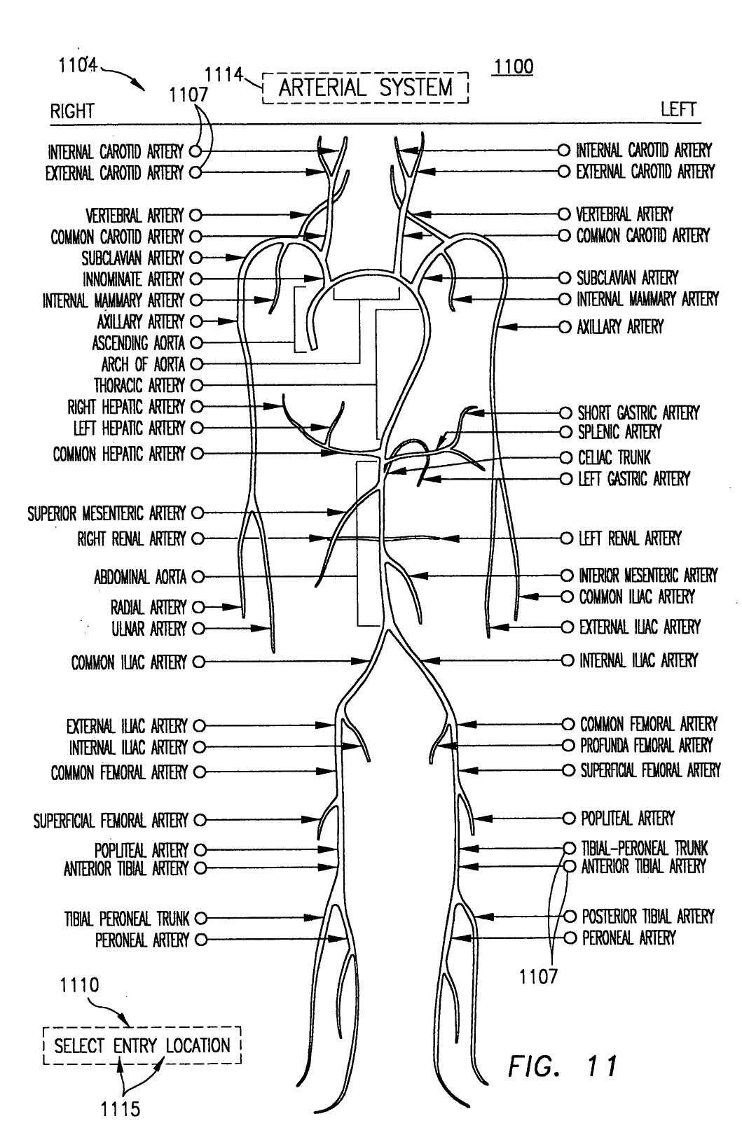

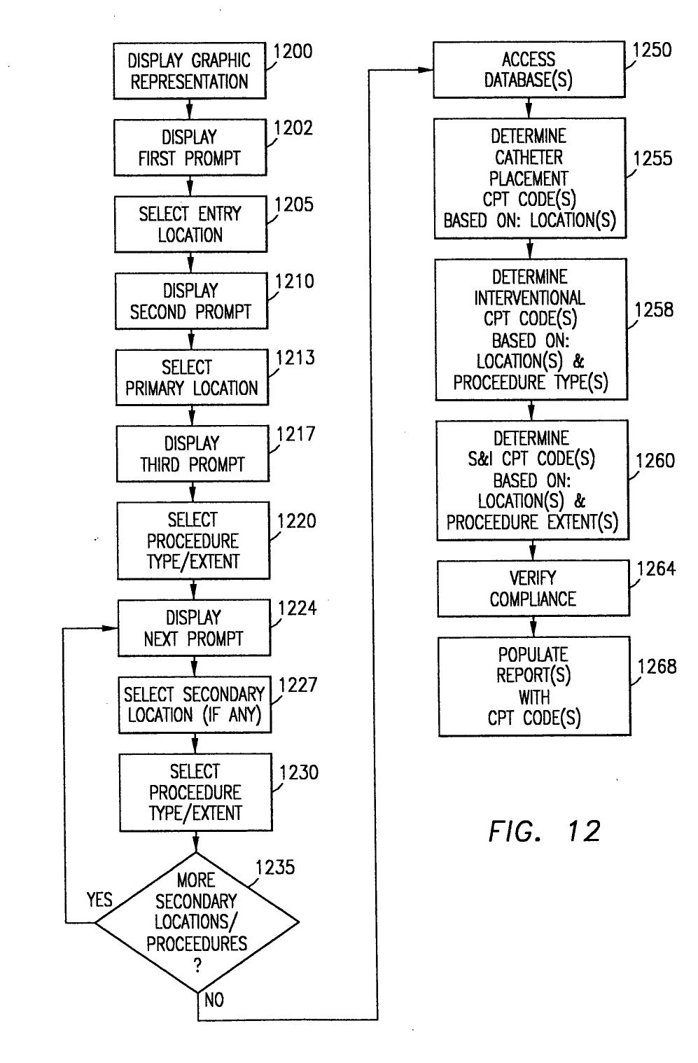

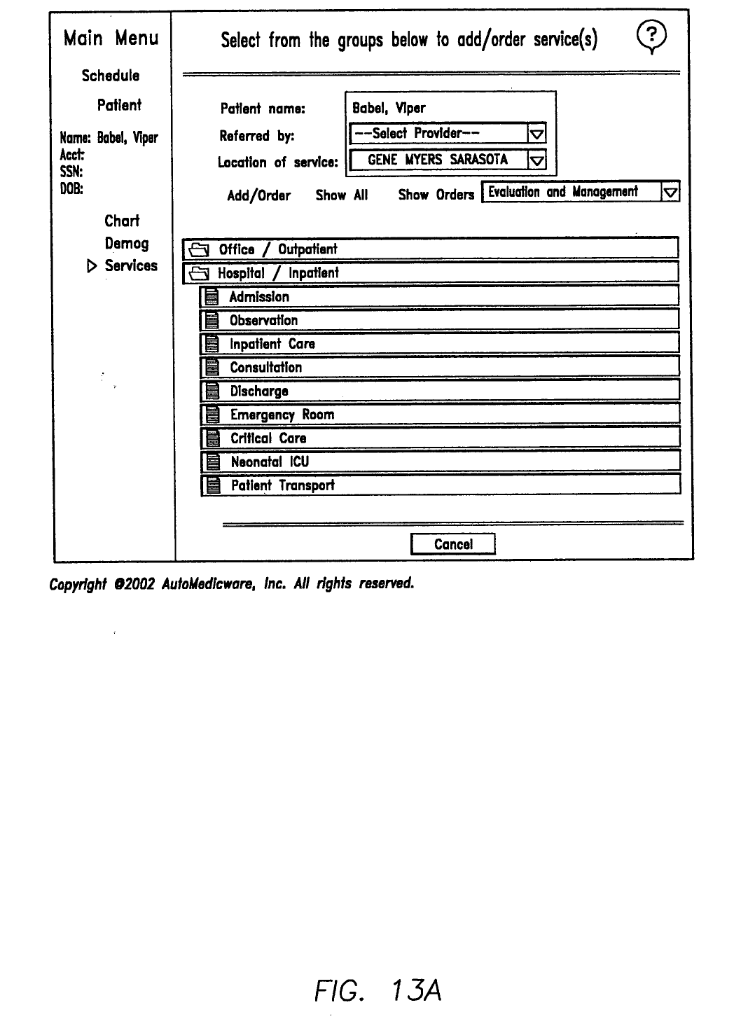

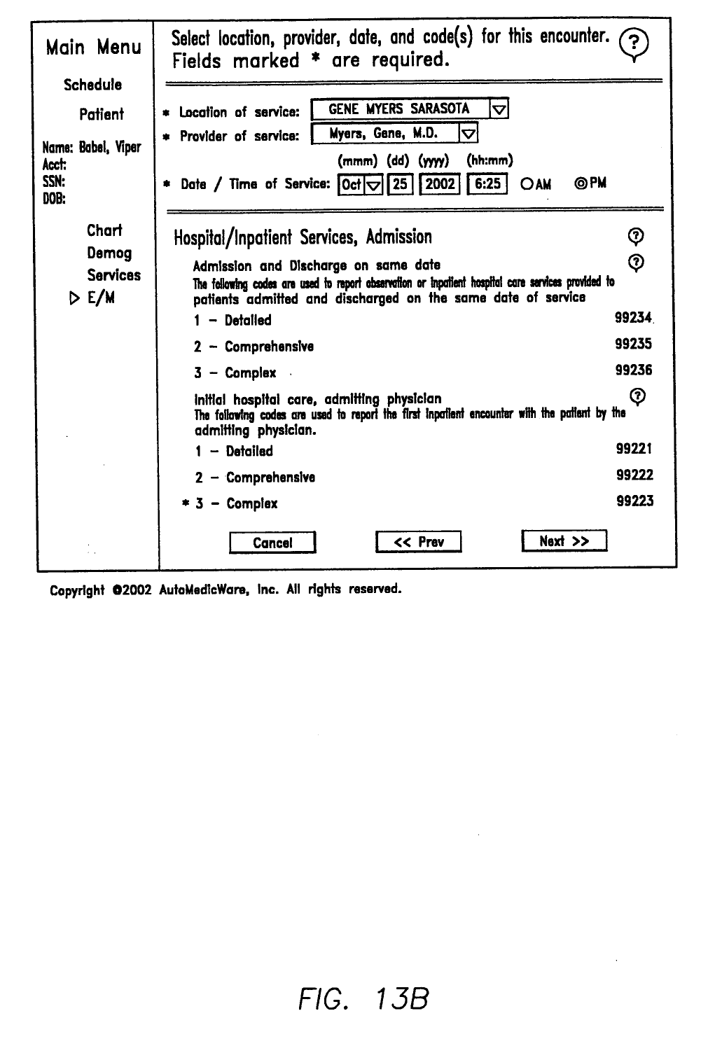

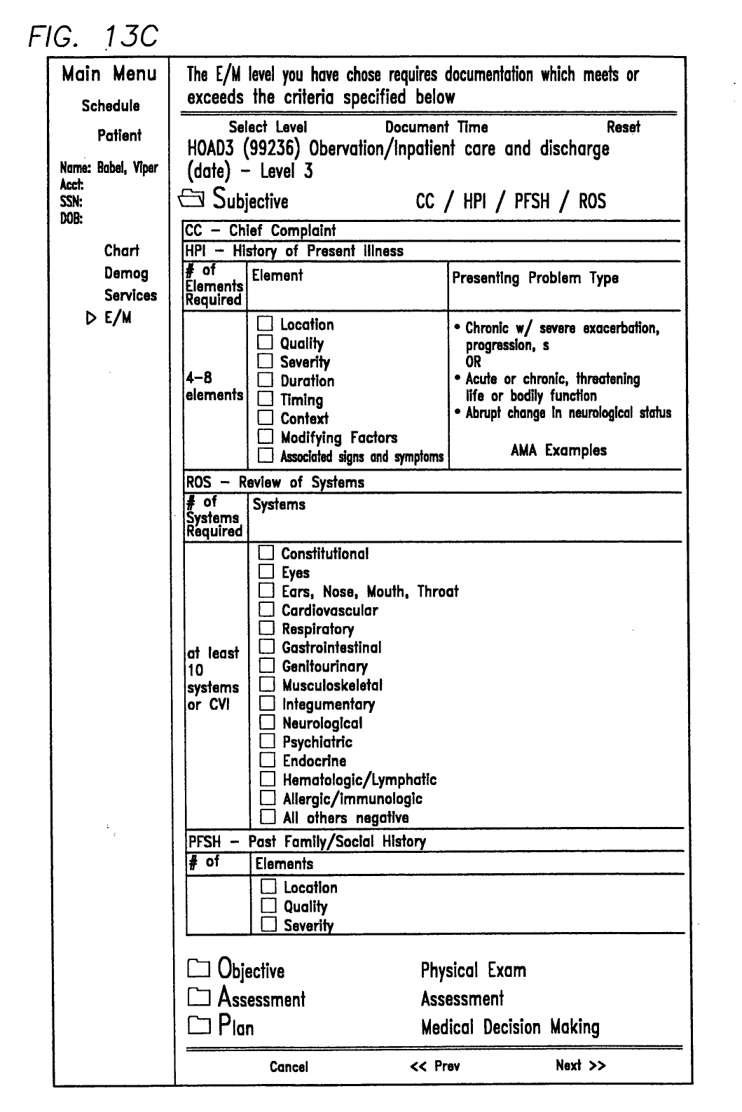

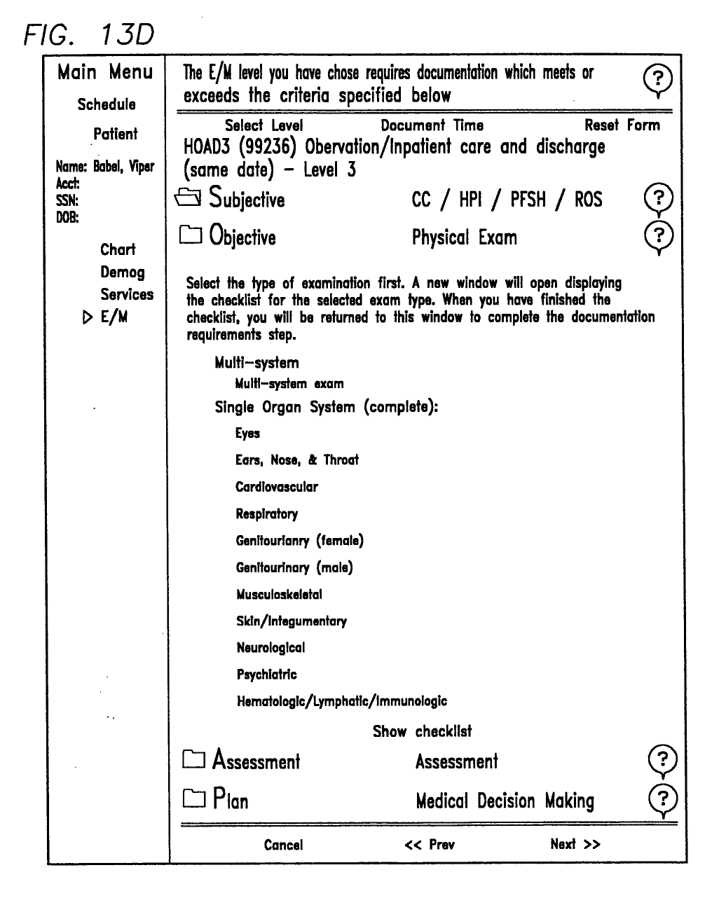

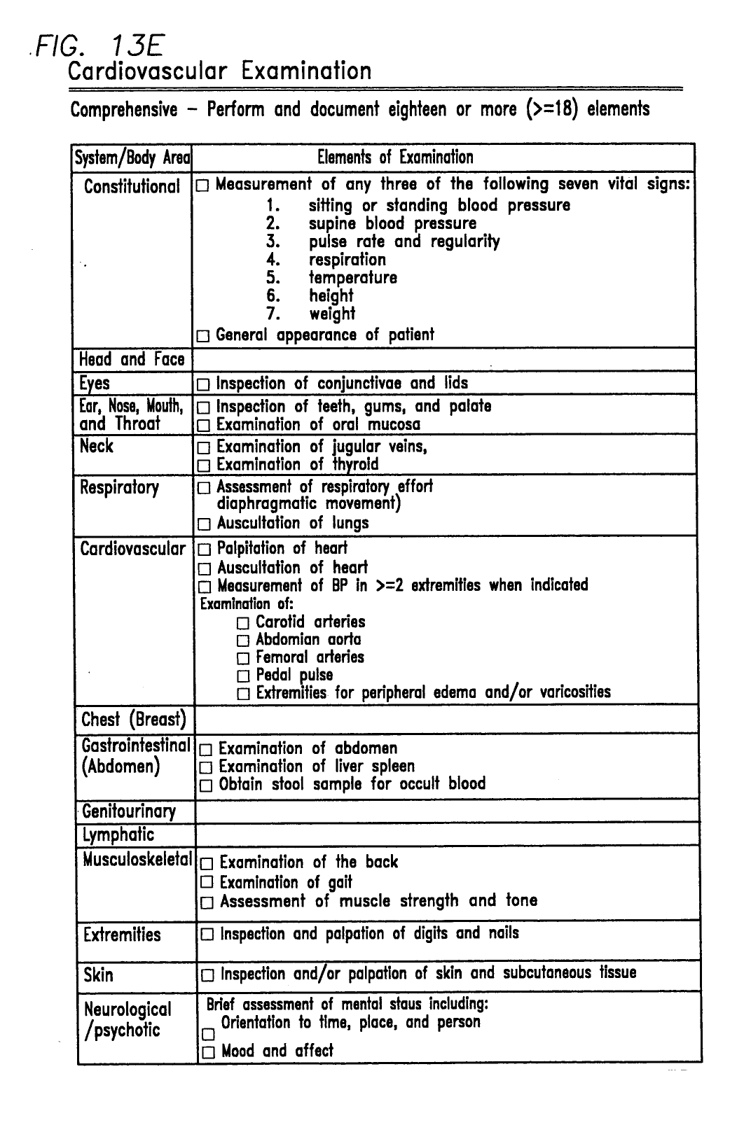

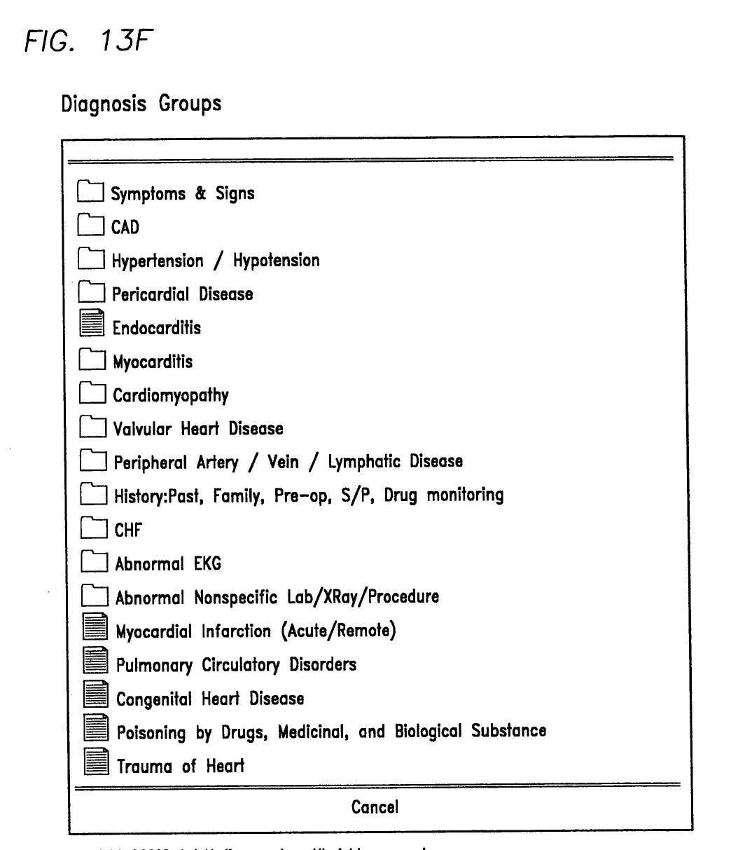

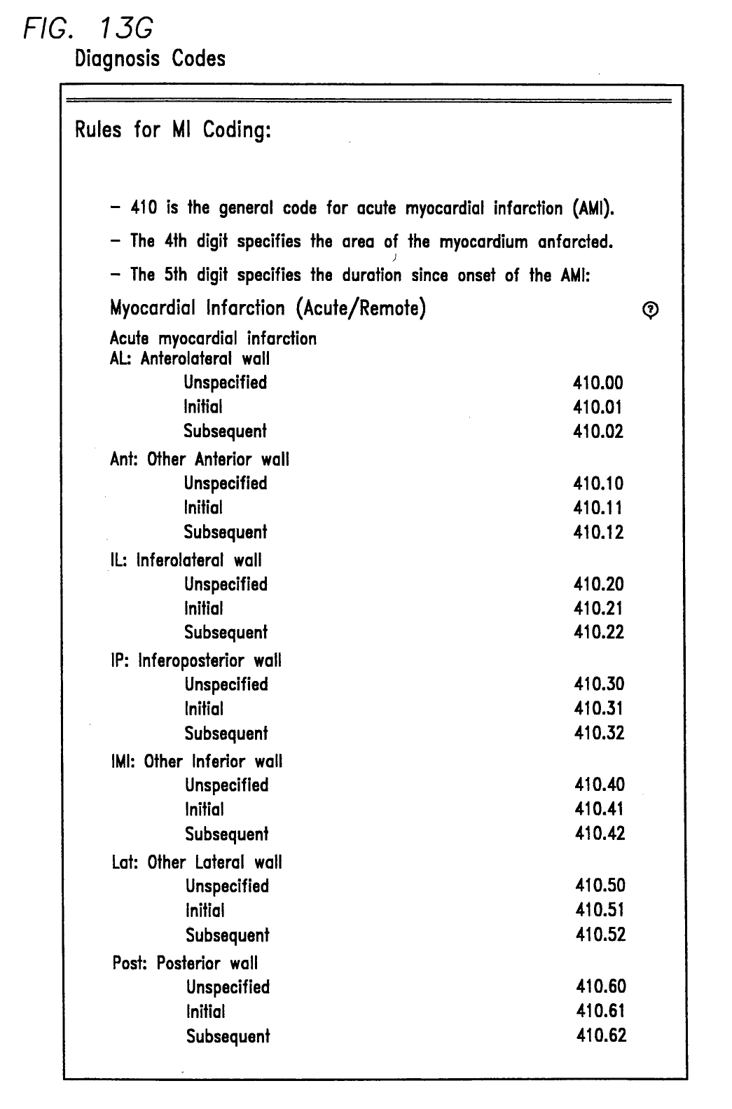

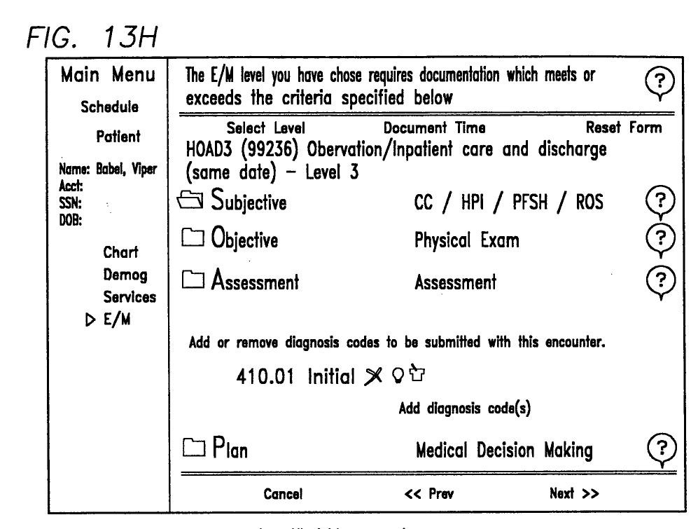

FIGS. 13A-131 illustrate an automated embodiment in which the process for entry of such information is as follows. Starting with introductory screen 13A, the care provider selects introductory information, such as the type of service provided (e.g., Evaluation and Management), the patient, the location of service (e.g., Hospital/Inpatient), and the type of care (e.g., Admission). This selection causes a further screen, such as that of FIG. 13B, to be shown, from which the physician selects an appropriate encounter information (e.g., “3-Complex” for initial encounter, admission and discharge on the same date). Note how a CPT (Current Procedural Terminology) Code is displayed, indicating that selection of the appropriate encounter information is linked to that CPT code.

This then brings up a “SOAP” (for “Subjective-Objective-Assessment-Plan”) screen that readily expands to show elements that are typically required supporting the selected encounter code. FIG. 3C illustrates an expanded entry screen for Subjective information such as CC (Chief Complaint), HPI (History of Present Illness), ROS (Review of Systems), and PFSH (Past/Family/Social History). Given that CPT code 99236 for a Level 3 encounter was initially selected, this screen may be advantageously used to prompt the required number of elements or systems that typically need to be reviewed. Of course, one skilled in the art will appreciate how a variety of different requirements and optional information may be prompted, subject to the professional selection of those with an interest in prompting and accurately capturing such information such as the attending physician (who can have the contents customized), a practice group, the facility (e.g., a hospital with its own requirements), and payors and other third parties. Information may similarly be prompted and inputted for Objective information, such as in the illustrated case of FIGS. 13D and E, where a single organ system (cardiovascular) is selected, returning a prompt (FIG. 13E) indicating a comprehensive level requires eighteen elements of examination, and providing predetermined element information (here conveniently categorized by system and body area) for use by the physician.

When entering Assessment information, the physician is prompted to add diagnosis codes (see FIG. 13H), in response to which a Diagnosis Group prompt is returned, listing appropriate groupings (e.g., Symptoms and Signs, CAD, etc.). In response to the selection of a group (e.g., Myocardial Infarction), the user is further prompted to select a type or location (e.g., AL, for anterior wall initial MI, with a designated code/subcode of 410.01). Note how one may design the system to conveniently use known general codes (e.g., 410 for acute MI) along with special codes, such as the illustrated fourth and fifth digits for location and duration information. If one returned to the main SOAP screen they would see an initial assessment now indicated including the diagnosis code entered above (see FIG. 13H).

The final window that is established is the window illustrated in which has now been populated with 410.01, (initial anterior lateral MI). By this point the healthcare provider has actually selected the major diagnosis, “for admission,” and the code with which he intends to bill for his E/M services for this admission on this patient at this time. This major disease category (i.e., code 401.01) is linked to a profile documentation prompter that returns further information as illustrated in FIG. 13I. This provides the healthcare provider at the point of service with the following information: a) specific definitions of the category selected; b) major complications (e.g., arrhythmias), and c) weighted profiling alternatives (e.g., unstable angina, etc.). Now, as the healthcare provider is provided with this “pop-up screen” at the point of service, if any of the aforementioned are present, he or she will automatically include by their selection, all as a single operator and at the point and time of service. Alternatively, the information can be included in their written or dictated reports at that time, for subsequent further documentation by coding specialists either retrospectively or in the retrospective/concurrent systems, but in both cases a much more complete capture of the care information is achieved substantially contemporaneous with the care.

In both approaches, once the information has been selected electronically it may readily be linked so as to auto-populate fields of the DRG, and select the DRG in a paperless, people-less, seamless fashion. This may conveniently occur by the action of a single operator at the point and time of service. This information may in turn populate other document and billing records as required or desired; e.g., in the illustrated case the DRG information may then be used to automate hospital billing forms (e.g., form UB-92 for inpatient hospital patients).

Further, using this automated approach the system may also be linked so as to intelligently or in a rules-based framework apply the input information to prospectively schedule future activates. Thus, for example, after completing the initial input a link to the physician's scheduling program could automatically schedule the next encounters (e.g., daily visit; lab work-ups; office visits post-discharge) including estimated times for the activity. Moreover, the input information can also be used in scheduling other activities—including stocking goods for upcoming procedures (e.g., the point of service generated report by the physician can create auto stocking of materials such as catheters, medicines, etc.). Prompts for approval or adjustment could also be provided before committing the scheduling/orders, either to the entering user or other person(s) authorized to approve the transaction.

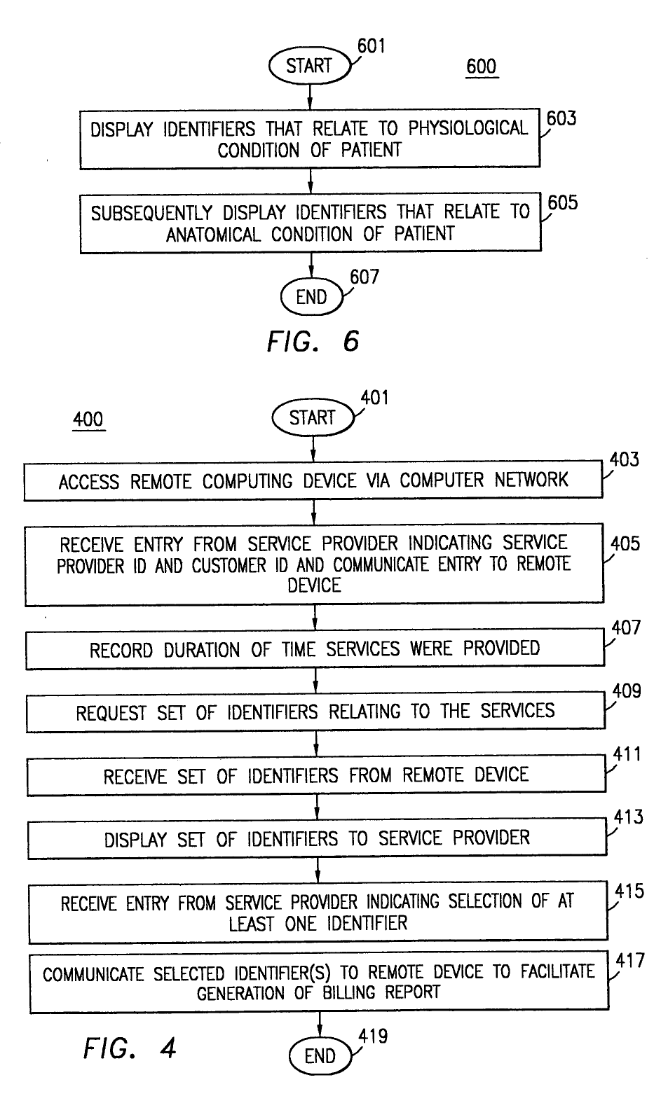

Turning now to FIG. 4, a logic flow diagram 400 is illustrated of yet another embodiment of steps executed by a local processing device 101, 102 to assist in the generation of a billing report in accordance with the present invention. The steps 403-417 described below with respect to FIG. 4 are preferably implemented in software stored in or on a computer-readable media (including without limitation computer memory, a floppy disk, a CD-ROM, a DVD, a magnetic tape, ROM, a hard disk, or any other kind of volatile or non-volatile memory) accessible by the local processing device 101, 102. Such computer-readable media includes program code, that, when executed, performs the steps 403-417 described below with respect to FIG. 4.

The logic flow begins 401 when the local processing device 101, 102 accesses 403 the remote processing device via a computer network 107, such as the Internet. As discussed above, such access preferably occurs when a user of the local processing device 101, 102 (e.g., a service provider) uses a mouse or other user interface to select an icon, a Uniform Resource Locator (URL) or other indicia displayed on the monitor of the local processing device 101, 102 indicating the user's desire to access a data recording and billing software application stored on or in a computer-readable media coupled to the remote processing device. Once the local processing device 101, 102 has accessed the remote processing device or as part of the data access sequence, the local processing device receives 405 one or more data entries from the service provider or other user indicating at least the service provider's ID or log-on code, and preferably also indicating an ID of the customer. As mentioned previously, the attending physician and any referring physician are preferably identified by their respective UPIN numbers. Local processing device 101, 102 communicates the entry or entries to the remote-processing device 103 via the computer network 107. For example, after the service provider selects the icon or other indicia indicating the service provider's desire to access the remote processing device, a log-in screen preferably appears on the local processing device 101, 102 monitor or display in which the service provider is required to enter his or her own service provider ID and preferably the customer's ID. The service provider may also be required to enter a password to access the system for security purposes. The log-in screen may be conveyed to the local processing device 101, 102 by the remote processing device 103 in response to the access request sent by the local processing device 101, 102 or the software in the local processing device 101, 102 itself may generate and display the log-in screen responsive to the service provider's selection of the remote device software indicia. In the event the local processing device 101, 102 generates and displays its own log-in screen, the access request communicated by the local processing device 101, 102 in step 403 would include the entered IDs and/or password to enable the remote processing device 103 to verify authorization of the service provider's access to the data recording and billing software application.

In a preferred embodiment, steps 403 and 405 are performed at or just prior to commencement of the services being rendered to the customer by the service provider. In such a preferred embodiment, the local processing device 101, 102 preferably includes a timer that can be started at the option of the service provider to record 407 the duration of time that the service provider provides the services to the customer. Such recordation of time permits the service provider to provide an accurate account of the time required to perform the services and such time may be used by the service provider to support the costs of the services or, in the case of medical services, to justify a particular level of cognitive care rendered to the patient during the patient's visit to the health care provider. In the health care field, such recordation of time may be further used to meet the service provider's federal requirement for reporting the amount of time that the service provider spent servicing group versus non-group patients.

After gaining access to the remote processing device or as part of the access request, the local processing device 101, 102 requests 409 a group of identifiers from the remote device 103, wherein the group of identifiers relate to the services being offered by the service provider. For example, responsive to the local device's logging onto the remote processing device 103 and accessing the remote device's data recording and billing software application, the remote device's software application may automatically communicate a list or menu of service codes and associated service descriptions to the local device 101, 102 for use by the service provider to indicate the services being rendered to the customer. Thus, the request for the group of identifiers may be implied in the local device's access of the remote device 103. Alternatively, the request for the identifiers may be a separate, express request (e.g., responsive to input from the service provider).

After requesting the group of identifiers, the local processing device 101, 102 receives 411 the group of identifiers from the remote device 103 and displays 413 the group of identifiers to the service provider. The group of identifiers may include several subgroups (e.g., submenus) depending on the type of services provided by the service provider and/or the billing and reporting requirements of one or more particular third party payor(s), such as an insurance carrier, that is at least partially responsible for payment for the services. Such payor—specific information would be provided selectively in response to matching patient identification information with the payor(s) to be billed for a particular patient. Depending on the number of identifiers to be reviewed by the service provider, the identifiers may be all displayed at once, or they may be displayed in subgroups based on a subgroup category. In the event that only subgroups are displayed, the end of selection of a particular identifier or identifiers from one subgroup preferably results in the next subgroup of identifiers being automatically displayed to the service provider on the monitor of the local processing device. For example, in a health care office, the health care provider may first view services codes or equivalent identifiers relating to the cognitive level of care rendered to the patient. Upon receiving the health care provider's selection of one or more of such codes and depression of “ENTER” key on the keyboard or selection of a virtual button on the screen indicating the end of the cognitive level of care subgroup identifier selection, the local processing device automatically retrieves (from its own RAM or from the remote device) and displays the next category of identifiers (e.g., the service codes relating to a non-cognitive level of care recommended for the patient) to the service provider. As noted above, in the event that a third party, such as an insurance provider or the federal government, is responsible for at least partial payment for the services, the identifiers received by the local processing device 101, 102 and displayed to the service provider are those that have been previously approved by the third party to identify particular services.

Some of the identifiers may also provide an indication that the services rendered or to be rendered to the customer are not services for which the third may be responsible for payment or partial payment. For example, as discussed above and in more detail below, one medical service-related identifier relating to a non-cognitive level of care or a health care condition of a patient may be associated with an advance beneficiary notice indicating certain medical services that are not subject to payment or partial payment by an insurance provider.

After the group or subgroup of identifiers have been displayed to the service provider, the local processing device receives 415 an entry from the service provider or other user indicating the selection of at least one parameter. This assumes that at least one of the displayed identifiers adequately relates to the services being rendered. If no identifiers adequately relate to the rendered services, additional groups or subgroups of identifiers may be displayed for selection at the service provider's request in the form of an appropriate command entered via device 101 or 102. After receiving a selection by the service provider, the local processing device 101, 102 communicates 417 the selected identifier or identifiers to the remote-processing device to facilitate generation of the billing report, and the logic flow ends 419.

All the steps identified in blocks 403-417 of FIG. 4 are preferably performed substantially at the time when the services are being rendered to the patient or other customer. That is, in a preferred embodiment, the service provider accesses the remote-processing device 101, 102 at or about the time the services commence and completes the identifier selection and submission to the remote-processing device 103 at or about the time the services are completed. In this manner, the present invention facilitates rapid generation and submission of the information necessary to complete the billing report by the person most skilled to provide that information (i.e., the service provider himself or herself).

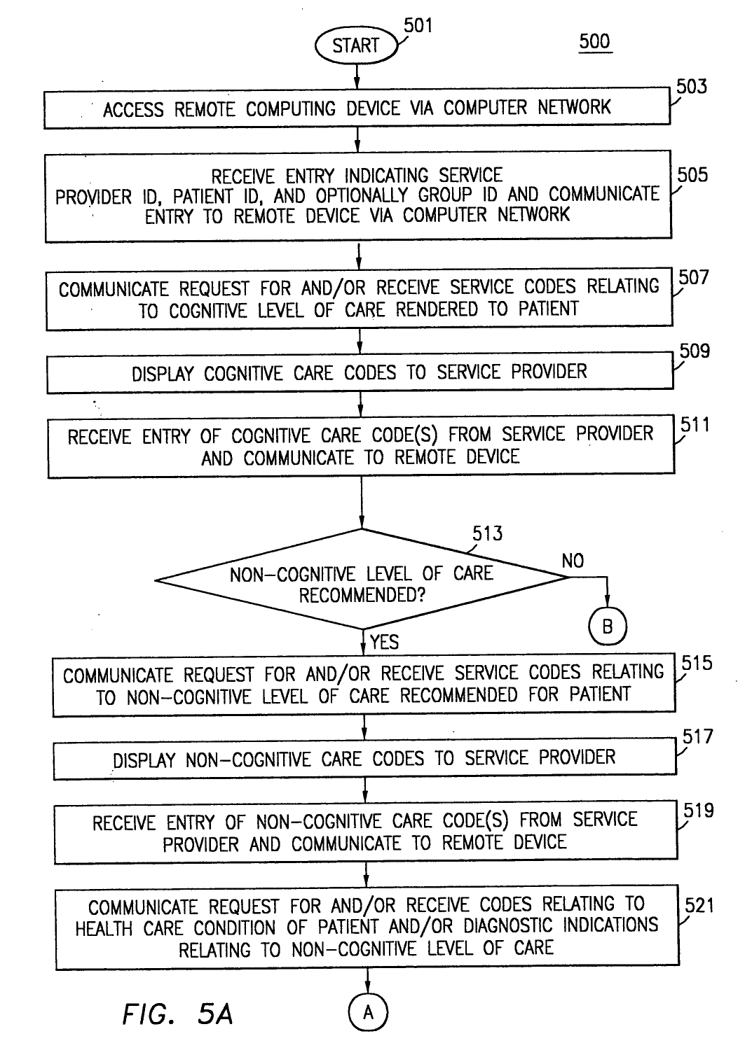

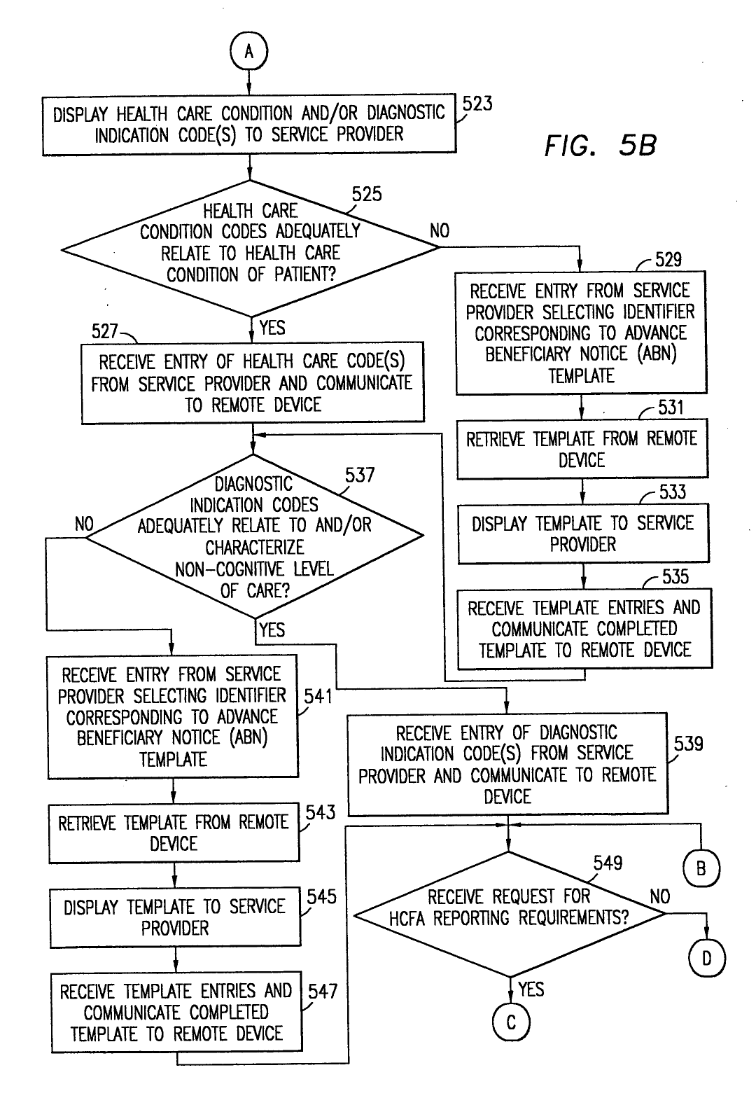

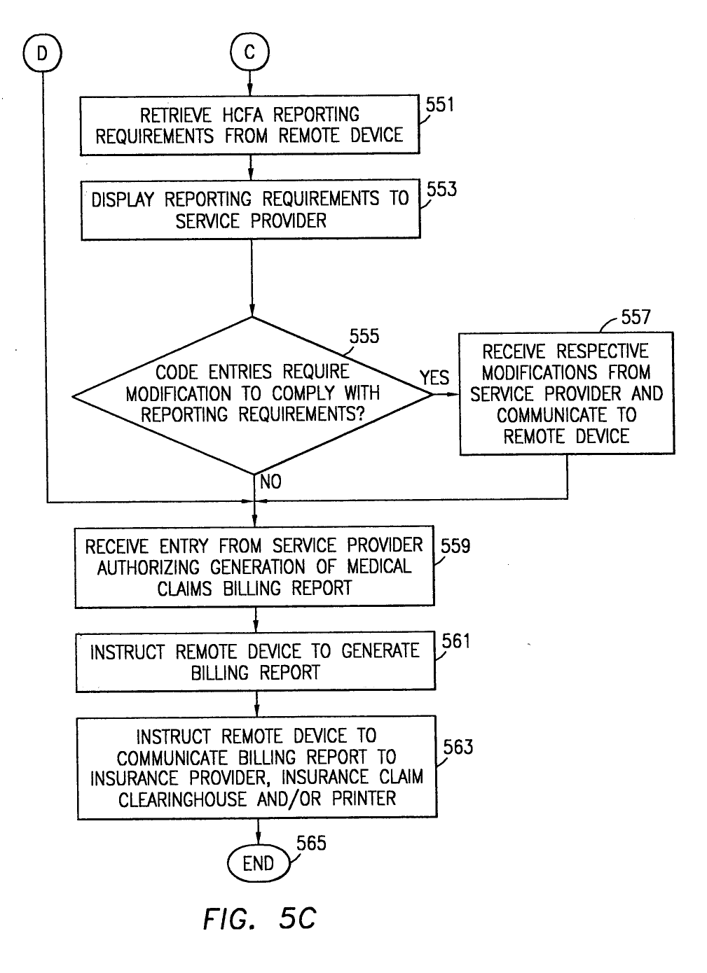

FIGS. 5A-5C together make up a logic flow diagram 500 of steps executed by a local processing device 101, 102 to assist in the generation of a medical claims billing report in accordance with a preferred embodiment of the present invention. The steps 503-563 described below with respect to FIGS. 5A-5C are preferably implemented in software stored in or on a computer-readable media (including without limitation computer memory, a floppy disk, a CD-ROM, a DVD, a magnetic tape, a hard disk, or any other kind of volatile or non-volatile memory) accessible by the local processing device 101, 102. Accordingly, such computer-readable media includes program code that, when executed, performs the steps 503-563 described below with respect to FIGS. 5A-5C.

The logic flow begins 501 when the local processing device 101, 102 accesses 503 a remote processing device 103 via the computer network. Such access is preferably responsive to the service provider's selection of an icon or other indicia representative of the remote processing device 103 or the data recording and billing software application stored on or accessible by the remote processing device 103. In addition to accessing the remote processing device 103, the local processing device 101, 102 receives 505 one or data entries from a service provider comprising all relevant identifying information including for example the service provider's ID, the patient's ID and optionally a health plan group ID associated with the patient, and communicates that entry to the remote processing device via the computer network. As discussed above, with respect to FIG. 4, the communication of the service provider's ID, the patient's ID and the group ID may be substantially simultaneous with the access request referred to in block 503. That is, when the software running on the local processing device 101, 102 is such that it provides the log-on screen upon the service provider's selection of an icon or other indicia relating to the remote processing device 103 or the remote device's software application, the access request communicated by the local processing device 101, 102 includes the service provider ID and other necessary IDs (e.g., patient ID and group ID). Alternatively, the communication of the service provider ID and the other optional IDs may themselves constitute an implied request for accessing the remote processing device 103 and the data recording and billing software used by the remote processing device 103.

In addition to accessing the remote processing device 103 and providing the remote device 103 with appropriate information (e.g., IDs) to enable the remote device 103 to authorize the service provider's use of the remote device's data recording and billing software, the local processing device 101, 103 communicates 507 a request for and/or receives service codes and descriptions relating to a cognitive level of care either rendered to or to be rendered to the patient. The request for the cognitive level of care service codes and descriptions (e.g., cognitive CPT codes and descriptions) may be separate from the access request or may be included in the access request. In the event that the request for the cognitive level of care codes is separate from the request to access the remote processing device, the local processing device 101, 102 communicates such request after obtaining access to the remote processing device 103 either automatically or responsive to input from the service provider. Alternatively, in the event that the request for the cognitive level of care codes is included in the request to access the remote processing device 103, the local processing device 101, 102 receives 507 the cognitive level of care service codes from the remote processing device 103 in response to the original access request.

Upon receiving the cognitive level of care codes from the remote-processing device 103, the local processing device 101, 102 displays 509 the cognitive level of care codes to the service provider. A preferred method of displaying the cognitive level of care codes is discussed in further detail below with reference to FIG. 6. Alternatively, as discussed above, if a group of CPT codes and levels is predetermined based on scheduling and other criteria entered before the service is provided, the physician will nonetheless have the opportunity to review the suggested level of service selected and verify or approve the selected level of care.

After displaying the cognitive level of care codes to the service provider, the local processing device 101, 102 preferably receives 511 entry of one or more cognitive level of care codes from the service provider, via the device user interface, and communicates the selected codes to the remote processing device 103. The entry of the cognitive level of care codes may be carried out through selection of displayed codes using any capable input device such as a mouse, a touch screen or any of the other user interface types described above (e.g., by typing or voice input of the alpha, numeric, or alpha-numeric code(s) associated with the appropriate cognitive level of care using a keyboard or keypad). As discussed below, the cognitive level of care codes are preferably displayed visually to the health care service provider on the screen or monitor of the local processing device. Each cognitive level of care code is preferably associated with a description of the particular cognitive level of care to which the code corresponds. Therefore, upon viewing the cognitive level of care codes and their associated levels of care, the physician or other health care service provider can select the code(s) to correctly identify the appropriate level of care rendered to or to be rendered to the patient.

In a preferred embodiment, the cognitive level of care descriptions and their associated codes are all acceptable to the patient's insurance provider and preferably confirm to the cognitive level of care codes promulgated by the Federal Health Care Financing Administration (HCFA). Thus, prior to the health care service provider's access of the remote processing device via the local processing device, a database stored on or in a computer-readable media accessible by the remote processing device is filled with cognitive level of care codes and descriptions which are acceptable to the patient's insurance provider and/or the federal government (e.g., when Medicare or Medicaid is the patient's insurance provider). The appropriate cognitive level of care codes and descriptions are retrieved from the database responsive to the request communicated in block 507 preferably based on the service provider's ID, the patient's ID and if provided, the patient's health care group ID. The cognitive level of care codes entered by the health care service provider through a keypad, keyboard or other user interface are communicated 511 to the remote-processing device via the computer network.

Once the cognitive level of care code entries have been completed by the health care provider, the local processing device 101, 102 determines 513 based on an input provided by the physician or other service provider whether any non-cognitive level of care (e.g., clinical tests, non-invasive, invasive; intervention or other procedures) are recommended for the patient. The programming of local device 101, 102 may presume by default that such non-cognitive care is necessary unless the service provider indicates otherwise or may await an express entry by the service provider indicating the necessity of non-cognitive care or a request for non-cognitive level of care codes and descriptions (e.g., non-cognitive CPT codes and descriptions).

In the event a non-cognitive level of care is recommended for the patient by the physician, the local processing device 101, 102 communicates 515 a request for and/or receives service codes relating to each selected non-cognitive level of care. In a preferred embodiment, after the service provider has completed entering the cognitive level of care codes, the local processing device 101, 102 automatically retrieves the non-cognitive level of care codes and descriptions from the remote processing device 103. In such a preferred embodiment, the local processing device 101, 102 automatically receives 515 non-cognitive level of care codes and descriptions from the remote processing device 103 after the service provider has completed his or her entry of the cognitive level of care codes. Optionally, the local processing device 101, 102 may be programmed to identify and display one or more non-cognitive levels of care which, based on the cognitive level(s) of care previously entered, the physician may wish to consider and/or select. The completion of entry (selection) of cognitive level of care codes may be indicated through the service provider's selection of an “enter” key on the keyboard or through selection of an enter virtual button using the computer mouse or through various other known user interface protocols.

Alternatively, the local processing device 101. 102 might retrieve the non-cognitive level of care codes and descriptions at substantially the same time the cognitive level of care codes and descriptions are retrieved. In such case, the local processing device 101, 102 would store the non-cognitive level of care codes and descriptions in RAM or other memory for subsequent use after the service provider has completed reviewing and entering the cognitive level of care codes. In yet another embodiment, the local processing device 101, 102 might communicate a separate request for the non-cognitive level of care codes and descriptions after receiving an indication from the service provider that the service provider has completed his or selection of cognitive level of care codes.

Regardless of how or when the non-cognitive level of care codes and descriptions are retrieved from the remote processing device 103, the local processing device 101, 102 displays 517 the non-cognitive level of care codes and descriptions to the service provider on the screen, monitor or other display of the local processing device 101, 102 (and/or those of any wireless communication device(s) 161 associated therewith). Like a preferred cognitive level of care codes, the preferred non-cognitive level of care codes preferably comprise non-cognitive CPT codes promulgated by HCFA or which are otherwise acceptable to the patient's insurance provider or other third party payor. Also, like the cognitive level of care codes, the non-cognitive level of care codes and descriptions are preferably stored in a database in or on a computer-readable media that is accessible by the remote processing device 103, and are approved in advance and/or promulgated by the patient's insurance provider, the federal government and/or other payor(s) applicable to the patient. In a preferred embodiment, both the cognitive and the non-cognitive level of care codes are specific to a particular type of medical specialty. Thus, a computer-readable media 143 accessible by the remote processing device 101, 102 may include all or part of any of several databases, each of which includes respective cognitive and non-cognitive CPT codes for a medical field or specialty, such as cardiology, neurology and so forth.

After acquiring the non-cognitive level of care codes and descriptions, the local processing device 101, 102 displays 517 the codes and descriptions to the service provider. As in the case of the cognitive level of care codes, each non-cognitive level of care code and description is associated with a particular non-cognitive level of care. Such display of the non-cognitive level of care codes and associated descriptions may take the form of a simple list, table or menu. Alternatively, such information may be displayed and processed in the novel manner described further below with referenced to FIG. 11. After the service provider has reviewed the displayed codes and descriptions, the local processing device 101, 102 receives 519 entry of at least one of the non-cognitive level of care codes from the service provider and communicates 519 the selected code(s) to the remote processing device 103. Depending on the number of non-cognitive level of care codes, the display of the codes may require the service provider to page or scroll through several screens of codes in accordance with known techniques to locate the appropriate codes for selection, or the local and/or remote device software may be configured to support execution of a text search or SQL query as discussed above. After identifying one or more non-cognitive level of care codes and descriptions that relate to the recommended non-cognitive level of care, the service provider enters, through selection or otherwise, the identified non-cognitive level of care codes and the local processing device 101, 102 communicates the entered codes to the remote processing device 103 via the computer network 107.

After the non-cognitive level of care codes have been entered by the service provider (e.g., as indicated by the service provider's selection of a virtual “COMPLETE” or “END” button using a computer mouse, touch screen or keyboard arrow keys), the local processing device 101, 102 communicates a request for and/or receives from the remote processing device 103, 521 codes or identifiers relating to the health care condition of the patient and/or diagnostic indications relating to the non-cognitive level or levels of care previously selected by and/or entered into the local processing device 101, 102 by the service provider. Such codes or identifiers are referred to herein as “health care condition codes” and “diagnostic indication codes”, respectively. As discussed above with respect to the non-cognitive level of care codes and the cognitive level of care codes, the local processing device 101, 102 preferably communicates a request for the health care condition codes and the diagnostic indications codes automatically upon receiving an entry from the service provider that the service provider has completed his or her selection of the non-cognitive level of care codes. Alternatively, the local processing device 101, 102 may refrain from communicating the request for the health care condition codes and the diagnostic indications codes until the service provider affirmatively indicates his or her desire to receive such codes through an appropriate entry into the local processing device 101, 102. The software in the local processing device 101, 102 may also include routines that select appropriate health care condition codes and descriptions and diagnostic indication codes and descriptions based on the entered non-cognitive level of care codes without requiring a separate request communicated to the remote processing device 101, 102. In such case, the local processing device 101, 102 would receive all necessary service-related codes and descriptions (i.e., cognitive level of care, non-cognitive level of care, health care condition and diagnostic indications) at or about the time that the local processing device 101, 102 originally accesses the remote processing device 103.

At the appropriate time, the local processing device 102, 103 displays 523 the health care condition codes and/or the diagnostic indication codes to the service provider. In a preferred embodiment, the local processing device 102, 103 first displays the health care condition codes and descriptions and then displays the diagnostic indication codes and descriptions only after the service provider has indicated that he or she has completed selection and/or entry of the health care condition codes. In a preferred embodiment, the health care condition codes comprise ICD codes such as the ICD-9 codes discussed earlier above. As in the case of the display of the non-cognitive level of care codes and the cognitive level of care codes, each health care condition code is preferably accompanied by an associated description of a health care condition or diagnosis for the patient. Upon reviewing the health care condition codes and descriptions, the service provider determines whether the health care condition codes and descriptions correctly relate to the health care condition of the patient. The local processing device 101, 102 likewise determines 525 whether the health care condition codes and descriptions adequately relate to the health care condition of the patient based on entries made by the service provider after his or her determination. If at least one of the health care condition codes and descriptions adequately relates to the health care condition of the patient (i.e., recites a diagnosis of the patient's health condition), the local processing device 101, 102 receives 527 entry of one or more health care condition codes from the service provider and communicates the received codes to the remote processing device 103. As discussed above with respect to entry of cognitive level of care codes, entry of the health care condition codes may occur through selection of the particular code using a computer mouse, through entry of the numeric or alpha-numeric characters associated with the code through the keypad, or through the use of any other known user interface mechanism.

In the event that none of the health care condition codes and descriptions adequately relate to the health care condition of the patient, the local processing device 101, 102 receives 529 an entry from the service provider selecting an identifier or code corresponding to an advance beneficiary notice (ABN) template. In a preferred embodiment, the health care condition codes include one code (e.g., the first code or identifier, the last code or identifier, or the first or last code or identifier on each screen or electronic page of health care condition codes) that allows the service provider to specify a health care condition of the patient that is not approved for payment by the patient's insurance provider. Selection of the ABN identifier code by the service provider enables the patient's insurance provider to quickly determine that the care associated with the patient's health care condition as specified in the ABN template may not be covered by the patient's insurance policy. Use of the ABN template for non-covered medical care facilitates faster claims processing by the patient's insurance provider and substantially reduces the likelihood of any allegation of insurance fraud due to the service provider's attempt to force the patient's condition into an enumerated health care condition.

After receiving the service provider's entry selecting the ABN identifier, the local processing device 101, 102 retrieves 531 the ABN template from the remote-processing device 103 and displays 533 the template to the service provider. The local processing device 101, 102 then receives 535 template entries from the service provider and communicates the completed ABN template to the remote-processing device 103 for use in generating the billing report. Entries into the ABN template are preferably provided via the keyboard or keypad of the local processing device 101, 102. In addition, if required by the patient's insurance provider or governmental regulation, the template entries may further include an electronic signature of the patient or other suitable verification of identity obtained in accordance with known techniques, such as those commonly used to electronically enter the signature of authorized credit card users at a point-of-sale.

In addition to determining whether the health care condition codes adequately relate to the health care condition of the patient, the service provider also determines whether the diagnostic indication codes and description adequately relate to and/or characterize the non-cognitive level of care recommended for the patient. The local processing device 101, 102 likewise determines 537 whether the diagnostic indication codes and descriptions adequately relate to and/or characterize the non-cognitive level of care based on entries made by the service provider after his or her determination. In the event that the diagnostic indication codes and descriptions—which in a preferred embodiment are displayed via display 150 and/or 177 automatically after the service provider has indicated his or her completion of entering health care condition codes—adequately relate to and/or characterize the non-cognitive level of care recommended for the patient, the local processing device receives 539 entry of one or more diagnostic indication codes from the service provider and communicates the selected or entered codes to the remote processing device 103. Entry of the diagnostic indication codes is similar to the above-described entry of the health care condition codes, the non-cognitive level of care codes and the cognitive level of care codes. Similar to the other aforementioned health care service-related codes, each diagnostic indication code is preferably accompanied by a recitation of the particular diagnostic indication corresponding to the code. Thus, in a preferred embodiment, the service provider scrolls through and reviews the diagnostic indications related to the selected non-cognitive level of care, and selects or enters the appropriate codes to support the service provider's choice of the non-cognitive level of care recommended for the patient.

In the event that none of the diagnostic indication codes and descriptions adequately characterize the service provider's recommended non-cognitive level of care, the local processing device 101, 102 receives 541 an entry from the service provider selecting an identifier or code corresponding to an ABN template. Responsive to receiving entry of the ABN identifier, the local processing device 101, 102 retrieves 543 the ABN template from the remote-processing device and displays 545 the template to the service provider. Some time after displaying the template to the service provider, the local processing device receives 547 entries into the template and, upon receiving an indication from the service provider that the template entries have been completed, communicates the completed template to the remote processing device.

Thus, as discussed above with respect to the health care condition codes, the service provider can use the ABN identifier to request an ABN template from the remote processing device to enable the service provider to particularly describe his or her basis for recommending a particular non-cognitive level of care for the patient and thereby alert the patient's insurance provider that there may be grounds for the insurance provider to reject the claim for the recommended non-cognitive level of care. Similar to the discussion with respect to step 535 above, the ABN template entries may include the entry of the electronic signature of the patient to comply with federal regulations requiring the service provider to inform the patient that the recommended non-cognitive or clinical procedures may not be covered by the patient's insurance. Although the logic flow diagram 500 depicts the entry or selection of health care condition codes prior to the selection or entry of diagnostic indication codes, such order of steps is arbitrary rather than required and shall not be implied. Rather, the order of selection of the health care condition codes and the diagnostic indication codes shown in FIG. 5B is preferred only and is not required to implement the present invention.

After receiving entry or selection of all the service-related codes, or after receiving entry of only the cognitive level of care codes when no non-cognitive level of care has been recommended for the patient, the local processing device 101, 102 determines 549 whether it has received a request from the service provider for the HCFA or insurer-specific reporting requirements. That is, in a preferred embodiment, after receiving selection or entry of all the necessary service codes, the local processing device 101, 102 determines whether the service provider has indicated that he or she wants to review the federal or insurer-specific reporting requirements related to the selected codes. In order to be properly reimbursed under Medicare or Medicaid, health care providers must meet the HCFA reporting requirements with respect to the non-cognitive and cognitive levels of care rendered to a patient. Thus, the present invention enables the service provider to check to make sure that the codes, in particular the health care condition codes and the diagnostic indication codes, entered or selected to identify the cognitive and non-cognitive levels of care comply with HCFA or other insurer-specific reporting requirements in order to reduce the likelihood that insurance claims based on the selected codes will be rejected by the patient's insurance provider. This system will also store ICD-9—CPT acceptance for any time periods after December 2000—this will be required for possible future audits of claims submitted in a specific time period (i.e. 163 audit of 2001 claim). Alternatively, the HCFA or insurer-specific reporting requirements may be requested prior to or after entry of one or more of the service-related codes as opposed to being requested only after entry of all necessary services codes.

In the event that the service provider does desire to receive the HCFA or insurer-specific reporting requirements, the local processing device will have determined in step 549 that it received a request for the reporting requirements. Such a request may be entered in any manner via the user interface of the local processing device 101, 102. After receiving the request, the local processing device 101, 102 contacts the remote processing device 103 electronically over the computer network 107 and retrieves 551 the reporting requirements from the remote processing device 103. The local processing device 101, 102 displays 553 the reporting requirements to the service provider and also preferably displays the previously selected codes and descriptions to enable the service provider to compare the selected codes and descriptions with the reporting requirements. The service provider then compares the displayed reporting requirements to the previously selected codes and descriptions to determine whether the code entries require modification or re-entry in order to comply with the reporting requirements. The local processing device 101, 102 likewise determines 555 whether the previously entered codes require modification or re-entry to comply with the reporting requirements based on entries made by the service provider after his or her determination. In the event that some modification or changes to the codes are required for compliance, the local processing device receives 557 the respective modifications or changes from the service provider and communicates the updated codes to the remote-processing device 103 for use in generating the billing report.

After receiving the modifications or changes to the service codes, or in the event that no code changes are required for compliance with the HCFA or insurer-specific reporting requirements, the local processing device 101, 102 receives 559 an entry from the service provider authorizing the generation of the medical claims billing report (e.g., insurance claim form) by the remote processing device 103. Such an entry indicates to the local processing device 101, 102 that the service provider has completed all the code entries necessary to enable the remote-processing device to proceed with generating the medical claims billing report. Responsive to the service provider's entry in step 559, the local processing device instructs 561 the remote processing device to generate the billing report. In addition, the local processing device 101, 102 preferably instructs 563 the remote processing device 103, either by a separate command or inherently in its instruction of step 561, to communicate the generated billing report to the patient's insurance provider, an insurance claim clearinghouse, a printer located at the location where the medical services are being rendered, and/or a printer coupled at some other location (e.g., at a hospital or other location at which the non-cognitive level of care may be administered to the patient), and the logic flow ends (565). The communication of the billing report to the insurance provider, the insurance claim clearinghouse and/or a printer preferably occurs over the computer network 107 which, in a preferred embodiment, comprises a wide area network, such as the Internet or via some other medium (e.g., via facsimile).

In a preferred embodiment, all the steps 503-563 in FIG. 5 preferably occur substantially during the time when the service provider is meeting with the patient to provide the medical services to the patient. That is, all the steps 503-563 in FIG. 5 preferably occur during the patient's office visit. Thus, in accordance with the present invention, the service provider himself or herself provides all the information necessary to generate the billing report (e.g., insurance claim form) to a host device at the time such information is fresh in the provider's memory. By having the service provider provide the information directly to the report generation software during the patient's office visit or shortly thereafter, the present invention insures that the person with the most knowledge with respect to why particular cognitive and non-cognitive levels of care were rendered or recommended for the patient applies such knowledge directly to generating the insurance claim form to facilitate rapid, accurate completion of the form. Therefore, the present invention eliminates or substantially reduces the number of coding errors that typically result from interpretation of a physician's notes or dictation by the physician's and/or the hospital's office staff during completion of insurance claim forms. With the present invention, instead of intermediaries interpreting a physician's notes or transcription to determine the appropriate cognitive and non-cognitive CPT codes, ICD-9 codes, and/or diagnostic indication codes, the physician himself or herself selects the codes to be used in generating the insurance claim form substantially at the time of service and communicates the codes via the computer network to a billing software application executed by a remote host device to enable the remote host to generate an accurate insurance claim form shortly after the services have been completed. Thus, the insurance claim form generated in accordance with the present invention after completion of the services includes all the information necessary for the insurance provider to satisfactorily process the claim and submit payment to the service provider in a timely manner.

FIG. 6 is a logic flow diagram 600 of steps executed to display identifiers or codes (e.g., cognitive CPT codes) relating to a cognitive level of care to a health care provider in accordance with a preferred embodiment of the present invention. The steps 603-605 described below with respect to FIG. 6 are preferably implemented in software stored in or on a computer-readable media (including, without limitation, computer memory, a floppy disk, a CD-ROM, a DVD, a magnetic tape, a hard disk, or any other kind of volatile or non-volatile memory) accessible by the local processing device 101, 102. Accordingly, such computer-readable media includes program code that, when executed, performs the steps 603-605 described below with respect to FIG. 6.

The logic flow begins 601 when the local processing device 101, 102 or other apparatus displays 603 identifiers or codes that relate to the physiological condition of the patient. The physiological condition of the patient preferably comprises a sign detected by the health care provider prior to performing any physical examination of the patient and/or a symptom reported by the patient. After displaying the identifiers that relate to the physiological condition of the patient, the local processing device 101, 102 or other apparatus subsequently displays 605 identifiers that relate to the anatomical condition of the patient, and the logic flow ends 607. The anatomical condition of the patient comprises one or more physical conditions of the patient that are detected by the health care provider as a result of performing a physical examination of the patient.

Referring back to FIG. 5, after the local processing device 101, 102 receives the cognitive level of care service codes from the remote processing device in step 507, the local processing device 101, 102 displays the cognitive level of care codes to the service provider preferably in accordance with the logic flow of FIG. 6. That is, the local processing device 101, 102 first preferably displays the codes and descriptions that relate to the physiological condition of the patient. After the service provider has selected the codes or identifiers that relate to the physiological condition of the patient, the local processing device 101, 102 subsequently displays the codes and descriptions that relate to the anatomical condition of the patient. By displaying the cognitive level of care codes (e.g., cognitive CPT codes) to the service provided in this manner, the cognitive level of care codes are displayed in such a way as to allow the service provider to rapidly select the codes. Rapid selection of the codes is facilitated by displaying the codes to the service provider in a manner that conforms logically to the thinking process of the service provider as he or she is rendering the cognitive level of care to the patient. Thus, instead of merely displaying the cognitive level of care codes to the health care provider in numerical or identifying name only, the present invention preferably displays the cognitive level of care codes in a manner that would follow the provider's thought process while administering the cognitive level of care. It is believed that in using this technique, the HCP decides within about the first 20% of the way into an encounter that the CPT should be.

By providing the cognitive level of care codes in a preferred arrangement of FIG. 6, the present invention allows the health care service provider to rapidly select the codes because the health care service provider is viewing the codes in substantially the same order as the service provider is rendering the service. By arranging and displaying the codes as depicted in FIG. 6, the present invention greatly reduces the amount of time that the service provider must spend searching through cognitive level of care codes to arrive at the appropriate codes for use in accurately identifying the cognitive level of care rendered to the patient.

With respect to a computer environment, steps 603 and 605 may be implemented through individual screen displays or displays within a single screen. For example, the identifiers and descriptions relating to the physiological condition of the patient may be displayed on a first screen for selection by the service provider and, subsequent to selection of one or more of the physiological condition identifiers or codes, the identifiers and descriptions relating to the anatomical condition of the patient may be subsequently displayed on a second screen. Alternatively, the identifiers and descriptions relating to the physiological condition of the patient may be displayed on one portion of the screen (e.g., the top portion of the screen) and the identifiers and descriptions relating to the anatomical condition of the patient may be displayed on a second portion of the screen (e.g., the bottom portion of the screen) that is intended to be viewed by the health care provider after the health care provider views the portion of the screen that includes the physiological condition identifiers and descriptions. In light of the present description, those of ordinary skill in the art will appreciate that various alternatives may be employed to implement a preferred arrangement and display of the cognitive level of care codes in accordance with the logic flow diagram 600 of FIG. 6, provided that the service provider is first provided display of the identifiers and descriptions that relate to the physiological condition of the patient and is subsequently provided display of the identifiers and descriptions that relate to the anatomical condition of the patient to reduce the amount of time that the service provider spends selecting cognitive level of care codes for use in generating the medical claims billing report.

Although the above discussion has focused on the display of the cognitive level of care codes in a computer environment (e.g., on an electronic display screen of some kind), such codes may be alternatively displayed in accordance with the present invention in a book, manual or other apparatus that may be used by the service provider while he or she uses the local processing device 101, 102 to select cognitive level of care codes for communication to the remote processing device. For example, the identifiers and descriptions that relate to the physiological condition of the patient may be displayed on one page of a book and the identifiers and descriptions relating to the anatomical condition of the patient may be displayed on a subsequent page. In such a case, the physician could then refer to those pages of his code book to enter the appropriate cognitive level of care codes into the local processing device 101, 102 for communication to the remote processing device 103.

In a preferred embodiment, as discussed above, the remote processing device 103 includes or is in communication with computer-readable media 137 that includes various databases containing cognitive level of care codes, non-cognitive level of care codes, health care condition codes and diagnostic indication codes that relate to particular areas of medicine or other services. The appropriate codes are selected by the remote-processing device 103 for display to the service provider via the display 150 and/or 179 of local processing device 101, 102 upon receipt and verification of the service provider's ID by remote processing device 103. That is, upon receiving the service provider's ID, the remote-processing device 103 determines the appropriate database to be accessed in support of providing the various codes to the local processing device 101, 102 for subsequent display to and selection by the service provider.

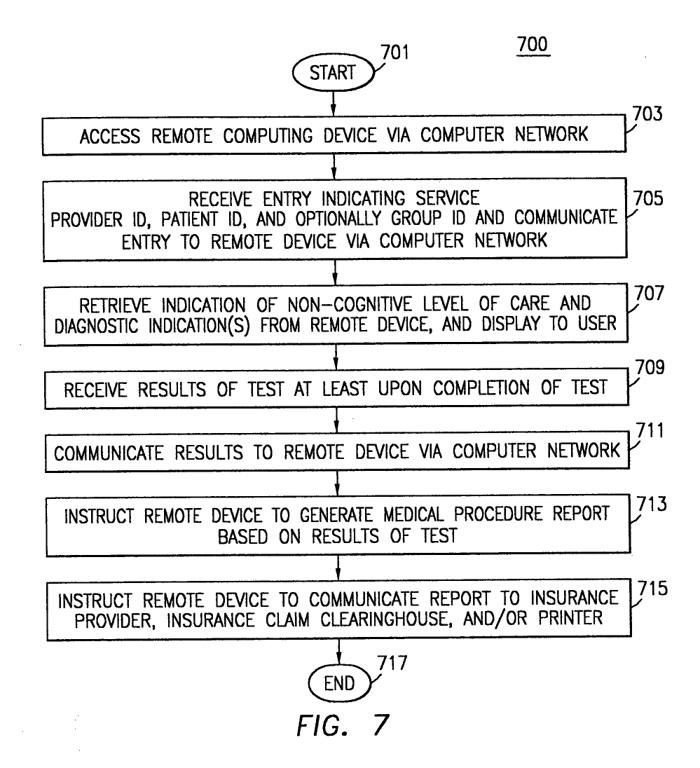

FIG. 7 is a logic flow diagram 700 of steps executed by a local processing device to assist in the generation of a medical procedure report in accordance with a preferred embodiment of the present invention, wherein the local processing device is located locally with respect to a location at which a non-cognitive level of medical care is being administered to a patient. The steps 703-715 described below with respect to FIG. 7 are preferably implemented in software stored in or on a computer-readable media (including, without limitation, computer memory, a floppy disk, a CD-ROM, a DVD, a magnetic tape, a hard disk, or any other kind of volatile or non-volatile memory) accessible by the local processing device. Accordingly, such computer-readable media includes program code that, when executed, performs the steps 703-715 described below with respect to FIG. 7.

The logic flow begins 701 when the local processing device 101, 102 accesses 703 the remote processing device 103 via the computer network. As part of such access or subsequent to such access, the local processing device 101, 102 receives 705 one or more entries indicating the service provider's ID, the patient's ID and/or the group ID of the patient, and communicates the entry or entries to the remote processing device via the computer network. As discussed above with respect to FIGS. 4 and 5, the service provider (in this case, the service provider administering the non-cognitive level of care to the patient) preferably selects an icon or other indicia on the screen of the local processing device to indicate the service provider's desire to access the remote processing device 103 and its data recording and billing software application.

Responsive to the service provider's indication to access the remote processing device, the local processing device displays a log-on or comparable screen to facilitate entry of the service provider's ID, the patient's ID and/or any other IDs or passwords, such as the patient's health care group ID. The log-on screen may be generated locally by the software on the local processing device 101, 102 or it may be retrieved from the remote processing device 103 upon obtaining access to the remote processing device 103.

After communicating the service provider's ID, the patient's ID and/or any other IDs or passwords to the remote processing device 103 via the computer network 107, the local processing device 101, 102 retrieves 707 an indication and description of the non-cognitive level of care to be administered to the patient and any diagnostic indications relating to such non-cognitive level of care from the remote processing device 103 via the computer network, and displays such indications and/or descriptions to the service provider. That is, after the service provider uses the local processing device 101, 102 to access the remote processing device 103 and gain access to the software application of the remote processing device 103, the local processing device 103 acquires the previously stored diagnostic indication and non-cognitive level of care codes and descriptions from the remote processing device 103 and displays them to the service provider who will be administering the non-cognitive level of care to the patient. As discussed above, non-cognitive level of care and diagnostic indication codes were preferably previously entered and stored at the remote processing device 103 by either the current service provider or another health care provider (e.g., when the present service provider is not the same health care provider who examined the patient previously and stored the respective non-cognitive level of care and diagnostic indication codes that are presently being used as a basis for administering the non-cognitive level of care to the patient). In summary, the service provider administering the non-cognitive level of care retrieves 707 the non-cognitive level of care and diagnostic indication codes and descriptions previously stored by the examining physician (which may be the same health care provider as is now administering the non-cognitive level of care) and uses the descriptions associated with the retrieved codes to proceed with administering the non-cognitive level of care to the patient.

After retrieving the diagnostic indication and non-cognitive level of care codes from the remote processing device 103, the service provider preferably administers the non-cognitive level of care (e.g., test) to the patient in such a manner as to permit the results of the test to be communicated during or no later than upon completion of administration of the test. Techniques for coupling medical test equipment, such as electrocardiogram machines and other test equipment, to a computer to enable the computer to receive data relating to the test while the test is in progress is well-known; thus, no further discussion of such an equipment set-up will be presented except to facilitate an understanding of the present invention.

Therefore, the local processing device 101, 102 preferably receives 709 results of the administered test or other non-cognitive level of care at least upon completion, and preferably during administration, of the test. As the local processing device 101, 102 is receiving the test data and results, or after the local processing device 101, 102 has received all the test data from the test equipment, the local processing device 101, 102 communicates 711 the test results and data to the remote processing device 103 via the computer network 107. The local processing device 101, 102 also instructs 713 the remote processing device 103 to generate a medical procedure report based on the test results and data received from the local processing device. Alternatively, the remote processing device 103 may automatically generate the medical procedure report based on the received test data. The medical procedure report generated by the remote-processing device 103 is in a format that is acceptable to the patient's insurance provider and/or complies with federally mandated guidelines, which are:

1. The Demographic Data—which is automatically stored in the medical report as the same data is entered into the “1500” billing report, by a data link at the point of service, time of input to the 1500—this produces simultaneous creation of the demographics for the 1500 and the templated medical report.

2. The name of the CPT and code of CPT, ICD-9 and Indication for the test are entered simultaneously from the point of service at the time of entry into the 1500 (CPT, ICD-9-indications not generally used in 1500 form)

3. The technologist then enters into the templated medical report, the specific technical results and calculations into specific areas of the report and then sends it to the HCP for interpretation.

In addition to instructing the remote processing device 101, 102 to generate the medical procedure report, the local processing device 101, 102 optionally instructs 715 the remote processing device 103 to communicate the medical procedure report to the patient's insurance provider, autosends to the referring physician and the test provider, an insurance claim clearinghouse and/or a printer that may be coupled to the network, and the logic flow ends 717.

Steps 713 and 715 may be performed automatically by the local processing device 101, 102 upon receipt of all the test data or, in the alternative, such steps 713, 715 may be performed only after receipt of an entry from the service provider instructing the local processing device 101, 102 to perform such steps 713, 715. For example, the local processing device 101, 102 software may display an icon, virtual button or other indicia that, when selected using the device's user interface, commands the local processing device 101, 102 to execute one or both of steps 713 and 715.

In summary, the logic flow diagram 700 of FIG. 7 provides a method in which a health care provider administering a non-cognitive level of care to a patient can, in real-time, communicate test data obtained during administration of such care to the remote processing device 103 for automatic entry into a medical procedure report that will accompany the insurance claim form to be submitted for payment or partial payment of the fees and costs incurred in administering such care. Such an automated process reduces the likelihood of errors in generation of the medical procedure report and, therefore, increases the likelihood that the insurance claim accompanying the medical procedure report will not be rejected and returned by the patient's insurance provider, thereby increasing the likelihood that the health care service provider will be paid timely by the insurance provider. In addition, the method depicted in FIG. 7 further increases the likelihood that the medical procedure report generated by the remote processing device 103 will comply with federal guidelines because the federal guidelines are preferably stored in, or are at least are accessible by, the remote processing device 103 and are used as a basis for generating the medical procedure report upon receipt of the test data.

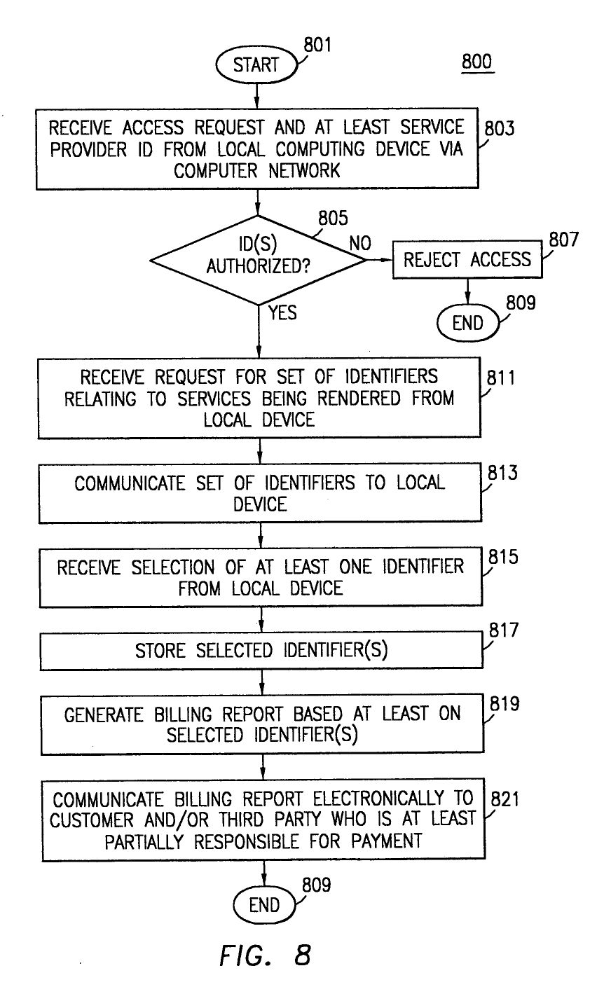

FIG. 8 is a logic flow diagram 800 of steps executed by a remote-processing device 103 to generate a billing report in accordance with the present invention. The steps 803-821 described below with respect to FIG. 8 are preferably implemented in software stored in or on a computer-readable media (including, without limitation, computer memory, a floppy disk, a CD-ROM, a DVD, a magnetic tape, a hard disk, or any other kind of volatile or non-volatile memory) accessible by the remote processing device. Accordingly, such computer-readable media includes program code that, when executed, performs the steps 803-821 described below with respect to FIG. 8.

The logic flow begins 801 when the remote-processing device 103 receives 803 an access request and at least a service provider's ID from a local processing device via the computer network 107. In addition to the service provider's ID, the remote-processing device 103 might also receive an ID of a customer, an ID of a group to which the customer belongs, and/or a password. The IDs may be embedded in the access request or may be part of a separate transmission from the local processing device 103.

After receiving the service provider ID and any other IDs or password(s) from the local processing device 101, 102, the remote processing device 103 determines 805 whether the received ID and/or password are authorized to access the data recording and billing software application stored in or on a computer-readable media operably coupled to the remote processing device 103. To determine whether the received ID(s) and/or password are authorized, the remote processing device 103 preferably compares one or more of the received IDs and/or password with a database of IDs and/or passwords stored in or on a computer-readable media operably coupled to the remote processing device 103. In a preferred embodiment, the remote processing device 103 determines whether the received service provider ID is authorized to access the data recording and billing software application with respect to the received customer ID. In an alternative embodiment, any other IDs and/or password(s) received from the local processing device 101, 102 may be used to verify the service provider's ID as part of the authorization determination of step 805.

In the event that the received service provider ID is not authorized to access the data recording and billing software application of the remote processing device 103, the remote processing device 103 rejects 807 the attempt of local processing device 101, 102 to access the remote processing device 103, and the logic flow ends 809. In the event that the service provider's ID is authorized to access and use the data recording and billing software application, the remote processing device 103 receives 811 a request from the local processing device 101, 102 for a group of identifiers relating to the services being rendered by the service provider. The group of identifiers preferably comprise service codes or service characteristics which identify the services being rendered. In the event that the services are being at least partially paid for by a third party, such as an insurance provider, the group of identifiers are acceptable to and have been approved by the third party to identify the services being rendered by the service provider. The request for the group of identifiers may form part of the access request described above with respect to step 803 or may be part of a separate request from the local processing device 101, 102 communicated after the local processing device has been granted access to the data recording and billing software of the remote processing device 103. In the event that the request for the group of identifiers forms part of the access request of step 803, the request is not acted upon by the remote processing device 103 until after the remote processing device 103 has determined that the service provider has been authorized to access the data recording and billing software of the remote processing device.

Responsive to receiving the request for a group of identifiers, the remote-processing device 103 communicates 813 a group of identifiers to the local processing device for display to the service provider. Some time after communicating the group of identifiers to the local processing device 101, 102, the remote processing device 103 receives 815 an indication of the selection of at least one of the identifiers from the local processing device 101, 102. That is, the remote-processing device 103 receives a message from the local processing device 101, 102 that includes a series of bits corresponding to one or more identifiers of the group.

Upon receiving the indication(s) of the selected parameter(s), the remote processing device 103 stores 817 the selected parameter(s) in memory and generates 819 a billing report based at least on the selected parameter(s). In a preferred embodiment, the remote-processing device 103 prepares a standard billing form, such as an insurance claim form, based on the service codes received from the local processing device 101, 102. The remote processing device 103 preferably includes, or is coupled to, a database containing an appropriate fee schedule for each identifier and preferably uses the fee schedule to prepare the billing report.

After generating the billing report, the remote processing device 103 communicates 821 the billing report electronically to the customer and/or a third party who is at least partially responsible for payment, and the logic flow ends 809. The communication of the billing report may occur automatically or may be responsive to a request from the local processing device 101, 102 to communicate the report. In a preferred embodiment, the report is communicated electronically via the computer network 107 to a processing device 104, 105 located at the customer and/or a third party, such as an insurance provider or an insurance claim clearinghouse. Alternatively, the billing report may be electronically communicated via a facsimile device or modem coupled to the remote processing device 103 in accordance with known facsimile transmission techniques.

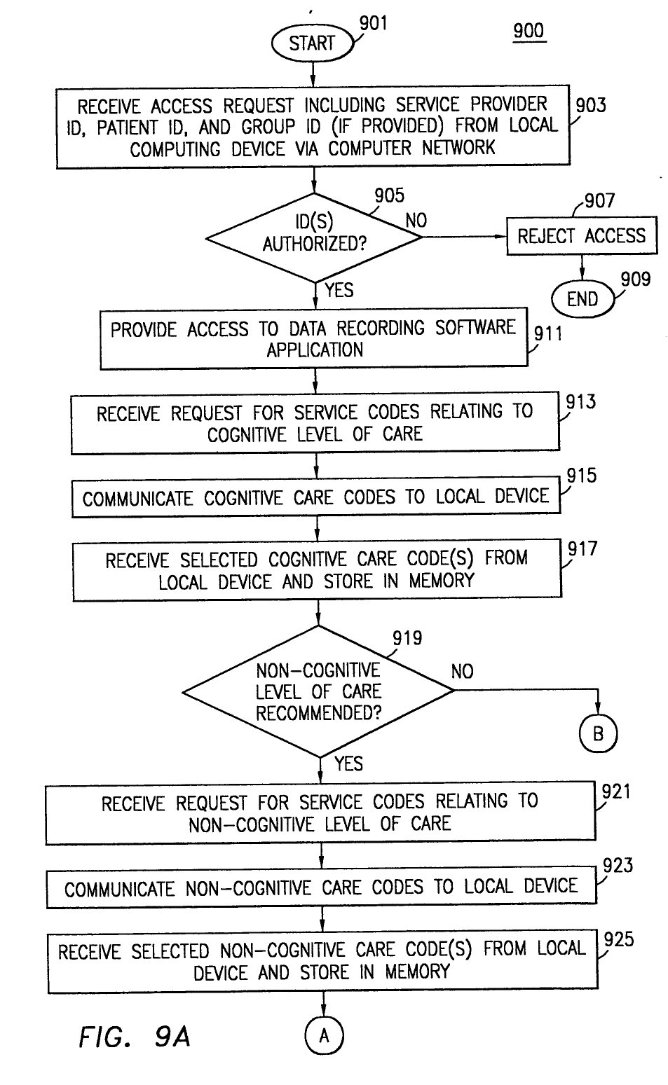

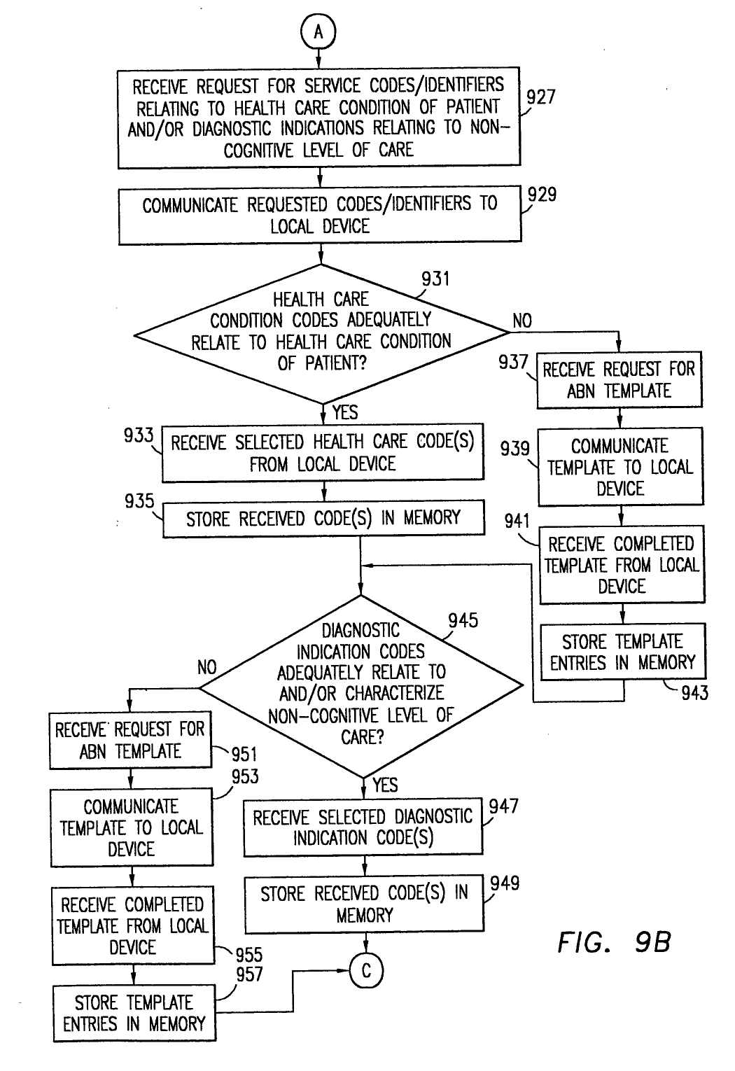

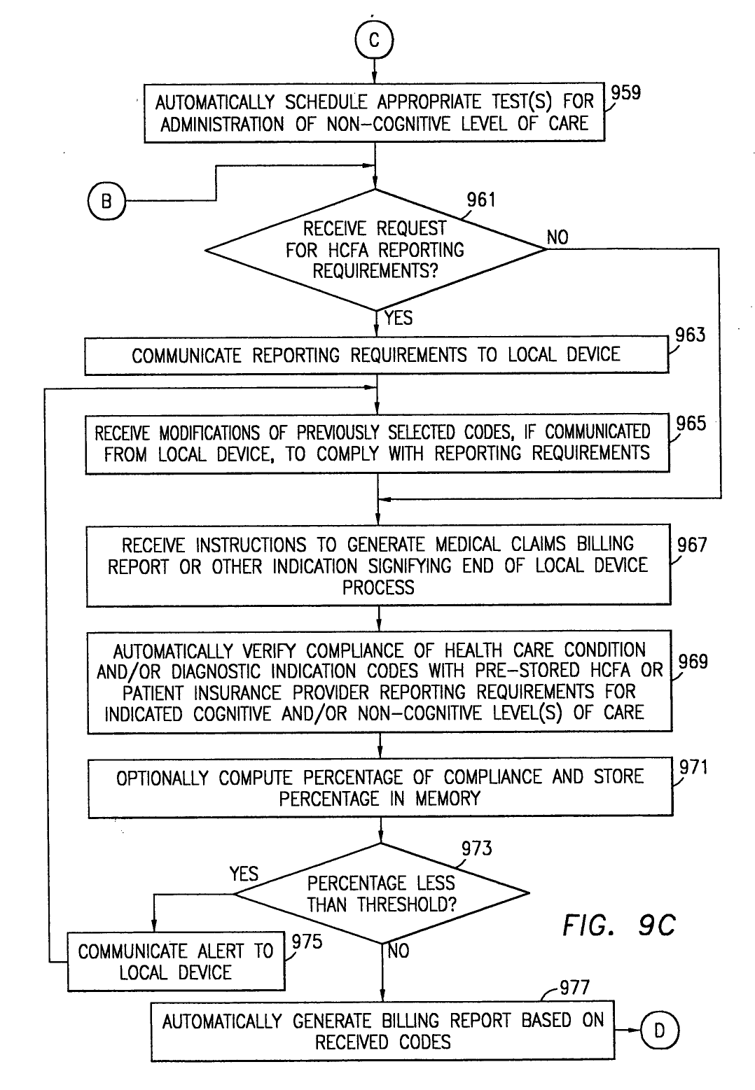

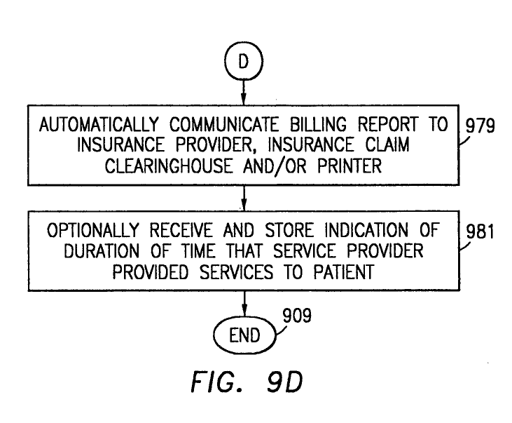

FIGS. 9A-9D are collectively a logic flow diagram 900 of steps executed by a remote processing device 103 to generate a medical claims billing report in accordance with a preferred embodiment of the present invention. The steps 903-981 described below with respect to FIGS. 9A-9D are preferably implemented in software stored in or on a computer-readable media (including, without limitation, computer memory, a floppy disk, a CD-ROM, a DVD, a magnetic tape, a hard disk, or any other kind of volatile or non-volatile memory) accessible by the remote processing device. Accordingly, such computer-readable media includes program code that, when executed, performs the steps 903-981 described below with respect to FIGS. 9A-9D.

The logic flow begins 901 when the remote processing device 103 receives 903 an access request from the local processing device 101, 102 wherein the access request preferably includes an ID of the service provider, a patient ID, optionally a patient group ID, and optionally a password, via computer network 107. That is, when the service provider desires to provide information for use in generating a billing report for services rendered to a patient, the service provider logs on or otherwise accesses a local processing device 101, 102 which is preferably located at or near the location where the services are being rendered, and logs on or otherwise accesses the remote processing device via the computer network 107 in accordance with known techniques. As part of the remote device 103 log-in sequence, the service provider preferably enters his or her own ID, the patient's ID, the group ID of the patient (if applicable), and a provider specific password into the local processing device 101, 102 for subsequent conveyance to the remote device via the computer network

Responsive to receiving the ID and password entries, the local processing device 101, 102 communicates an access request including the received ID(s) and password to the remote-processing device 103. Alternatively, an access request may be received by the remote-processing device 103 that does not include any of the aforementioned IDs or password. In such a case, the remote processing device 103, upon receiving the access request, might respond via the computer network with a request from the local processing device 101, 102 for one or more of the aforementioned IDs or password.

After receiving the IDs and password, the remote processing device 103 determines 905 whether one or more of the IDs are authorized to access the remote processing device 103 and/or a data recording and billing software application stored in a memory of the remote processing device 103 or on some other computer-readable media operably coupled to the remote processing device 103. In a preferred embodiment, the remote-processing device 103 determines whether the service provider's ID and password are authorized to access the data recording and billing software application. Any other provided IDs, if provided, are preferably used to generate the billing report. Alternatively, the remote-processing device 103 may further determine authorization of the patient's ID with respect to the service provider's ID. For example, the remote processing device 103 may search a service provider/ patent relational database to determine if the patient's ID corresponds to the service provider's ID stored in the database, unless the access request or another data message received from the local processing device 101, 102 indicates that the patient is a new patient of the service provider.

In the event that one or more of the IDs and/or password are not authorized to access the remote-processing device, the remote processing device 103 rejects 907 access and the logic flow ends 909. In this case, the remote processing device 103 preferably sends a message back to the local processing device 101, 102 via the computer network informing the local processing device that access to the remote processing device 101, 102 and/or the data recording and billing software application has been rejected. The local processing device 101, 102 would preferably display an “ACCESS DENIED” or equivalent message to the service provider to inform the service provider that access has been rejected and would preferably provide a reason for the access denial, such as invalid ID.

In the event that the service provider is authorized to access the remote processing device 103, the remote processing device 103 provides access 911 to a data recording and billing software application stored in a memory of the remote processing device 103 or on some other computer-readable media coupled to the remote processing device 103. For example, when the service provider's ID is authorized, the remote processing device 103 allows the local processing device 103 to view an entry or other screen of the software application, such as a screen that enables the service provider to select an appropriate medical specialty area in which the services were rendered and for which billing is now necessary.

In addition to providing access to the software application, the remote-processing device 103 receives 913 a request for service codes relating to a cognitive level of care provided to the patient. The request for the cognitive level of care service codes may be separate from the request to access the remote-processing device 103 or may be imbedded in the access request. That is, the access request of step 903 may include appropriate IDs, a password, and a request for communication of the cognitive level of care service codes. Alternatively, the local processing device 101, 102 may submit the request for service codes after being notified that access has been granted to the data recording and billing software application. The cognitive level of care codes are preferably stored in the remote processing device 103 or on a computer-readable media accessible by the remote processing device 103 in such a manner as to allow the cognitive level of care codes to be preferably displayed by the local processing device 101, 102 to the service provider as described above with respect to FIG. 6. After receiving the request for the cognitive level of care codes, the remote-processing device 103 communicates 915 the cognitive level of care codes to the local processing device 101, 102 for display to the service provider.

Some time after communicating the cognitive level of care codes to the local processing device 101, 102, the remote processing device 103 receives 917 selected codes from the local processing device 101, 102 and stores the received codes in memory and/or on a computer-readable media operably coupled to the remote processing device 103. That is, the remote processing device 103 receives the cognitive level of care codes selected by the service provider which correspond to the cognitive level of care services rendered by the service provider to the patient. In a preferred embodiment, the cognitive level of care codes comprise cognitive CPT codes promulgated by HCFA. Alternatively, the cognitive level of care codes may comprise codes promulgated by a third party who is fully or partially responsible for payment for the rendered medical services, such as the patient's insurance provider or some other indemnitor.

In a preferred embodiment, after the selected cognitive level of care codes have been received and stored by the remote-processing device 103, the remote device 103 determines 919 whether a non-cognitive level of care has been recommended for the patient. Such a determination is preferably made through analysis of messages received from the local processing device 103. For example, the remote processing device 103 may determine that a non-cognitive level of care is necessary based on receipt of a message from the local processing device 103 expressly indicating that a non-cognitive level of care has been recommended for the patient. Alternatively, the remote device 103 may determine make such determination based on receiving a request for service codes relating to a non-cognitive level of care in accordance with step 921 of FIG. 9A.

In the event a non-cognitive level of care is recommended for the patient, the remote processing device 103 receives 921 a request 515 for service codes relating to the non-cognitive level of care as described above with reference to FIG. 5A. Such service codes preferably comprise non-cognitive CPT codes promulgated by HCFA or some third party that is at least partially responsible for payment of the rendered medical services. After receiving the request 515 for the non-cognitive level of care service codes, the remote processing device 103 retrieves those codes from memory 143 and communicates 923 the non-cognitive level of care codes to the local processing device for display to the service provider as described above with reference to block 519 of FIG. 5A.

Some time after communicating the non-cognitive level of care codes to the local processing device 101, 102, the remote processing device 103 receives 925 selected non-cognitive level of care codes from the local processing device 103 and stores the selected codes in memory 143 or on a computer-readable media operably coupled to the remote processing device 103. That is, after the service provider has selected the appropriate non-cognitive level of care codes corresponding to the non-cognitive level of care recommended for the patient, the remote processing device 103 receives the selected codes from the local processing device 101, 102 and stores them in memory 143 for future use such as use by a technician, a physician, a nurse, or other service provider staff, who will subsequently administer the non-cognitive level of care.

In addition to receiving the selected non-cognitive level of care codes from the local processing device 101, 102, the remote processing device 103 receives 927 a request for service codes or identifiers relating to the health care condition of the patient and/or diagnostic indications relating to the non-cognitive level of care recommended for the patient. Such a request for service codes or identifiers could be a separate, express request but is preferably implicit in the received selected non-cognitive level of care codes. That is, instead of receiving a separate request for service codes or identifiers relating to the health care condition of the patient and/or diagnostic indications, the remote processing device's 103 receipt of selected non-cognitive level of care codes may serve as an implicate indication that the local processing device 101, 102 desires to receive service codes or identifiers relating to the patient's health care condition and/or diagnostic indications relating to the non-cognitive level of care. Alternatively, the request for service codes or identifiers relating to the health care condition of the patient and/or diagnostic indications may be communicated through communication of selected non-cognitive level of care codes from the local device 101, 102.

After receiving the request for the health care condition and diagnostic indication codes or identifiers, the remote-processing device 103 communicates 929 the requested codes or identifiers to the local processing device for display to the service provider. Some time after communicating the health care condition codes or identifiers to the local processing device 101, 102, the remote processing device 103 determines 931 whether the health care condition codes that were sent adequately relate to the health care condition of the patient. Such a determination is preferably made by analyzing the type of message received from the local processing device 103 after communication of the health care condition and diagnostic indication codes. In the event that the health care condition codes adequately relate to the health care condition of the patient, the remote-processing device receives (933) selected health care condition codes or identifiers from the local processing device. That is, if the health care condition codes (e.g., ICD-9 codes and descriptions) communicated to the local processing device are adequate in the opinion of the service provider to define the health care condition of the patient, the remote processing device 103 receives one or more selected health care condition codes from the local processing device 101, 102 that correspond to the service provider's interpretation of the health care condition of the patient. The remote processing device 103 stores 935 the received health care condition code(s) or identifier(s) in its memory or on a computer-readable media that is operably coupled to the remote processing device 103.

In the event that the health care condition codes or identifiers do not adequately relate to the health care condition of the patient, the remote processing device receives 937 a request for a template in which the service provider can enter appropriate information which complies with the advance beneficiary notice (ABN) requirements of the federal government. After receiving the request for the ABN template, the remote-processing device communicates 939 the template to the local processing device 101, 102 for display to the service provider. Some time after communicating the template, the remote processing device 103 receives (941) a completed template from the local processing device and stores (943) the template entries in memory or on some other computer-readable media coupled to the remote processing device 103. Thus, the present invention accounts for circumstances in which the health care condition codes and descriptions (e.g., the ICD-9 codes and descriptions promulgated by HCFA) do not relate to certain (possibly rare) health care conditions. Consequently, the present invention provides for the communication of an ABN template to the local processing device for use by the service provider to enter the details relating to the patient's health care condition. In a preferred embodiment, the local processing device 101, 102 and/or remote processing device 103 software accommodates entry of the patient's electronic signature on the ABN template to provide evidence that the patient was notified that his or her insurance might not cover service fees and/or costs related to the patient's diagnosed health care condition.

In addition to determining whether the health care condition codes or identifiers adequately relate to the health care condition of the patient, the remote processing device 103 also determines 945 whether the diagnostic indication codes or identifiers adequately relate to and/or characterize the non-cognitive level of care recommended for the patient. Similar to the determination of step 931, the determination in step 945 is preferably based on what is received from the local processing device 103. When the diagnostic indication codes or identifiers adequately relate to and/or characterize the non-cognitive level of care, the remote processing device 103 receives 947 selected diagnostic indication codes or identifiers and stores the received codes or identifiers in memory or on another computer-readable media operably coupled to the remote processing device. On the other hand, when the diagnostic indication codes do not adequately relate to and/or characterize the non-cognitive level of care recommended for the patient, the remote processing device 103 receives 951 a request for an ABN template for entering unique diagnostic indications related to the recommended non-cognitive level of care. The ABN template received in step 951 may be the same template as discussed above with respect to step 937. Alternatively, separate ABN templates may be used to facilitate entry of the patient's health care condition description and the description of any unique diagnostic indications.

After receiving the request for the ABN template, the remote-processing device 103 communicates 953 the template to the local processing device 101, 102 for display to the service provider. Some time after communicating the template, the remote processing device 103 receives 955 a completed template from the local processing device 101, 102 and stores 957 the template entries in memory or on some other computer-readable media coupled to the remote processing device 103. Thus, the present invention accounts for circumstances in which the diagnostic indication codes that are acceptable to the patient's insurer do not relate to every possible diagnostic indication that could be the basis for a proposed non-cognitive level of care. Consequently, the present invention provides for the communication of an ABN template to the local processing device for use by the service provider to enter additional diagnostic indications that may not be approved by the patient's insurer. In a preferred embodiment, the local processing device 101, 102 and/or remote processing device 103 software accommodates entry of the patient's electronic signature on the ABN template to provide evidence that the patient was notified that his or her insurance might not cover service fees and/or costs related to administration of the recommended non-cognitive level which was premised on the diagnostic indication(s) recited on the ABN template.

If the remote processing device 103 receives service codes indicating that a non-cognitive level of care has been recommended, the remote device 103 optionally automatically communicates with a scheduling computer at the location where the non-cognitive services will be performed and schedules 959 the appropriate test(s) or procedure(s) necessary to administer the recommended or ordered care. To account for the patient's possible refusal of receiving the recommended care, the remote processing device 103 software may facilitate an entry by the service provider to indicate such refusal. In the event of receiving an indication that care has been refused, no automatic scheduling is performed.

After receiving the entered service codes, which as discussed above at least includes one or more cognitive level of care codes and might further include non-cognitive level of care codes, health care condition codes, and diagnostic indication codes, the remote processing device 103 determines 961 whether it received a request for HCFA or insurer-specific reporting requirements. That is, the remote-processing device 103 determines whether the service provider desires to manually verify compliance of his or her code entries with the pre-stored reporting requirements. The request for reporting requirements might alternatively be received prior to or during entry of the codes; accordingly, the determination of step 961 may occur at any time prior to generation of the billing report, even before the remote device receives any code entries.

In the event that the remote-processing device 103 has received a request for HCFA or insurer-specific reporting requirements, the remote device 103 communicates 963 the reporting requirements to the local processing device 101, 102 for viewing by the service provider. Some time after communicating the reporting requirements, the remote processing device 103 receives 965 code modifications, including code deletions and code additions (e.g., re-entered codes or new codes), to comply with the reporting requirements if the service provider determines that the previously entered or selected codes do not comply with the reporting requirements. Prior to receiving such new or modified codes for compliance purposes, the remote processing device 103 might also receive new requests for cognitive level of care codes, non-cognitive level of care codes, health care condition codes, and/or diagnostic indication codes. For example, in the event that a cognitive level of care code does not comply with an HCFA requirement for the corresponding cognitive level of care (e.g., level of office visit), the remote processing device 103 might receive a request for the cognitive level of care codes to be sent to the local processing device 101, 102 so that the service provider may re-review the cognitive level of care codes to select the appropriate code in view of the HCFA reporting requirements. Thus, as described above, the remote processing device 101, 102 software application allows the service provider to manually verify compliance of the previously entered service codes or identifiers with HCFA reporting requirements and, in the event that any previously entered codes or identifiers are not in compliance, permits the service provider to modify or change the codes to ensure compliance.

Compliance with HCFA reporting requirements is particularly important for insurance claims or billing reports to be submitted to Medicare or Medicaid for payment by the federal government. Failure to comply with HCFA reporting requirements result in claim refusals or returns and substantial delays in receipt of payment for services rendered to Medicare or Medicaid patients. To reduce the likelihood of such payment delays, the present invention permits the service provider to request the HCFA or any other insurer-specific reporting requirements from the remote processing device 103 in order to perform a manual compliance verification prior to submitting the medical claims billing report to the insurance provider, such as Medicare or Medicaid. Although the HCFA reporting requirements are available in book form, the process of reading through the book or books to verify compliance of selected CPT, ICD-9 and diagnostic indication codes or identifiers, particularly when both cognitive and non-cognitive levels of care are at issue, can be particularly tedious and error-prone. By contrast, the present invention provides a much less tedious, automated approach to manually verifying compliance with HCFA reporting requirements (typically referred to as “bullets”) by, for example, displaying only the reporting requirements that relate to the entered cognitive and non-cognitive codes responsive to the service provider's request for the reporting requirements. Once the appropriate reporting requirements are displayed, the service provider can readily compare the requirements to the selected health care condition codes (ICD-9 codes) and diagnostic indication codes to verify that the selected health care condition and diagnostic indication codes correctly relate to the selected non-cognitive level of care code.

In the event that a cognitive level of care code or a non-cognitive level of care code is in error, the reporting requirements communicated to and displayed by the local processing device 101, 102 for the errant code will not correspond to the respective level of care and the service provider will quickly be able to determine that the wrong code has been entered. In addition, if the correct cognitive level of care and non-cognitive level of care codes have been entered or selected by the service provider, but an incorrect diagnostic indication code or health care condition code has been selected by the service provider, the service provider will quickly be able to determine such error by viewing the reporting requirements associated with the selected non-cognitive level of care code.

In the event that the remote processing device 103 has not received a request for HCFA or insurer-specific reporting requirements or has received such a request and the service provider has completed his review of the reporting requirements and modified or re-entered appropriate service codes or identifiers, the remote processing device 103 preferably receives 967 instructions to generate a medical claims billing report or receives some other indication signifying the end of the local processing device's process. That is, in a preferred embodiment, the service provider, upon completing his or her entry of service codes or identifiers and, if desired, review of HCFA or insurer-specific reporting requirements, instructs the remote processing device 103 to generate the medical claims billing report based on the entered information or optionally simply selects an end of process button with a mouse or other user interface of the local processing device 101, 102 to signify to the remote processing device that the service provider has completed entering all the information that the service provider believes is necessary to generate the billing report.

In a preferred embodiment, after receiving such instruction or indication, the remote processing device 103 automatically verifies 969 compliance of the selected health care condition and/or diagnostic indication codes or identifiers with the pre-stored HCFA or insurer-specific reporting requirements associated with the selected cognitive and/or non-cognitive levels of care. That is, in a preferred embodiment, the remote-processing device 103 automatically verifies compliance with HCFA or insurer-specific reporting requirements prior to generating the medical claims billing report. This is readily implemented by using conditional logic statements to test for compliance and to correct any non-compliant results before they are archived or used to populate any medical billing reports or medical procedure reports. The auto-compliance routine executed by the remote processing device in accordance with step 969 reduces the likelihood that a medical claims billing report will be submitted to an insurance provider without complying with that insurance provider's reporting requirements. Such automatic compliance verification increases the likelihood that the medical claims billing report generated based on the entered or selected service codes will be favorably processed by the patient's insurance provider and, thereby, reduces the likelihood that the submitted insurance claim will be rejected or denied due to non-compliance with insurer reporting requirements. Increasing the likelihood of compliance with insurer reporting requirements accordingly increases the likelihood that the service provider will receive payment from the patient's insurance provider in a timely manner.

After or during execution of the auto-compliance procedure, the remote processing device 103 may optionally compute 971 the percentage of compliance of the health care condition and/or diagnostic indication codes and store the percentage in memory or on another computer-readable media operably coupled to the remote processing device. In the event that the remote processing device 103 computes the percentage of compliance, the remote processing device 103 preferably compares 973 the computed percentage with a programmed threshold value and in the event that the percentage of compliance is less than the threshold (e.g., less than 95% compliant), the remote processing device 103 preferably communicates 975 an alert to the local processing device 101, 102 to inform the service provider that any medical claims billing report generated based on the selected health care condition and/or diagnostic indication codes will not satisfactorily comply with the reporting requirements of the patient's insurance provider and, thereby, will likely result in a denial of the submitted insurance claim. The communication of the alert gives the service provider an early opportunity to modify or re-enter the health care condition and/or diagnostic indication codes prior to initial generation of the insurance claim form at a time when the correct information is fresh in their minds, thereby providing the service provider with an opportunity to efficiently correct a mistake that could result in a substantial delay in receiving payment from the patient's insurance provider.

Although electronic filing of medical insurance claims are currently conducted, no prior art software of which applicant is aware facilitates such electronic filing also provides an auto-compliance routine to verify compliance of the claim with respect to the particular insurance provider's reporting requirements prior to initial generation of the insurance claim form. In the prior art, electronic filing of an insurance claim form may eliminate payment delays introduced due to mailing the claim form, but does little, if anything to substantially increase the likelihood that the submitted claim will be satisfactorily processed and paid by the insurance provider. By contrast, the present invention provides an auto-compliance program to check compliance of the entered health care condition and diagnostic indication codes with the reporting requirements for the associated non-cognitive level of care, and alerts the service provider in the event that compliance with the reporting requirements is insufficient to provide a substantial likelihood that an insurance claim submitted based upon the entered codes will be in proper condition for expedient payment by the insurance provider.

In the event that the percentage of compliance is greater than or equal to the threshold (i.e., the percentage of compliance will likely result in satisfactory processing of the medical claims billing report to be generated based upon the entered or selected health care condition and/or diagnostic indication codes), the remote processing device 103 automatically generates 977 a medical claims billing report based on the entered cognitive level of care codes, non-cognitive level of care codes, health care condition codes and/or diagnostic indication codes. The medical claims billing report preferably comprises a HCA 1500 form (insurance claim form) that is conventionally used to submit an insurance claim for medical services. Upon generating the medial claims billing report, the remote processing device 103 preferably automatically communicates 979 the billing report to the patient's insurance provider, an insurance claim clearinghouse and/or a printer coupled to the computer network 107. As described above, the computer network 107 preferably comprises a wide area or global computer network, such as the Internet. In the event that the insurance provider and/or the insurance claim clearinghouse has a processing device 104 or 105 coupled to the network, and running appropriate software to receive electronic insurance claim forms, the remote processing device 103 preferably conveys the medical claims billing report (insurance claim form) as a data file via network 107 directly to the insurance provider or the insurance claim clearinghouse.

Alternatively, the remote-processing device 103 might communicate the billing report via a facsimile device operated by the insurance provider and/or the insurance claim clearinghouse. In this case, the remote-processing device 103 preferably utilizes a conventional facsimile program and a facsimile modem to communicate the billing report to the facsimile machine or modem of the insurance provider or the insurance claim clearinghouse.

In the event that the insurance provider, the service provider or the patient requires a paper copy of the insurance claim form, the remote processing device 103 preferably communicates the billing report to a printer 133 coupled to the computer network 107. The printer 133 may be located at the location where the services are being rendered to the patient or may be located at some other point or node on the network, such as a printer located at the insurance provider's place of business, the service provider's place of business, or the patient's home.

In the event that the service provider is required, by law or otherwise, to report the number of minutes the service provider has spent per year with group patients versus non-group patients, the remote processing device 103 optionally receives and stores 981 an indication of the duration of time that the service provider rendered service to the patient, and the logic flow ends 909. As discussed above, the local processing device 103 at which the service provider is entering or selecting the service codes preferably records the duration of time that the services are being rendered to the patient. The local processing device 103 may store the duration of time itself or, as in step 981 of FIG. 9D, may communicate the duration of time to the remote processing device 103 for storage (e.g., in the event that the memory capability at the remote processing device 103 is substantially greater than the memory capability of the local processing device 103 or in the event that access to the time duration information may be required by other entities, such as the federal government or a professional association, such as the American Medical Association).

In a preferred embodiment, all the steps recited above with respect to FIGS. 9A-9D are preferably executed substantially during the time period services are being rendered to the patient. In addition, access to the remote processing device 103, entry or selection of service codes, automatic reporting requirement compliance verification, and submission of the insurance claim form to the appropriate facility (either the insurance provider or an insurance claim clearinghouse) preferably occurs in less than about 22 to 30 seconds. Thus, the present invention facilities rapid, accurate submission of insurance claims by the single operator who is the most knowledgeable about the relationship of the service codes to the actual services rendered to the patient.

The present invention enables a service provider himself or herself to accurately provide the information necessary to generate the medical claims billing report without requiring a substantial amount of the service provider's time. In this manner, the present invention mitigates claim form errors commonly introduced through inaccurate coding of the service provider's hand-written or transcribed notes because the service provider is preferably the person accessing the remote processing device and providing the service code information necessary to facilitate generation of the billing report.

FIG. 10 is a logic flow diagram 1000 of steps executed by a remote-processing device 103 to generate a medical procedure report in accordance with a preferred embodiment of the present invention. The steps 1003-1019 described below with respect to FIG. 10 are preferably implemented in software stored in or on a computer-readable media (including, without limitation, computer memory, a floppy disk, a CD-ROM, a DVD, a magnetic tape, a hard disk, or any other kind of volatile or non-volatile memory) accessible by the remote processing device 103. Accordingly, such computer-readable media includes program code that, when executed, performs the steps 1003-1019 described below with respect to FIG. 10.

The logic flow begins 1001 when the remote-processing device 103 receives 1003 an access request and at least a service provider's ID from the local processing device 101, 102 via the computer network 107. In a preferred embodiment, the access request or an additional data message received subsequent to the access request includes the patient's ID, a group ID for the patient (if applicable), and a password. As discussed above, the access request itself may alternatively include the aforementioned IDs. After receiving the ID(s), the remote processing device 103 determines 1005 whether at least the service provider's ID and/or password is authorized to access the remote processing device 103 and the data recording and billing software application stored in a memory of the remote processing device 103 or on another computer-readable media operably coupled to the remote processing device 103. If the service provider's ID and/or password is not authorized or if other predetermined security conditions are not satisfied, the remote processing device 103 rejects 1007 access to its software application, and the logic flow ends 1009. As discussed above, the remote processing device 103 preferably communicates a denial of access message to the local processing device 101, 102 via the computer network 107 for display to the service provider to inform the service provider that access to the data recording and billing software application of the remote processing device has been denied.

In the event that at least the service provider's ID and any other IDs or other preconditions necessary for access to the data recording and billing software application are recognized by the remote processing device 103 (e.g., upon comparing such ID or IDs to a database of approved IDs), the remote processing device 103 receives 1011 a request for one or more non-cognitive level of care identifiers and/or diagnostic indication identifiers from the local processing device. Such a request may be part of the access request received in step 1003 or such request may be a separate request received from the local processing device 101, 102 subsequent to informing the local processing device 101, 102 that access to the data recording and billing software application has been granted. In other words, when the patient sees a particular health care provider for administration of a clinical test or other operatory procedure constituting a previously ordered or recommended non-cognitive level of care, the health care provider uses a local processing device 101, 102 to access the remote processing device 103 and retrieve the previously stored non-cognitive level of care code(s) and description(s), and any associated diagnostic indications, prior to commencing administration of the non-cognitive level of care to insure that the correct care is provided to the patient.

Responsive to receiving the request for the non-cognitive level of care identifiers and descriptions and/or the diagnostic indication identifiers and descriptions from the local processing device 101, 102, the remote processing device 103 communicates 1013 the requested identifiers or codes and descriptions to the local processing device 101, 102 via the computer network. Some time after communicating the requested identifiers or codes to the local processing device, the remote processing device 103 receives 1015 information resulting from administration of the non-cognitive level of care at least upon completion of such care. That is, the remote-processing device 103 receives the test results or operatory procedure results or summaries generated during or after administration of the non-cognitive level of care. In a preferred embodiment, the remote-processing device 103 receives the test information or operatory procedure information as the test or procedure is being performed. Alternatively, the local processing device 101, 102 may accumulate and store the test information and provide the complete test or procedure information to the remote-processing device 103 upon completion of the test or procedure.

Upon receiving the test or procedure information from the local processing device 101, 102, the remote processing device 103 generates and stores 1017 a medical procedure report that incorporates the received information. The medical procedure report preferably complies with any reporting requirements imposed by the patient's insurance provider. Thus, the remote-processing device formats the received test or procedure information into a medical procedure report format required by the patient's insurance provider. The memory of the remote processing device 103 or another computer-readable media operably coupled to the remote processing device 103 is preferably loaded with the medical procedure reporting and format requirements of the patient's insurance provider at some time prior to administration of the non-cognitive level of care.

The remote-processing device 103 communicates 1019 the completed medical procedure report to the patient's insurance provider, an insurance claim clearinghouse and/or a printer, and the logic flow ends 1009. Communication of the report to the insurance provider or the insurance claim clearinghouse preferably occurs electronically either via the computer network 107, if the insurance provider and/or the insurance claim clearinghouse includes a processing device 105 coupled to the computer network 107, or via a facsimile transmission to a facsimile device operated by the insurance provider and/or the insurance claim clearinghouse. In the event that a printout of the report is desired by the service provider, the patient or the insurance provider, the remote processing device 103 electronically communicates the completed medical procedure report to a printer coupled to the network in accordance with known printing techniques.

Using the invention, a single operator can rapidly select service-related identifiers substantially contemporaneous with the service to facilitate generation of a billing report or invoice for the services by a remotely located computer or server. Thus, in contrast to prior art medical billing approaches which typically require billing staff to arrive at the appropriate billing codes based subjective interpretation on a physician's notes or transcribed dictation, the present invention enables the health care provider himself or herself to select the appropriate billing codes for rendered services from lists of codes that have been approved by the patient's insurer and/or the federal government. Through its preferred presentation of at least some of the identifiers or service codes (e.g., cognitive CPT codes for medical services), the present invention enables the service provider to make billing code selections rapidly (e.g., in less than about 22 to 30 seconds) to mitigate the amount of time that the service provider must concern himself or herself with billing formalities. Further, the present invention facilitates electronic generation and submission of both insurance claim forms and medical procedure reports in support of invoiced services. Still further, the present invention provides a wireless communication device 161 that may be used as either the local processing device 101, 102 or an interface to the local processing device 101, 102 to allow the service provider to access the remote processing device 103 and enter billing code information regardless of where the services are rendered.

As described thus far, with reference to FIGS. 5 and 9, remote processing device 103 and local processing devices 101, 102 (including any wireless communications device(s) 161 which may comprise either or both local processing devices 101, 102) are programmed to operate together to facilitate the display to the user and selection by the user of cognitive and non-cognitive level of care codes and associated descriptions which are used by system 100 to populate appropriate fields of a medical claims billing report and/or medical procedure report.

As will now be described with additional reference to FIGS. 11 and 12, the selection of the appropriate cognitive and non-cognitive level of care codes used to populate a report such as a medical billing report and/or medical procedure report, may also be carried out in an even more highly automated manner with the aid of a graphical user interface 1100.

In a preferred form, such graphical user interface 1100 comprises a pictorial or graphical representation 1104 of all, or at least a portion, of the object of the services rendered. As used herein and in the claims, the term “graphical representation” means any two or three-dimensional pictorial or graphical picture, schematic, diagram or other non-verbal or multimedia representation. Graphical representation 1104 is presented to the service provider based on information previously stored in the memory 143 of remote processing device 103 and/or on machine readable media 137. As with other illustrated menu driven services, an appropriate graphical representation may be determined in part upon the previously selected context and procedural type information, but may optionally be changed by the attending physician as desired. Thus, if an originally scheduled office visit is not rescheduled at a facility capable of more advanced procedures (with more detailed inputs), means can be provided through the demographic modification window to trigger retrieval of the additional information applicable to the different site. Further, while FIG. 11 only illustrates one particular type of graphical representation, any organ or system in the human body is amenable to one or more graphical representations usable in connection with the present embodiment. Thus, instead of the arterial system, one could readily display upper or lower GI representations, or multisystem information e.g., for broader exploratory work.

Through the use of a user input device associated with local processing device 101, 102, such as a touchscreen, mouse, trackball, thumbwheel, light pen or other pointing device capable of pointing to, highlighting, scrolling to or otherwise selecting, one or more of a plurality of particular points on or regions 1107 of the graphical representation 1104 can be selected by a user to indicate the nature and/or status of a particular service or aspect of a service rendered. Alternatively, but less desirably, a keyboard or keypad or voice-responsive routine associated with the local processing device 101, 102 could be provided and used to make such selections.

In addition to the aforementioned pictorial or graphical representation 1104 of at least a portion of the object of the services, graphical user interface 1100 may also include one or more fields 1110, 1111 in which alphanumeric information 1115 such as headings, labels, menus and/or textual instructions and/or prompts to guide the service provider or other user through the data entry process can be displayed.

The nature of the pictorial or graphic representation 1104 of the object of the services will vary from one field of use of the invention to another, depending on the nature of the object of particular services to be billed. In more abstract, symbolic or representational systems (e.g., in computer or biologic networks) alternate representations 1104 or other relational techniques may be employed, and a skilled artisan will appreciate numerous and varied approaches may be adopted in lieu of the illustrated two dimensional graphic. Graphical representation 1104 may optionally be further labeled, e.g., with part numbers and/or repair or service codes to identify with required particularity as required by a particular application parts or systems repaired, replaced or serviced by the service provider.

In the health care field, the object of services rendered by a physician or other health care provider is generally the body of a human. Accordingly, in the health care field, the pictorial or graphical representation 1104 would typically represent the all or part of the human body or one of the constituent parts or systems of the body. As indicated by the heading appearing in field 1111, FIG. 11 shows, by way of a particular example, a pictorial or graphic representation 1104 of the human arterial system which can be used to facilitate display and selection of non-cognitive care codes, including any appropriate modifier codes, indicating particular services, such as angiography procedures, ordered to be preformed on a particular patient and/or actually performed on the patient. Such services may be billed by generating a correct medical billing report and/or documented by generating a corresponding medical procedure report in a manner as will now be described in further detail with reference to FIGS. 11 and 12 as well as reference once more to FIGS. 1, 5 and 9.

In accordance with this aspect of the invention, one or more pictorial or graphic representations 1104 and any and all associated headers, prompts, labels and/or other alphanumeric information 115 are retrievably stored in the memory 143 and/or computer readable media or other means accessible for use by remote processing device 103. Optionally included among the information stored are menus of titles or other identifiers of each available graphical representation 1104. By means of the software application running on local processing device 101, 102 the physician or other user enters a selection which communicates a request to the remote processing device 103 for a particular graphical representation 1104 appropriate to the particular services rendered or to be rendered. Such request may be made for example by selecting a displayed entry such as “peripheral angiography” from a menu or the last of a series of successively more specific menus displayed within field 1110 which guide the user, in a logical manner, to a particular graphical representation 1104.

Remote processing device 103 receives such requests from the local processing devices 101, 102 and retrieves from memory 143 and/or media 137 the appropriate graphical representation 1104 as well as any menus and/or user prompts and any and all other alphanumeric information associated with that particular graphic representation 1104. The local processing device 101, 102 receives this information and displays to the user, graphical user interface 1100, including graphical representation 1104 and all associated alphanumeric fields 1110, 1111 on a monitor, screen, touchscreen or any other suitable visual display associated with a user interface of local processing device 101, 102 and/or display 179 of any wireless communication device 161 associated therewith. In a particularly preferred embodiment, local processing device 101, 102 comprises a wireless communication device 161. Such enables a physician or other user to view the displayed graphical user interface 1100 and also enter selections and/or other commands from virtually any physical location within communication range of transceiver 173 including, without limitation from the actual location of the patient at the time the user is actually examining, performing a procedure upon or otherwise attending the patient. Preferably wireless communication device 161 has a user interface 177 and display 179 which are combined in the form of a touch sensitive screen (touchscreen) which permits the user to view graphical user interface 1100 and also make data entry selections by touching corresponding regions 1107 of graphic representation 1104 and communicate the selection to remote processing device 103. The programming of the system 100 and its operation in connection with graphical user interface 1100 will now be described in further detail with additional reference to FIG. 12.

In operation, a particular graphical representation 1104 is retrieved from memory 143 of remote processing device 143 and is displayed 1200 on user interface 1100 of local processing device 101, 102. As described above, displaying step 1200 is optionally initiated in response to the user making a selection from a menu displayed within alphanumeric field 1111 or 1110. Without further action on the part of the user, a suitable first prompt may optionally be displayed 1202 to the user within field 1110 to instruct the user on the next action to be taken. For example, as FIG. 11 illustrates, a suitable first prompt for an angioplasty procedure may read: “select entry location”. In response to the first prompt, the physician or other user uses the touchscreen or other input device as described above to select 1205 a particular one of the points 1107 associated with graphical representation 1104 indicating the location at which the catheter or other medical device was or was to be initially inserted by the physician. Data indicative of the entry location corresponding to the selection is then either stored temporarily within local processing device 101, 102 or is immediately communicated to remote processing device 103 and stored in memory 143 for subsequent processing as will be described. Optionally, but preferably, selection of the entry location by the user initiates the display 1210 within field 1110 of a second prompt such as “select most distal location”. In response, the user uses the touchscreen or other input device to select 1213 a second point 1107 on graphical representation 1104. In the case of an angioplasty procedure, this second point, referred to hereinafter as the “primary location”, corresponds to the most distal (from the entry location) location in the arterial system at which some type of procedure was, or is to be preformed. Data corresponding to the primary location is stored temporarily within local processing device 101, 102 or is communicated promptly to the remote-processing device 103 for storage in memory 143. A third prompt is then optionally displayed 1217 on field 1110 together with a menu retrieved from memory 143 or the memory of the local processing device 101, 102. The third prompt, a message such as: “select procedure type/extent” appears above the menu. The menu comprises a list of possible selections for the type of procedure and its extent. Using the touchscreen or other user input device associated with the remote-processing device in the manner described above the user selects 1220 appropriate entries of procedure type and extent from one or more such menus. Corresponding data are then stored as described above.

Subsequently, an appropriate next prompt is optionally displayed 1224 within field 1110. By selecting the corresponding point 1107 on graphical representation 1104, the user selects 1177 any secondary location(s) (i.e. locations intermediate the entry location and the primary location), if any, at which another procedure was or is to be performed and, from one or more menus displayed within field 1110, selects 1230 the type and extent of the procedure performed or to be performed. Data corresponding to each selection is stored either locally or in memory 143 and, in response to a prompt displayed per a decision step 1235, the prompting and selection steps 1224 through 1230 and storage of the corresponding data are repeated for any and all additional secondary locations and/or procedures. This completes the entry of all data necessary to enable all CPT codes associated with the selections made by the user to be determined by the software running on local processing device 101, 102 and/or remote processing device 103. All appropriate CPT codes are then determined by the system 100 without necessity of further user intervention as will now be described. Where, as is the case with some medical procedures, the same distal location may be classified differently depending upon more proximal procedure points, this embodiment provides an automated approach to capturing and verifying the correct information. For example, if the most distal location of the catheter was the left external carotid, two different codes 36216 and 36217 are designated for use depending on whether the patient had normal or abnormal anatomy. By capturing intermediate points in the progress of the catheter, this would already have been captured as the catheter alternately progressed through the aorta either directly to the left common carotid (36215) or via the innominate artery (36215), as in abnormal anatomy. As data is entered, e.g., as the catheter progresses, the software may automatically update or correct previously indicated codes as information is updated (e.g., reflecting abnormal as opposed to normal anatomy at a given anatomical location).

As indicated at step 1250 one or more databases are accessed after selection steps 1205, 1213, 1220, 1227 and 1230 have been completed and the data corresponding to each respective section stored in memory. While such database(s) may be resident in memory associated with local processing device 101, 102 it or they will more typically be resident in memory 143. Accordingly, the remaining steps to be described with reference to FIG. 12 are preferably executed mainly if not entirely by remote processing device 103 once the data corresponding to selections 1205, 1213, 1220, 1227 and 1230 have been communicated to remote processing device 103 from local processing device 101, 102 and stored in memory 143.

Whether a single database or multiple databases are used is optional. Likewise, the particular data structure(s) employed in the database(s) are matters of design choice. As indicated at step 1255, the program determines each catheter placement CPT code. This is readily carried out by looking up within the database(s) each such code based on the stored data indicating the entry and primary locations entered at steps 1205 and 1213, respectively. This look up operation is performed using stored table which contains the complete domain of combinations of each entry location and primary location permissible under the applicable billing rules currently in effect at a given time and the catheter placement CPT code in effect for each entry location/primary location pair. In the event one or more secondary locations were selected by the user, the stored data representing each secondary location is used in the same manner to determine, preferably again using a look up table in which such codes are uniquely specified by the stored data indicating the entry location and the secondary location, each corresponding catheter placement CPT code.

As indicated at step 1258, any and all interventional CPT codes are determined based on the stored data indicating the locations selected in steps 1213 and 1217 and the stored data indicating the procedure type selected in steps 1220 and 1230 for each respective location. Because each interventional CPT code is fully specified by the location and procedure type, determination of these codes is also readily carried out using a simple look up table stored in the database(s) referred to above. This table contains the complete domain of location/procedure type combinations and each row in the table is uniquely identified by the stored data indicating the type of procedure performed (e.g. angioplasty, stunt, angiography, etc.) and the stored data indicating the primary or secondary location at which each respective procedure was performed or is to be performed.

CPT codes for radiological procedures are known as Supervision and Interpretation (S&I) CPT codes. As indicated at step 1260, these are determined based on the stored data indicating the location and extent of each radiological procedure performed or to be performed. This determination also can readily be carried out using a stored look up table containing the complete domain of all combinations of locations and extents allowed under the applicable HCFA, AMA, third party payor or other billing rules. Each row in the table contains an S&I CPT code which is uniquely specified by the stored data indicating the primary location and each secondary location at which some type of radiological procedure was performed (e.g. injection of a radiological contrast agent) and the stored data indicating extent of the procedure performed or to be performed at each respective location. It will be appreciated that the billing rules on which each of the tables discussed above are based may be subject to change from time to time. It is important therefore that the tables be updated as required to reflect such changes in order to maintain proper operation.

Once they have been determined any and all catheter placement CPT codes, interventional CPT codes and/or S&I codes can be stored in memory 143. If desired, the stored codes can then be used immediately or at a later time to populate the appropriate fields of a stored electronic template for a medical billing report and/or a medical procedure report as indicated at step 1268. Such step can be carried out by remote processing device 103, local processing device 101, 102 or any combination of those devices. If desired, these CPT codes can also by communicated by remote processing device 103 to local processing device 101, 102 and displayed to the user for informational purposes and/or for user confirmation.

Rather than carrying out step 1268 directly after completion of any or all of steps 1255, 1258 and/or 1260, it is preferable but optional to further verify compliance with applicable billing and reporting requirements by first verifying compliance as indicated at step 1264. This may readily be performed in the same manner described above in connection with step 969 of FIG. 9. Although the determination steps 1255, 1258 and 1260 will result in determination of correct identifiers with a high degree of reliability, it may be the case that applicable billing and reporting requirements may disallow certain combinations of identifiers or impose special requirements in certain instances. For example, under the Correct Coding Initiative, it may be illegal to “bundle” or enter a narrow code for puncturing an artery if a global code was previously used, and the DRBA software is preferably configured to warn and/or automatically correct such an erroneous entry. Any errors which might otherwise be caused by overlooking such exceptional cases are corrected by step 1264 which may be implemented by programming conditional logic statements to recognize such exceptions and correct them as required by the applicable billing and reporting rules.

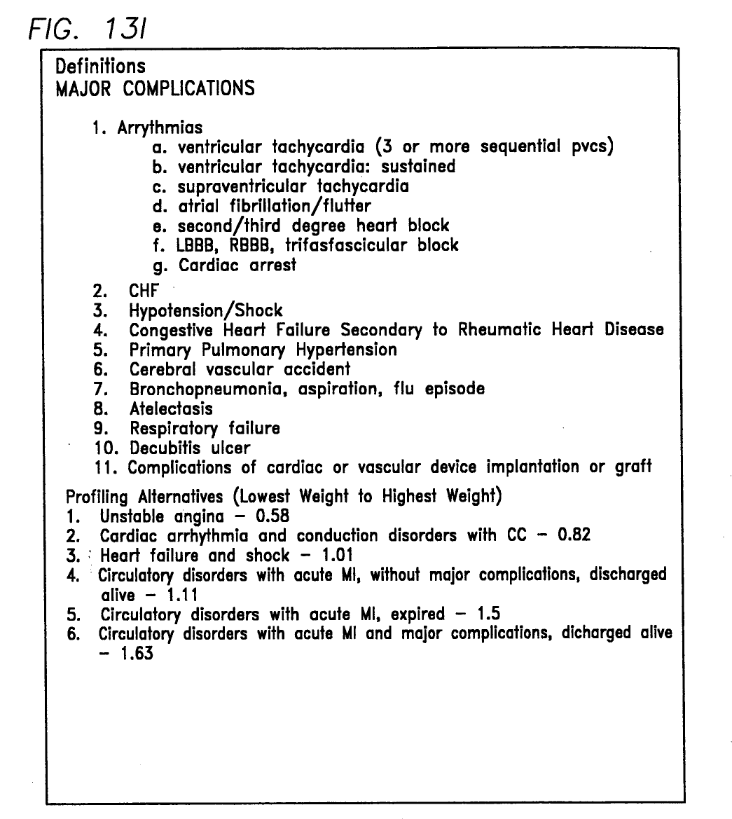

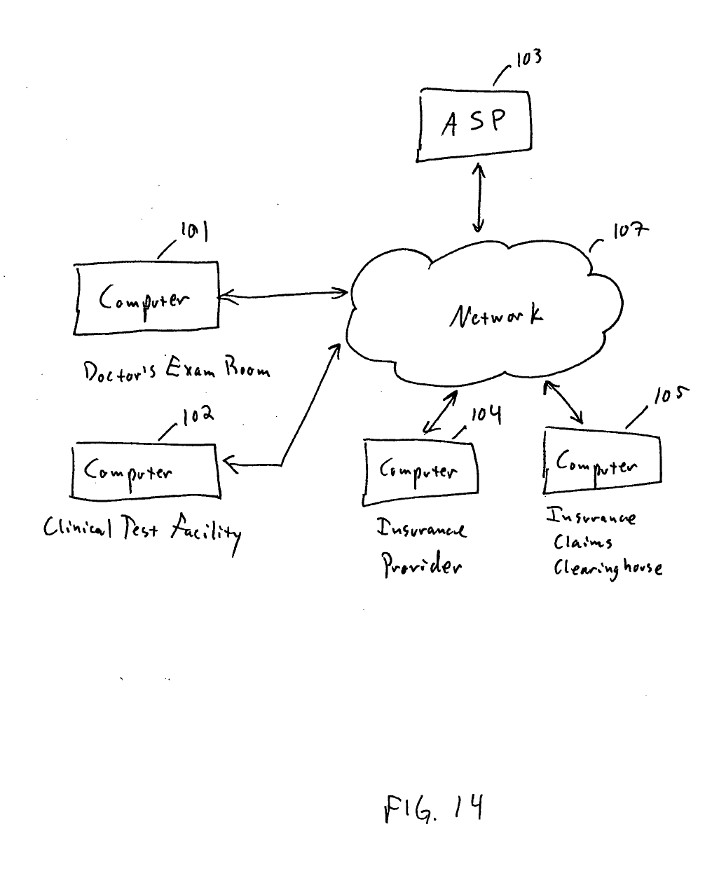

FIG. 14 is a block diagram depicting a high-level architecture of the personal medical web site component of one embodiment of the present invention. FIG. 14 shows computer 101, located in a doctor's office, and computer 102, located in a clinical test facility, both connected to a network 107. Computers 101, 102 and their relative functions, as well as network 107, are described in greater detail with reference to FIG. 2 and other figures above. FIG. 14 further shows computer 104, associated with an insurance provider, and computer 105, associated with an insurance claims clearinghouse, also both connected to a network 107. Computers 104, 105 and their relative functions are described in greater detail with reference to FIG. 2 and other figures above.

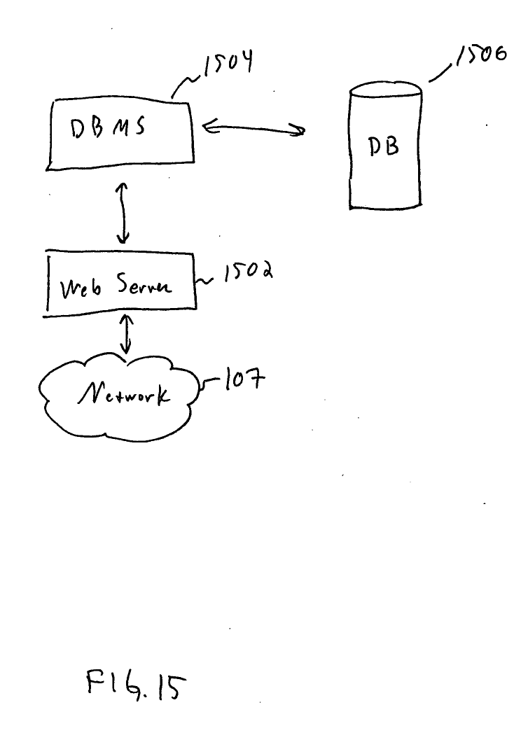

FIG. 14 further shows an Application Service Provider (ASP) 103 connected to the network 107. ASP 103 provides functions related to receiving, storing, modifying, retrieving and transmitting and maintaining information related to medical services rendered, billing, medical treatment, medical claims and continuing medical education. The architecture of ASP 103 is described in greater detail with reference to FIG. 15 below.

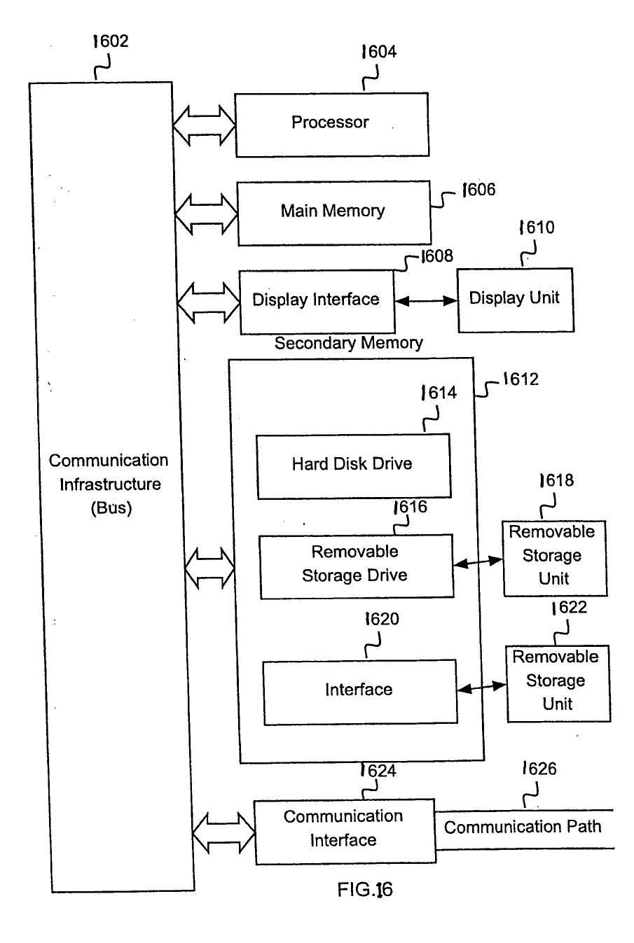

In an embodiment of the present invention, the computer systems of the computers 101-105 are one or more Personal Computers (PCs) (e.g., IBM or compatible PC workstations running the Microsoft Windows operating system, Macintosh computers running the Mac OS operating system, or equivalent), Personal Digital Assistants (PDAs), hand held computers, palm top computers, smart phones, game consoles or any other information processing devices. In another embodiment, the computer systems of the computers 101-105 are a server system (e.g., SUN Ultra workstations running the SunOS operating system or IBM RS/6000 workstations and servers running the AIX operating system). The computer systems of the computers 101-105 are described in greater detail below with reference to FIG. 16.

In an embodiment of the present invention, the network 107 is a circuit switched network, such as the Public Service Telephone Network (PSTN). In another embodiment, the network 107 is a packet switched network. The packet switched network is a wide area network (WAN), such as the global Internet, a private WAN, a telecommunications network or any combination of the above-mentioned networks. In yet another embodiment, the network 107 is a wired network, a wireless network, a broadcast network or a point-to-point network.

It should be noted that although FIG. 14 shows four computers 101-105, the present invention supports any number of computer clients that are able to access the ASP 103 and its functions. It should further be noted that although ASP 103 is pictured as one entity, the functions of ASP 103 can be distributed over a plurality of computers connected to the network 1097 and functioning as one point of access. In this embodiment, the ASP, 103 operates in a distributed computing paradigm.

As explained above, the ASP 103 provides functions related to maintaining information related to medical services and continuing medical education. The information residing at the ASP 103 is garnered from the computers 101-105 substantially contemporaneous with the rendering of medical services to patient. Further, the information stored at ASP 103 is available to patients via a network for viewing, editing, copying and transmitting. The aforementioned processes of ASP 103 are described in greater detail with reference to FIG. 16 below.

The described embodiments of the present invention are advantageous as they allow for the quick and easy transfer of medical service-related data to a database on a network substantially contemporaneous with the provision of a medical service. This results in a more direct and less time-consuming process for logging and filing medical service and billing information. Another advantage of the present invention is the reduction in the number of steps necessary for effectuating the logging and filing of medical service and billing information. This results in a reduction of time and resources expended during the logging and filing process, as well as a more streamlined environment for the provision of medical services.

A further advantage of the present invention is the mobility and ease of access of a medical record that may be accessible over a network, such as online via the Internet. This allows the patient or any other interested party to easily view the medical record with only a web browser having an Internet connection. Yet another advantage of the present invention is the management of the medical record by the patient. Whereas current systems only allow management of a medical record file by an insurance company or physician, the present invention allows the medical record to be managed by the patient himself since the patient has the highest interest in maintaining the record up-to-date and in good condition.

Yet another advantage of the present invention is the allowance for access, including temporary access, of the personal medical record by others. The patient may regulate the provision of credentials, including temporary credentials, to other parties, such as a physician for the purpose of an office visit, or an insurance company for the purpose of processing a medical claim. This allows a patient to be informed as to who has access to his personal medical record and allows the patient to be in charge of the mechanism (i.e., credentials) for allowing access to the medical record.

FIG. 15 is a block diagram depicting the architecture of the Application Service Provider (ASP) 103 component of one embodiment of the present invention. FIG. 15 shows a web server 1502 connected to the network 107. Web server 1502 can be any commercially available web server for serving web pages and other web content to clients via a network 107, such as the global Internet or the World Wide Web. FIG. 15 also shows a database 1506 for storage of information and a database management system 1504 for managing the data and records within the database 1506. Database 1506 and database management system 1504 can be any commercially available combination of a database and database management system for managing large quantities of data. Database 1506 corresponds to the references to memory 143 of ASP 103 above.

In one embodiment of the present invention, the database 1506 includes a plurality of records for storing personal medical information of patients. Preferably, at least one record corresponds to medical information for one patient or client. Also, a unique identifier, or key, exists for each record in the database 1506. The database management system 1504 manages the input and output of information into records of the database 1504. The web server 1502 manages the serving of information from the database 1506 to the network 107, such as the Web, and the reading of information from the Web for inclusion into the database 1506.

A wide variety of information can be received for inclusion into the database 1506. As described above, any information that may be stored on the memory 143 may alternatively be stored in the database 1506. This includes: software programs, data recording and billing software applications, service-related identifiers (e.g., CPT or other medical codes), groups of identifiers based on the physician's ID and location of services, a service description list/grouping, requested reporting requirements, non-cognitive CPT codes, diagnostic indication codes and descriptions, diagnostic indication identifiers, ABN identifiers, requests for ABN templates, completed ABN templates, insurer reporting requirements, ICD-9 codes, information related to administration of care, medical procedure reports, examination times, non-cognitive level of care service codes, graphic representations 1104 and any and all associated headers, prompts, labels and/or other alphanumeric information 115.

Referring to FIG. 2A, pre-encounter inputs of step 201 can be included into database 1506 (particularly, into the medical record of the patient being examined) prior to any office visit of a patient. The present invention further allows for the database 1506 to provide selection data and code data to the physician during step 201. Further, during the evaluation and management procedure of step 202, the present invention allows for the data garnered to be transmitted to the medical record of the patient in database 1506 for storage, substantially contemporaneous with the evaluation and management procedure. The present invention further allows for the database 1506 to provide selection data and code data to the physician during step 202. Likewise, any billing and/or service reports generated substantially contemporaneous with the evaluation and management procedure, or after the procedure, in step 215 are transmitted to the medical record of the patient in database 1506 for storage.

Next, during the ordering of a treatment or procedure in step 205, the present invention allows for the order/procedure data to be transmitted to the medical record of the patient in database 1506 for storage, substantially contemporaneous with the ordering of the treatment or procedure. The present invention further allows for the database 1506 to provide selection data and code data to the physician during step 205. Likewise, any prescriptions or orders generated substantially contemporaneous with the ordering of the treatment or procedure, or after the ordering of the treatment or procedure, in step 206 are transmitted to the medical record of the patient in database 1506 for storage.

Then, during the diagnosis or the selection of the procedure type in step 207, the present invention allows for the diagnosis or procedure data to be transmitted to the medical record of the patient in database 1506 for storage, substantially contemporaneous with the diagnosis or the selection of the procedure type. The present invention further allows for the database 1506 to provide selection data and code data to the physician during step 207. Likewise, any billing and/or service reports generated substantially contemporaneous with the diagnosis or the selection of the procedure type, or after the fact, in step 215 are transmitted to the medical record of the patient in database 1506 for storage.

Subsequently, during the selection of procedure inputs in step 210, the present invention allows for the procedure input data to be transmitted to the medical record of the patient in database 1506 for storage, substantially contemporaneous with the selection of procedure inputs. The present invention further allows for the database 1506 to provide selection data and code data to the physician during step 210. Likewise, any billing and/or service reports generated substantially contemporaneous with the selection of procedure inputs, or after the fact, in step 215 are transmitted to the medical record of the patient in database 1506 for storage.

Lastly, during the generation of a report or interpretation of procedure results in step 211, the present invention allows for the procedure data to be transmitted to the medical record of the patient in database 1506 for storage, substantially contemporaneous with the generation of the report or interpretation of procedure results. The present invention further allows for the database 1506 to provide selection data and code data to the physician during step 211. Likewise, any billing and/or service reports generated substantially contemporaneous with the generation of the report or interpretation of procedure results, or after the fact, in step 215 are transmitted to the medical record of the patient in database 1506 for storage.

Referring to FIGS. 3A-3AA and FIGS. 13A-13I, a group of GUIs are presented to a physician for the purpose of generating a various medical, billing and claims reports. The present invention allows for the database 1506 to provide to the physician selection data, code data and any other data presented in the above-referenced GUIs. Further, any data that is input via the above-referenced GUIs can be included into database 1506 (particularly, into the medical record of the patient being examined) via a network 107.

With regards to the generation of medical data during the taking of a patient history (such as in steps 201 or 202 of FIG. 2), it should be noted that in the patient questionnaire, each question results in a specific ICD disease code. Further, a series of questions could be asked of a patient regarding their review of systems, past history, social and family history, and these questions could each result in a specific ICD code. Moreover, each question, when answered in the positive or negative fashion, could result in the population of the same data in multiple fields in the history of the present illness, chief complaint, review of systems, past history, social history and family history.

Thus, the present invention includes the generation of a series of questions that may be answered by a single operator (the patient). The single operator, by a single click to a yes or no question, may populate multiple fields in the aforementioned various elements of the history taking process (i.e., the history of the present illness, chief complaint, review of systems, past history, social history and family history). A single operator can make the initial entry by use of a website, or fill out a paper format such that it can be scanned using the OCR techniques typical in the industry. As required by federal regulations and the Privacy Act (HIPAA) regulations, the patient can exclusively “own” the personal medical website (PMW), and only the patient may give permission for a review of the information on the web site. Further, the database created by the single operator answering the series of questions, is created in a format that meets or exceeds all the federal regulations.

The single operator, or owner, of the PMW may provide access to any other individual that they deem necessary and appropriate. The database will interface with an electronic medical record corresponding to a patient (i.e., the owner of the record). The patient may regulate the provision of credentials, including temporary credentials, to other parties, such as a physician for the purpose of an office visit, or an insurance company for the purpose of processing a medical claim. This allows a patient to be informed as to who has access to his person al medical record and allows the patient to be in charge of the mechanism (i.e., credentials) for allowing access to the medical record.

The database can be upgradeable over any period of time so that new information may be added as necessary. The personal medical website may also include other data including demographics, insurance information, current and past medications and medication side effects, etc.

In another embodiment of the present invention, a system for maximizing the use of “memory hooks” to help retain Continuing Medical Education (CME) information at a time when an HCP was most interested in the delivery of such CME information is disclosed. The system is available at the point and time that a medical service is provided to a patient. A full CME program is provided the physician in addition to a “capsulated version” that contains pertinent information regarding specific care of a specific patient for a specific diagnosis (ICD) or a specific service (CPT). This allows for quick delivery of the most pertinent CME information to the physician at the time the medical service is provided.

Take for example a patient with congestive heart failure. If there is a CME for congestive heart failure that contains information regarding the pathophysiology of certain aspects of congestive heart failure and an additional table containing information on specific drugs, indications and doses, the latter would be all that would be delivered at the point and time of service (unless, of course the HCP had more time in which case the entire CME could be presented). The additional piece of information that could be delivered, if an electronic medical record (EMR) were available, would be an insert into the EMR regarding new patient education information provided to a patient and the new recommendations. This information capitalizes on the concept of delivery of “capsulated ” CME at that point and time of service to maximize the use of “memory hooks” at peak levels of interest on behalf of HCP. If enough interest is generated in the physician, the rest of the CME be investigated at a later time.

A web based health care system (described in greater detail above) that is accessed using a web browser can focus on providing the HCP with coding, billing generation, auto-authorization, auto-faxing, auto-posting, all at the point and time of service delivery. Such a system can accomplish these tasks by using interfaces with existing practice management systems (PMS). This system is beneficial because it goes to a great extent to extract from the HCP, at the point and time of service, a variety of information about the patient in order to provide medical, social, business and financial care to the patient. This information is then delivered to the patient's EMR. A natural extension of this system is the concept of auto-CME at the point and time of service, to the extent possible, recognizing time constraints.

The auto-CME system of the present invention is a web based system allowing access via a web browser. The system is available at the point and time that the medical service is provided. Not only is the full CME program provided, but a “capsulated version” that contains pertinent information regarding specific care of a specific patient for a specific diagnosis (ICD) or a specific service (CPT) can be provided. This is directed towards rapid delivery of pertinent information that can be reviewed in a short period of time. Information that provides direct, indirect or no correlation to the ICD or CPT can also be provided.

Further, the system can keep an online version of the CME completed to date, or any portion thereof. Further, the system can notify the HCP of remaining portions of the CME which have only been completed by the “capsulated version.” If desired by the HCP, the system may automatically insert information into proper zones in the EMR pertinent to the capsulated version of the CME requested. The system can also permit the HCP to be charged for these services at that point in time that service is provided.

The present invention can be realized in hardware, software, or a combination of hardware and software. A system according to a preferred embodiment of the present invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general-purpose computer system with a computer program that, when being loaded and executed, controls the computer system such that it carries out the methods described herein.

An embodiment of the present invention can also be embedded in a computer program product, which comprises all the features enabling the implementation of the methods described herein, and which—when loaded in a computer system—is able to carry out these methods. Computer program means or computer program in the present context mean any expression, in any language, code or notation, of a set of instructions intended to cause a system having an information processing capability to perform a particular function either directly or after either or both of the following: a) conversion to another language, code or, notation; and b) reproduction in a different material form.

A computer system may include, inter alia, one or more computers and at least a computer readable medium, allowing a computer system, to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer readable medium may include, for example, volatile storage such as RAM, buffers, cache memory, and network circuits. Furthermore, the computer readable medium may comprise computer readable information in a transitory state medium such as a network link and/or a network interface, including a wired network or a wireless network, that allow a computer system to read such computer readable information.

FIG. 16 is a high level block diagram showing an information processing system useful for implementing one embodiment of the present invention. The computer system includes one or more processors, such as processor 1604. The processor 1604 is connected to a communication infrastructure 1602 (e.g., a communications bus, cross-over bar, or network). Various software embodiments are described in terms of this exemplary computer system. After reading this description, it will become apparent to a person of ordinary skill in the relevant art(s) how to implement the invention using other computer systems and/or computer architectures.

The computer system can include a display interface 1608 that forwards graphics, text, and other data from the communication infrastructure 1602 (or from a frame buffer not shown) for display on the display unit 1610. The computer system also includes a main memory 1606, preferably random access memory (RAM), and may also include a secondary memory 1612. The secondary memory 1612 may include, for example, a hard disk drive 1614 and/or a removable storage drive 1616, representing a floppy disk drive, a magnetic tape drive, an optical disk drive, etc. The removable storage drive 1616 reads from and/or writes to a removable storage unit 1618 in a manner well known to those having ordinary skill in the art. Removable storage unit 1618, represents a floppy disk, a compact disc, magnetic tape, optical disk, etc. which is read by and written to by removable storage drive 1616. As will be appreciated, the removable storage unit 1618 includes a computer readable medium having stored therein computer software and/or data.

In alternative embodiments, the secondary memory 1612 may include other similar means for allowing computer programs or other instructions to be loaded into the computer system. Such means may include, for example, a removable storage unit 1622 and an interface 1620. Examples of such may include a program cartridge and cartridge interface (such as that found in video game devices), a removable memory chip (such as an EPROM, or PROM) and associated socket, and other removable storage units 1622 and interfaces 1620 which allow software and data to be transferred from the removable storage unit 1622 to the computer system.

The computer system may also include a communications interface 1624. Communications interface 1624 allows software and data to be transferred between the computer system and external devices. Examples of communications interface 1624 may include a modem, a network interface (such as an Ethernet card), a communications port, a PCMCIA slot and card, etc. Software and data transferred via communications interface 1624 are in the form of signals which may be, for example, electronic, electromagnetic, optical, or other signals capable of being received by communications interface 1624. These signals are provided to communications interface 1624 via a communications path (i.e., channel) 1626. This channel 1626 carries signals and may be implemented using wire or cable, fiber optics, a phone line, a cellular phone link, an RF link, and/or other communications channels.

In this document, the terms “computer program medium,” “computer usable medium,” and “computer readable medium” are used to generally refer to media such as main memory 1606 and secondary memory 1612, removable storage drive 1616, a hard disk installed in hard disk drive 1614, and signals. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Furthermore, the computer readable medium may comprise computer readable information in a transitory state medium such as a network link and/or a network interface, including a wired network or a wireless network, that allow a computer to read such computer readable information.

Computer programs (also called computer control logic) are stored in main memory 1606 and/or secondary memory 1612. Computer programs may also be received via communications interface 1624. Such computer programs, when executed, enable the computer system to perform the features of the present invention as discussed herein. In particular, the computer programs, when executed, enable the processor 1604 to perform the features of the computer system. Accordingly, such computer programs represent controllers of the computer system.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

We claim:

1. A method for a medical service provider to document and approve service and billing information substantially contemporaneous with a provision of services, comprising:
receiving context information about services for a patient;
retrieving a first category of service identifier groups based at least in part on the context information;
receiving, in response to an approval by the medical service provider of a first group of the service identifier groups, a first identifier belonging to the first group as further input substantially contemporaneous with the provision of services by the medical service provider; and
storing the context information and the first identifier for output in connection with billing information.

2. The method of claim 1, wherein the step of retrieving further comprises:
retrieving a category of patient condition identifier groups;
receiving, in response to an approval by the medical service provider of a second group of the patient condition identifier groups, a second identifier from the second group as further input substantially contemporaneous with the provision of services by the medical service provider, wherein the second group is determined at least in part based upon the first identifier; and
wherein the step of storing further comprises storing said second identifier for output in connection with billing information.

3. The method of claim 1, wherein the step of receiving the first identifier comprises:
receiving a type of care identifier in response to a selection from a list of related types of medical care by a medical doctor.

4. The method of claim 1, wherein the step of receiving the first identifier comprises:
pre-selecting a type of care identifier based at least in part on the context information; and
presenting the type of care identifier to a physician for approval substantially contemporaneous with the provision of services.

5. The method of claim 2, wherein the step of receiving a first identifier comprises:
pre-selecting a group of related types of medical care based on the context information; and
presenting for approval plural level of care identifiers associated with a first type of medical care, wherein the first identifier is one of the plural level of care identifiers.

6. A method for maintaining a personal medical record available on a network, the method comprising;
performing an evaluation and management service upon a patient;
generating personal medical information of the patient substantially contemporaneous with the evaluation and management service;
causing the identification of a personal medical record on the network corresponding to the patient; and
sending the personal medical information over the network for storage in the personal medical record.

7. The method of claim 6, further comprising:
generating information related to services provided to the patient and/or billing, substantially contemporaneous with the evaluation and management service; and
sending the information related to services provided and/or billing over the network for storage in the personal medical record.

8. The method of claim 6, further comprising:
ordering a treatment for the patient based on the evaluation and management service;
generating information related to the treatment substantially contemporaneous with the step of ordering a treatment; and
sending the information related to the treatment over the network for storage in the personal medical record.

9. The method of claim 8, further comprising:
generating prescription information related to the treatment, substantially contemporaneous with the step of ordering a treatment; and
sending the prescription information over the network for storage in the personal medical record.

10. The method of claim 8, further comprising:
selecting a procedure for treatment of the patient based on step of ordering a treatment;
generating information related to the procedure substantially contemporaneous with the step of selecting a procedure; and
sending the information related to the procedure over the network for storage in the personal medical record.

11. The method of claim 10, further comprising:
generating information related to services provided to the patient and/or billing, substantially contemporaneous with the step of selecting a procedure; and
sending the information related to services provided and/or billing over the network for storage in the personal medical record.

12. The method of claim 10, further comprising:
selecting procedure input information based on the step of selecting a procedure;
generating procedure input information substantially contemporaneous with the step of selecting procedure input information; and
sending the procedure input information over the network for storage in the personal medical record.

13. The method of claim 12, further comprising:
generating information related to services provided to the patient and/or billing, substantially contemporaneous with the step of selecting procedure input information; and
sending the information related to services provided and/or billing over the network for storage in the personal medical record.

14. The method of claim 10, further comprising:
selecting procedure result information based on a procedure that was performed;
generating procedure result information substantially contemporaneous with the step of selecting procedure result information; and
sending the procedure result information over the network for storage in the personal medical record.

15. The method of claim 14, further comprising:
generating information related to services provided to the patient and/or billing, substantially contemporaneous with the step of selecting procedure result information; and
sending the information related to services provided and/or billing over the network for storage in the personal medical record.

16. The method of claim 6, further comprising:
allowing the patient to read, modify and copy the personal medical record corresponding to the patient over the network.

17. A method for maintaining a personal medical record available on a network, the method comprising;
maintaining in a database a list of unique identifiers associated with personal medical records corresponding to patients;
receiving personal medical information of a patient over the network substantially contemporaneous with an evaluation and management service performed upon the patient; and
identifying in the database, using the list of unique identifiers, a personal medical record corresponding to the patient and storing the personal medical information in the personal medical record that was identified.

18. The method of claim 17, further comprising:
receiving over the network information related to services provided to the patient and/or billing, substantially contemporaneous with the evaluation and management service; and
identifying in the database, using the list of unique identifiers, a personal medical record corresponding to the patient and storing the information related to services provided and/or billing in the personal medical record that was identified.

19. An information processing system for maintaining a personal medical record database available on a network, comprising:
an interface for inputting personal medical information of a patient substantially contemporaneous with an evaluation and management service performed upon the patient;
a processor for causing the identification of a personal medical record on the network corresponding to the patient; and
a transmitter for sending the personal medical information over the network for storage in the personal medical record.

20. The information processing system of claim 19, further comprising:
a processor for generating information related to services provided to the patient and/or billing, substantially contemporaneous with the evaluation and management service; and
a transmitter for sending the information related to services provided and/or billing over the network for storage in the personal medical record.

21. An information processing system for maintaining a personal medical record database available on a network, comprising;
a database of personal medical records corresponding to patients, each medical record having a unique identifier;
a network interface for receiving personal medical information from a patient over a network substantially contemporaneous with an evaluation and management service performed upon a patient; and
a processor for identifying a personal medical record corresponding to the patient and storing the personal medical information in the personal medical record that was identified.

22. The information processing system of claim 21, further comprising:
a receiver for receiving information related to services provided to the patient and/or billing, substantially contemporaneous with the evaluation and management service; and
a processor for identifying the personal medical record corresponding to the patient and storing the information related to services provided and/or billing in the personal medical record that was identified.

23. A method for providing continuing medical education substantially contemporaneous with a provision of medical services, the method comprising;
performing an evaluation and management service upon a patient;
generating personal medical information of the patient substantially contemporaneous with the evaluation and management service;
sending the personal medical information over the network for storage in a personal medical record on the network corresponding to the patient; and
receiving continuing medical education information related to the personal medical information.
